(19) United States
(12) Patent Application Publication
(10) Pub. No.: US 2015/0188949 A1
(43) Pub. Date: Jul. 2, 2015

(54) CLOUD-BASED NETWORK SECURITY

(71) Applicant: LOOKOUT, INC., San Francisco, CA (US)

(72) Inventors: Kevin Patrick Mahaffey, San Francisco, CA (US); John Gunther Hering, San Francisco, CA (US); Brian James Buck, Livermore, CA (US)

(21) Appl. No.: 14/586,759

(22) Filed: Dec. 30, 2014

Related U.S. Application Data
(60) Provisional application No. 61/922,657, filed on Dec. 31, 2013.

(51) Int. Cl. H04L 29/06

(52) U.S. Cl. CPC H04L 63/20; H04L 63/10; H04L 63/0272

(57) ABSTRACT

A method for managing the use of gateways on a network includes authenticating a user, determining and managing a path between a user computing device and a destination computing device, the path including at least one of the gateways, and managing user traffic on the path according to a policy associated with the user.

### CROSS-REFERENCE TO RELATED APPLICATIONS

This patent application claims priority to U.S. provisional patent application 61/922,657, filed Dec. 31, 2013, entitled “CLOUD-BASED NETWORK SECURITY,” which is hereby incorporated by reference along with all other references cited in this application.

### TECHNICAL FIELD

The present invention relates to the field of information technology, including, more particularly, systems and techniques for the security of computing devices.

### BACKGROUND OF THE INVENTION

Current techniques for providing security are based on desktop computing models. These models are inadequate for today's computing devices and especially mobile computing devices. At work, computers are protected from threats that originate on the internet. Companies deploy firewalls, intrusion prevention systems, and increasingly, advance security event correlation engines to protect from these threats. However, as more people bring mobile devices into the workplace, they get none of this protection. And now a typical user and the multiple devices that such a user employs rarely stay in one place. The device (or device user) may travel all over the world. And the device will try to communicate with destinations all over the world.

Also, the Internet has historically been a more or less a neutral network with packets are sent to a user's local gateway and then ported to the right destination. The network, however, has recently become progressively less neutral. For example, ISPs may be throttling traffic based on where the traffic is going and what kind of traffic it is. Companies may be blocking certain types of traffic. There can be individual private networks that belong to an access controller. Companies may have layers upon layers of firewalls. They may be performing network filtering and data loss prevention. These types of activities on the network are a departure from the original design of the internet which was to provide a very reliable way of transmitting a packet from Point A to Point B.

Furthermore, there are architectural, political, and business issues that impact a number of desirable Internet use cases. For example, modifying certain protocols to make them more efficient for a particular use case, and doing that publicly, is very difficult and can entail a ten-year process or more.

Generally, the Internet has evolved with security as an afterthought, and this has impacted the protection of personal data, personal privacy, particular realms, and the like. Today, these are protected mainly with firewalls. But that makes addressing and connectivity more complex, particularly when trying to achieve objectives that may touch on security.

### BRIEF SUMMARY OF THE INVENTION

In an embodiment, users are authenticated in a cloud-based network security platform.

In an embodiment, managing the use of gateways on a network includes authenticating a user, determining and managing a path between a user computing device and a destination computing device, the path including at least one of the gateways, and managing user traffic on the path according to a policy associated with the user.

In an embodiment, a method for managing a connection between a computing device and a destination computing device includes a first managing component that both manages a connection between the first computing device and the destination computing device and managing traffic intended for the destination computing device. The managing component identifies a characteristic of the traffic. It accesses a database and retrieves a connection policy associated with the identified characteristic of the traffic. The managing component implements the connection policy in both managing the traffic and in managing a connection. The managing software component provides a second computing device with a request for the connection over a network. The second computing device configures the connection. After the first computing device is authenticated, the second computing device establishes the connection. Thus, both the traffic and the first connection between the first computing device and the destination computing device are managed by the managing component.

In an embodiment, managing a path between a first computing device and a destination computing device includes choosing a first gateway located on the network, with the first gateway including an entrance to a tunnel between the first computing device and the destination computing device.

In an embodiment, each of a plurality of enterprises has access to a plurality of gateways. Instances of a managing software component run with each gateway of the plurality of gateways. And each of the instances of managing software has access to a database with connection policies for managing traffic associated with the enterprises.

Other objects, features, and advantages of the present invention will become apparent upon consideration of the following detailed description and the accompanying drawings, in which like reference designations represent like features throughout the figures.

### BRIEF DESCRIPTION OF THE FIGURES

FIG. 1 shows a simplified block diagram of a system for a cloud-based network security platform implemented in a distributed computing network connecting a server and clients.

FIG. 2 shows a more detailed diagram of an example of a client of the system.

FIG. 3 shows a simplified block diagram of a system for providing a pipe between a client and destination.

FIG. 4 shows another example of a pipe system.

FIG. 5 shows another example of a pipe system.

FIG. 6 illustrates an example of a block diagram of a system for automatically providing a secure network connection to a computing device, implemented in accordance with some implementations.

FIG. 7 shows an example of contexts in which a computing device might be used.

FIG. 8 shows a more detailed block diagram of a particular context.

FIG. 9 shows a block diagram of a specific implementation of a client-side secure connection manager.

FIG. 10 illustrates an example of a block diagram of a system for automatically providing multiple secure network connections to a computing device, implemented in accordance with some implementations.

FIG. 11 illustrates an example of a block diagram of a method for providing a secure network connection to a computing device, implemented in accordance with some implementations.

FIG. 12 illustrates an example of a block diagram of a method for automatically protecting a secure network connection, implemented in accordance with some implementations.

FIG. 13 illustrates an example of a block diagram of a method for recommending a policy for a secure network connection, implemented in accordance with some implementations.

FIG. 14 illustrates an example of a block diagram of a method for applying a security policy to determine whether the security level of a network connection is appropriate for the context.

FIG. 15 illustrates an example of a block diagram of a method for applying a security policy to establish a network connection having the appropriate level of security for the context.

FIG. 16 illustrates an example of a block diagram of a method for receiving a security policy.

FIG. 17 illustrates an example of a block diagram of a method for analyzing context information at a server to determine whether a network connection for the computing device offers the appropriate level of security.

FIG. 18 shows an example of screen shot for a specific implementation of a pipe system.

FIG. 19 shows another example of screen shot for the specific implementation of the pipe system.

FIG. 20 shows another example of screen shot for the specific implementation of the pipe system.

FIG. 21 shows another example of screen shot for the specific implementation of the pipe system.

FIG. 22 shows another example of screen shot for the specific implementation of the pipe system.

FIG. 23 shows another example of screen shot for the specific implementation of the pipe system.

### DETAILED DESCRIPTION

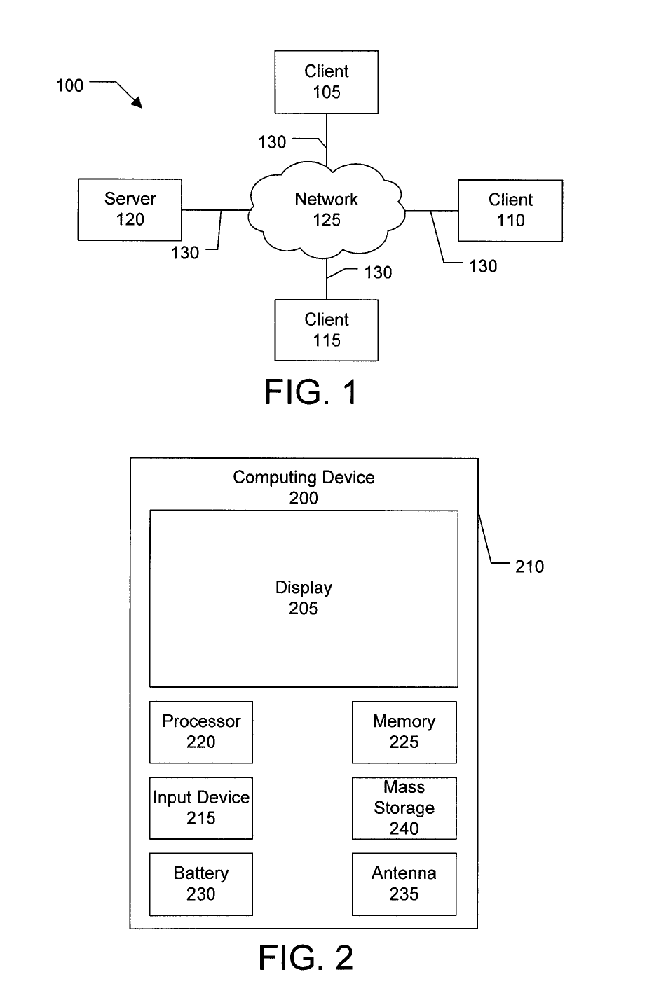

FIG. 1 is a simplified block diagram of a distributed computer network 100 incorporating a specific embodiment of a system for multiparty authentication of an action. Computer network 100 includes a number of client systems 105, 110, and 115, and a server system 120 coupled to a communication network 125 via a plurality of communication links 130. Communication network 125 provides a mechanism for allowing the various components of distributed network 100 to communicate and exchange information with each other.

Communication network 125 may itself be comprised of many interconnected computer systems and communication links. Communication links 130 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, Internet telephony, IP telephony, digital voice, voice over broadband (VoBB), broadband telephony, Voice over IP (VoIP), public switched telephone network (PSTN), and others. While in one embodiment, communication network 125 is the Internet, in other embodiments, communication network 125 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment and does not limit the scope of the systems and methods as recited in the claims. One of ordinary skill in the art would recognize other variations, modifications, and alternatives. For example, more than one server system 120 may be connected to communication network 125. As another example, a number of client systems 105, 110, and 115 may be coupled to communication network 125 via an access provider (not shown) or via some other server system.

Client systems 105, 110, and 115 typically request information from a server system which provides the information. Server systems by definition typically have more computing and storage capacity than client systems. However, a particular computer system may act as both a client or a server depending on whether the computer system is requesting or providing information. Aspects of the system may be embodied using a client-server environment or a cloud-cloud computing environment.

Server 120 is responsible for receiving information requests from client systems 105, 110, and 115, performing processing required to satisfy the requests, and for forwarding the results corresponding to the requests back to the requesting client system. The processing required to satisfy the request may be performed by server system 120 or may alternatively be delegated to other servers connected to communication network 125.

Client systems 105, 110, and 115 enable users to access and query information or applications stored by server system 120. Some example client systems include desktop computers, portable electronic devices (e.g., mobile communication devices, smartphones, tablet computers, laptops) such as the Samsung Galaxy Tab®, Google Nexus devices, Amazon Kindle®, Kindle Fire®, Apple iPhone®, the Apple iPad®, Microsoft Surface®, the Palm Pre™, or any device running the Apple iOS®, Android® OS, Google Chrome® OS, Symbian OS®, Windows Mobile® OS, Windows Phone, BlackBerry® OS, Embedded Linux, Tizen, Sailfish, webOS, Palm OS® or Palm Web OS®.

In a specific embodiment, a “web browser” application executing on a client system enables users to select, access, retrieve, or query information and/or applications stored by server system 120. Examples of web browsers include the Android® browser provided by Google, the Safari® browser provided by Apple, Amazon Silk® provided by Amazon, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others (e.g., Google Chrome).

FIG. 2 shows an example of a computer system such as a client system. In an embodiment, a user interfaces with the system through a client system, such as shown in FIG. 2. Mobile client communication or portable electronic device 200 includes a display, screen, or monitor 205, housing 210, and input device 215. Housing 210 houses familiar computer components, some of which are not shown, such as a processor 220, memory 225, battery 230, speaker, transceiver, antenna 235, microphone, ports, jacks, connectors, camera, input/output (I/O) controller, display adapter, network interface, mass storage devices 240, and the like.

Input device 215 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, gestural interface (contact or non-contact gestures), biometric input sensor, or combinations of these.

Mass storage devices 240 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

The system may also be used with computer systems having different configurations, e.g., with additional or fewer subsystems. For example, a computer system could include more than one processor (i.e., a multiprocessor system, which may permit parallel processing of information) or a system may include a cache memory. The computer system shown in FIG. 2 is but an example of a computer system suitable for use. Other configurations of subsystems suitable for use will be readily apparent to one of ordinary skill in the art. For example, in a specific implementation, the computing device is mobile communication device such as a smartphone or tablet computer. Some specific examples of smartphones include the Droid Incredible and Google Nexus One®, provided by HTC Corporation, the iPhone® or iPad®, both provided by Apple, BlackBerry Z10 provided by BlackBerry (formerly Research In Motion), and many others. The computing device may be a laptop or a netbook. In another specific implementation, the computing device is a non-portable computing device such as a desktop computer or workstation.

A computer-implemented or computer-executable version of the program instructions useful to practice the systems and techniques described in this application may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the techniques described in this application may be stored or reside in RAM or cache memory, or on mass storage device 240. The source code of this software may also be stored or reside on mass storage device 240 (e.g., flash drive, hard disk, magnetic disk, tape, or CD-ROM). As a further example, code useful for practicing the techniques described in this application may be transmitted via wires, radio waves, or through a network such as the Internet. In another specific embodiment, a computer program product including a variety of software program code to implement features described in this application is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Windows Phone, Symbian®, BlackBerry® OS, BlackBerry 10 OS, BlackBerry Tablet OS, Palm web OS, bada, Embedded Linux®, MeeGo®, Maemo®, Limo®, Tizen, Sailfish, or Brew OS. Other examples of operating systems include one of the Microsoft Windows family of operating systems (e.g., Windows 95, 98, Me, Windows NT®, Windows 2000, Windows XP®, Windows XP x64 Edition, Windows Vista®, Windows 7, Windows 8, Windows CE, Windows Mobile®, Windows Phone 7®, Windows Phone 8®), Linux®, HP-UX, UNIX, Sun OS, Solaris, Mac OS X, Alpha OS, AIX, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system useful in practicing the systems and methods in this application using a wireless network employing a protocol such as Wi-Fi (IEEE standards 802.11, 802.11a, 802.11b, 802.11e, 802.11g, 802.11i, 802.11n, 802.11ac, and 802.11ad, just to name a few examples). For example, signals from a computer may be transferred, at least in part, wirelessly to components or other computers.

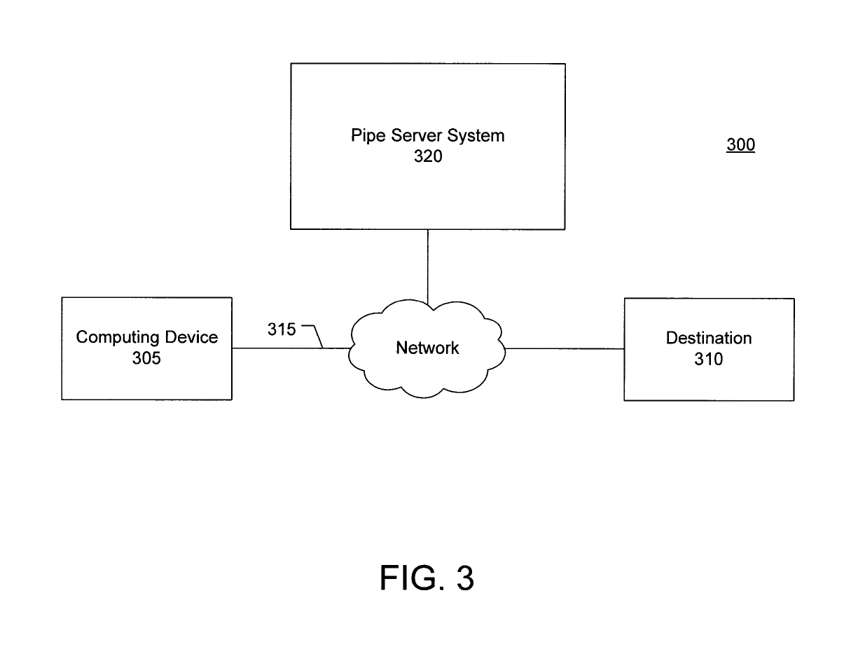

FIG. 3 shows a simplified block diagram of a system 300 for provisioning all or part of a network infrastructure in order to provide a secure and easy to administer system for connecting a computing device 305 to a destination 310. A device network connection 315 may flow thru a server system 320 in order to provide an enhanced experience. Users or buyers can include consumers and enterprises.

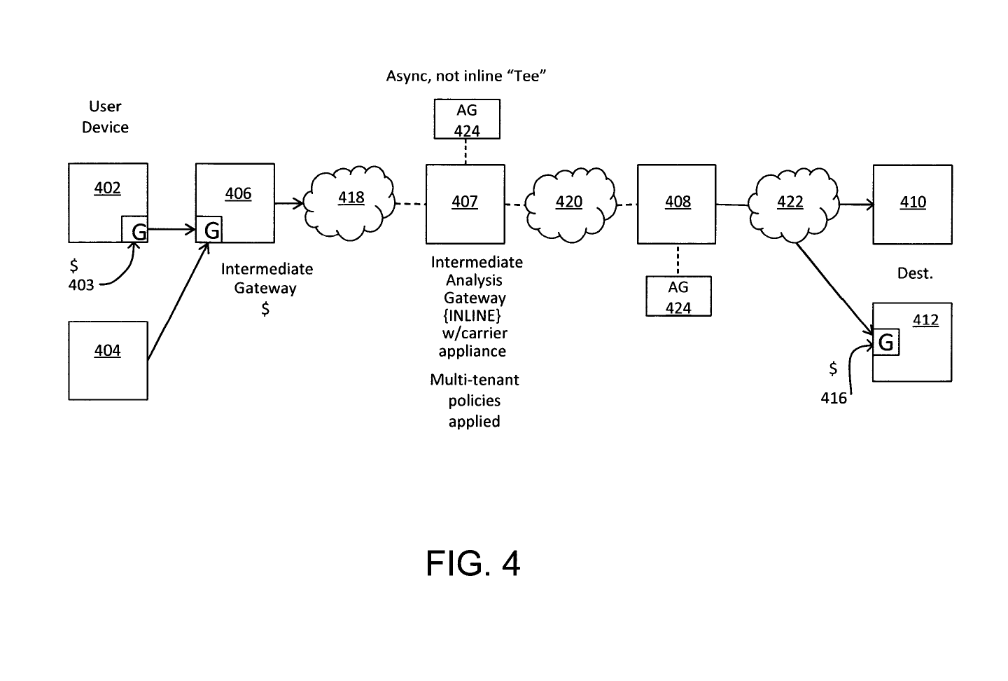

In a specific implementation, a feature of the system includes provisioning part or all of the network infrastructure to accomplish a much more secure and easy-to-administer and easy-to-connect-in environment. In a specific implementation, the system includes a telco-integrated, smart secure pipe. The system may include local, terminal, and intermediate gateways (respectively: FIGS. 4, 403 and 406; FIGS. 4, 414 and 416; and FIGS. 4, 406 and 407). There can be analysis at multiple places. There can be criteria for security in the pipe. Every user in the pipe may be authenticated, unlike what is present on the Internet, where there is no authentication by default.

Some features of the pipe can include performance optimizations for particular cases including wireless ones, mobility-oriented ones, and so on. There can be inspection and protection of content that is flowing. There can be caching. There can be analysis at particular gateways.

Since the internet is host-oriented, a user's computer (a host) gets things to another computer. Generally, the network itself is not user or application-aware. Rather, it is “dumb.” A packet is merely address-aware. This can be undesirable because if there is an application, such as Facebook, the Facebook application may often only want to talk to Facebook servers. A developer may not want it to be able to talk to any other locations on the Internet.

Similarly, there can be an application on the enterprise. The enterprise may wish that only authorized users are able to contact it. Past solutions have included either a Web site that is publicly available with a username and password (which has user experience issues), or a user authenticates to a protected network behind the firewall and then they can access the application. But there is no granular access control typically. Rather, it is like a flat network inside a company—everyone is inside the firewall, not just the authorized users. So, there is no intrinsic mapping between the person and the application.

Users must go through multiple steps. For example, a firewall may be established such that only people who get inside the firewall are “good.” Instead or additionally, people may be required to type in a user name and password on the actual Web site, which can also be problematic. Furthermore, there are issues with approaching the problems from the aspect of the user experience. However, with embodiments, a system can be aware of the network user and the application. There are user aspects to this that are beneficial. Further, in a world of the Internet of Things, where most of these devices have a single purpose, it can be very bad if a thing is doing something other than its single purpose. So, the actual network awareness of that purpose and awareness of where the thing is authorized to talk and where it is not can be beneficial. It can be a primary security attribute.

In a specific implementation, a system provides for a replacement for multiple layers of network infrastructure. In another specific implementation, the system includes an overlay network which rides atop existing Internet infrastructure. In this specific implementation, the system may be referred to as the Overnet. The network may be aware of the user and the application as a part of a communication protocol. There can be a tunneling system such that a device will route traffic through a tunnel. One example of an architectural approach includes either having a local gateway so it enters the tunnel on their machine, or remote gateway where it enters the tunnel off another machine. So it can be embedded in a router or other device. And then it exits the tunnel based on where it is going or remote to where it is going. That traffic can be colored in such a way that it tags information on the traffic for the remote receiver. For example, there can be an internal contact store to a company. And the only way for a user to get there is to route through this tunneling system because it is on a very private network. The tunneling system effectively acts as the access control to that as an option.

The other, perhaps more tactical, problem that this system can solve is that right now there can be a lot of boxes in a corporate data center. If there is a PC under a desk that is plugged into the wall, all the traffic may go through those boxes. When there is a mobile phone that is not running through the corporate data center, it is expensive to route traffic through those boxes because instead of routing them directly from where they need to go, such as from phone to where they need to go, they're going to have to route it across the country to the corporate data center, then across, then back out to where it is trying to go. So, this procedure adds a lot of latency.

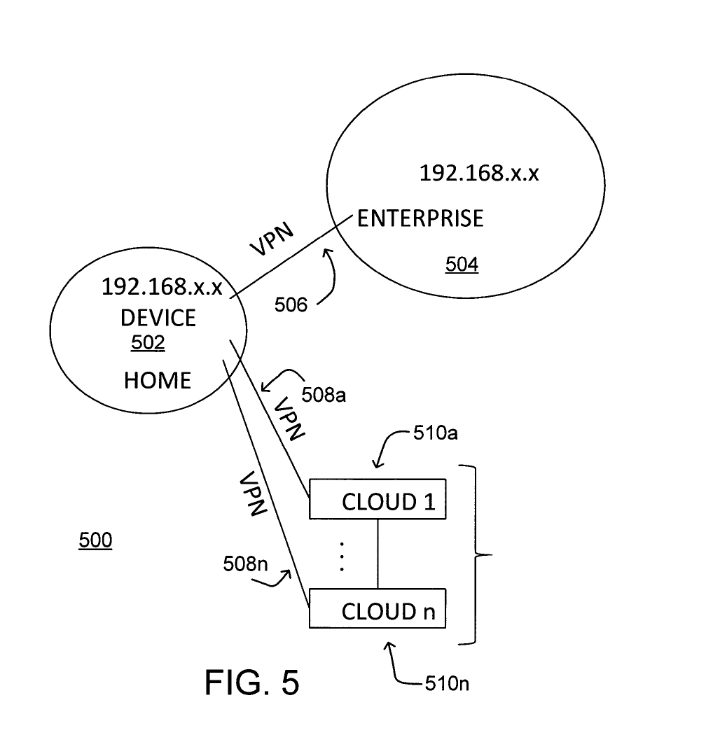

FIG. 4 shows a schematic diagram of a pipe system 400. FIG. 5 shows another schematic diagram of a pipe system 500. Referring now to FIG. 4, there can be a local gateway 403 on the device 402. There can be two kinds of devices; a device in which there is a local gateway, e.g., a client 402, or an agent that is running on the device. Or it might be the piece of Wi-Fi access point or another piece of network infrastructure that has the gateway, perhaps without anything being on the device itself, e.g., device 404 and gateway 406. Thus, in embodiments, the system may include local gateways 403 (on device 402), terminal gateways 408 (into destination 410) and 416 (into destination corp. 412), and/or intermediate gateways 406, 407. In embodiments, an intermediate gateway, e.g., gateway 407, may be an in-line analysis gateway. The system may also a terminal gateway that tees the traffic to an analysis system (not inline) and the destination, such as terminal gateway 408 teeing to analysis gateway 424.

But, in this specific implementation, authentication happens at this point at the time of this connection being made. And when there is a connection being made over to a destination 410 or 412, traffic is flowing through a number of intermediate gateways 406, 407 that the system 400 may have. Parts of these may tunnel through parts of the public Internet 418, 420, 422 or these might be direct connections, such as a private Internet. Consider, as an analogy, an Internet weather center, or an Internet weather report. The Internet may be understood as being a series of private networks that are interconnects, and those peering points, that is where it interconnects.

So, essentially the way packets flow over the Internet 418, 420, 422 is via a series of private networks and they are named, they are called autonomous systems, and they each have a number. And then these autonomous systems connect to each other often times at multiple points. These points may be referred to as peering points. When they do that, they advertise routes to each other over a protocol called BGP (border gateway protocol). And so, there can be an IP address A and an IP address B. As a client, a connection is made with an ISP. And then at some point it gets routed to a router. The router may have millions of entries. It knows how to get to every IP address in the world. The router, based on information from a peer, may identify a route to a destination (e.g., China). The route may also note that it can also connect to this thing in China from this route. So, for example, the router may identify ten different routes in that same IP range.

A router may then choose what it considers to be the best route. Right now, however, the best route is defined as the shortest number of traversed systems. “Best” is from the perspective of the network operator and not necessarily from the perspective of the end user.

A connection can be made from San Francisco to San Jose and it may go out through Washington D.C. where there's a peering point and it goes to a different vendor's network and it comes back. The reason is because it might be cheaper because there is a peer—a better relationship or a better contract with those people. Usually the arrangement includes a no-fee peer which is if there are companies of roughly the same size and they say let's connect and let's not charge each other. If there is a big company and a small company and they have leverage, then they're going to charge a user, or an enterprise, very high rates to do that. It can also happen that these peering points become congested. Latency can increase to, for example, 300 or more milliseconds. The lengthy response times can be frustrating. Typical discovery protocols are usually not smart enough to address latency in a particular routing decision. And though somebody might manually go in and pull the route because they noticed it was congested, and thought “let us stop that,” there is not a systematic way for that to happen.

Furthermore, people can take over the routes so there is no or limited authentication. It is not uncommon for cybercriminals to take over other people's routes without them knowing it and route all the traffic destined to them through the criminal systems and then pass it on to the original user so that the original user is unaware.

Certain countries, for example, are known to have taken control of such routes unbeknownst to the users. In some cases the assumption of control was purposeful. In other cases, the assumption of control was accidental. For example, in one case, a country's blocking of a particular website from being accessible in the country affected users in other countries because this whole system of autonomous systems is just basically flat and there is no authentication. The country broadcasted that the website was null. The rest of the Internet picked that up, too, because there is not a trust relationship. It can be kind of a very fragile place. Most people have no idea how fragile that is.

Regarding the autonomous systems, it can be important to understand what autonomous systems the packets are going to, for many customers. The reason is because when sending packets out to the Internet, there may be a desire to know that they go through the countries they can control. Users may not want their packets to pass through certain countries.

Alternatively, there might be, from an intelligence perspective, knowledge that this fiber route is tapped. The user does not want any of their packets to go through that fiber route. And the Internet has no way right now to customize routes.

And packet transmission issues can be multilevel. There can be a geographical domain or a geopolitical domain through which the packets are not to flow. Or they can flow but they have to be encrypted if they're flowing through this particular country. There can be full encryption. It might slow down the traffic, but it can be acceptable because a link may not be trusted because it is going through hostile territory. In a specific implementation, the headers and the tags on the packets may be modified. In another specific implementation, the networks and the access points through which the data flows may be controlled. Packets may be redirected to various places. As an example, instead of putting an IP address, i.e., the destination IP address, the system may put an IP address of the next route on the packets and that may be used in conjunction with a tunneling protocol where the actual data may be enclosed in it.

Instead of using a tunneling protocol, the system may alternatively use just custom headers without modifying the payload. So, there can be custom IP or TCP headers to specify the sending of a packet to the next gateway in the chain, but the system will use headers to inform that gateway where the actual destination of that traffic is. Another specific embodiment may include a tunneling protocol. Examples include IPSEC, VPN, OpenVPN or any custom protocol. Alternatively, it may be implemented at a lower network level using, for example, MPLS for labeling where, essentially, a virtual circuit is created. That is, there is a predecided route and the label is the only thing that the router looks at, e.g., this label goes there.

The distinction is that there are various other criteria beyond the usual routing criteria that the Internet currently uses that the system may use once the system acquires traffic. The system may choose to route it into a number of different places before it then emerges and goes to the public Internet 422. Or, a different type of destination 412 could be one that actually has one of the system gateways running in it as well. This is where the terminal gateway 416 is, in which case the system is essentially determining all the routing done.

The system helps to address the problem of an enterprise analyzing the traffic for their devices that are out in the world without having to bring all the traffic back to one central place. For example, consider an organization's data center. The organization may scrub all traffic exiting the organization for vulnerabilities, including running IPS on it, and the like. Some companies perform very close inspection of the traffic. For example, many companies will block Facebook. They will inspect everything. The inspection may be done from a centralized location. There can be a box that sits in the middle.

One question is how is that done in a world where a phone may be, for example, connected to Starbucks, and are people in London. One way to do that, and the figure of merit from a performance standpoint is one, is any latency being added in the pipe itself. And two, is it an unoptimal route to get the traffic through the scrubbing station? And in the case of a traditional enterprise where the scrubbing station's halfway across the world for a global workforce, it can be a very unoptimal route.

So the question is how is that problem solved. In a specific implementation, the system addresses that by having a global distributed network of these gateways. And a device runs all of its traffic through the optimal gateway near it, and then that gateway sends the traffic onto its destination. And there are policies and rules. With the exception of perhaps the largest companies, no company may be able afford the manpower to build that out, particularly in carrier data centers. For example, costs can be shared over multiple customers.

A specific implementation includes a multitenant distributed technique. There can be a need to have authentication. For example, one may need to know the user is from Cisco or are from Juniper or from Google? A reason is because all the packets are running through the same gateway but their pulses are going to be different. Some companies have internal services that are accessible by running a VPN. It can be very frustrating to configure a VPN on a mobile phone. However, for some users, if they want to access the internal services, the VPN must be used. However, if all traffic is running through a local gateway, most traffic may be to, for example, Google; it may proceed straight to Google and not be deviated from its path and there can be a network policy applied to it.

But if the user wants to access an internal service, the question is how can the user access the service without having a network connection to the inside of an organization's network where that internal service is running? For example, with a user in London accessing local London servers the packets just stay in the UK. However, if the user wants to access something here in the U.S., how can that be accomplished? By having all the packets running through a gateway, the system can authenticate that user and see if they're authorized to access that service and then selectively route the packets for that service back to San Francisco through a secure tunnel, back into the enterprise. And the enterprise is able to do access control so not everyone on the Internet can access that service; only people who are authorized to.

In an embodiment, analytics are performed on top of the system. One problem right now is a user's device may be compromised by an HR person opening up a resume that's actually a malicious .pdf. They malicious .pdf may subsequently infect the user's computer by accessing the source code repository—made possible because the organization may have a flat network.

However, in an embodiment the system includes intelligence on the gateway. So the gateway knows who the user is and what the user is accessing and is able to perform analytics and access control on a more granular than just a “do you have access to this level.” It may perform an anomaly detection. For example, there's never been a person from HR ever to access the source code repository. Then all of a sudden, a laptop is accessing the source code repository. And then there can be a permissive access control policy. The system may allow everyone to access everything, but anomaly detection layer may identify an activity as an anomaly, this group has never done this thing here before, so it will alert an IT admin.

The business opportunity is multifold. For example, many business devices connect to unencrypted Wi-Fi. Businesses don't like that because not all of their traffic will be encrypted by SSL, or maybe they are just worried about people knowing what their traffic is. So one business opportunity is having a secure VPN service that makes it very easy for a user, while the user is connected to an insecure network, secure their traffic.

Bringing the appropriate traffic back to the corporate data center for internal services, that authorization-use case, that's another example.

A third example includes bringing all of the things that are in the corporate data center filtering traffic right now to this broader distributed room. There may be network efficiency-use cases. Another use case is the anomaly, e.g., a security- and inspection-use case to detect when users are actually doing weird things in the network. Another one is, if the user is in that middle, the enterprise may want to know where corporate data is flowing. This is a problem right now. It is generally speaking, corporate data is e-mail, as far as most people are concerned. People are worried about downloading attachments. For example, maybe, getting the quarterly reports before they're released onto this device. The enterprise wants to know, make sure that if this device is lost or stolen, the enterprise wants to know what was on there. And in the case that it is lost, nothing leaks off of here to an unauthorized place.

So one way to do that is on the network so the system can tag and see all the things that are coming down from the e-mail server to the device and the system can see all the things that are leaving the device. So the system can identify, this went on and this left and it went to this server, is that authorized or not? And that could be blocked in a particular device, or that could be just monitored as an inventory, e.g., a security event. There can be a manifest, e.g., the device took possession of these things, these things are on the device, oh, these things are deleted. So that if the device is lost, the system knows exactly what the user lost or if the user has applications on the device, the system knows which applications received what data from the corporate repository.

There may be the provisioning of connectivity, a proprietary network, a proprietary pipe, which is providing actual network connections and several intermediate gateways. Or there can be an arrangement with carriers and/or appliances where the analysis gateway runs in here and is essentially, a system provided virtual pipe. In other cases, there can be corporations, or individuals, who will pay for that kind of a local gateway capability on the device or on their local home Wi-Fi or corporate Wi-Fi access point or the like to start the whole process. It enables all kinds of other business opportunity because the system is essentially separating and controlling via policy issues of identity, authentication, authorization, privacy and anonymity.

These tend to all get bundled up together right now. For example, there can be an unsecure connection in which case the user has none of those things, or it's encrypted, but the encryption doesn't necessarily provide anonymity; it doesn't necessarily provide privacy; it doesn't necessarily provide any protection against malware. There's no analysis done on content, and so forth. It works against the kinds of performance and analysis things that the user may want to do efficiently within the network. HTTP 2.0 presents opportunities. Commercial implementations are nearing. And it creates what is essentially breaking that model of all of those things tied together and it is doing cross-layer kinds of things as well, which will enable not just improved performance, but increased granularity of security. There is, however, little development around the security aspects.

Currently, the internet is quite fast and routing data around the world would be noticeable on a device. Some places where a global infrastructure may be used includes potentially also giving enterprises control of the keys so they can tunnel back to their infrastructure. Alternatively, a multitenant environment may be spun up that will be provisioned with those enterprise keys, that the enterprise technically controls, but the infrastructure by which they can manage it can be built in a very, very simple way. There can be many types of different policy on what the enterprise will allow and where. As an enterprise, the system can give a user a one-click button to spin up a global network-filtering layer that is in every major data center around the world.

Somebody would take years to build that for traditional enterprise. With the infrastructure built up the system could leverage the “cloud”, like private clouds, there can be a private cloud in fifty different data centers around the world and spin up machines on behalf of enterprises that can do their filtering. So even if the infrastructure remains the same, but the system can build the foundation that the enterprise can manage that there. So there are a number of different business models available.

In a specific implementation, the system is completely proprietary. In another specific implementation, the system includes a global cloud. In the case of an enterprise, a global cloud may be spun up for the enterprise so that many different data centers can be abstracted (e.g., fifty different data centers abstracted). And if the enterprise wants to have filtering boxes, so it can specify an IPS, and each one of those filtering—there's fifty data centers, and make it so the enterprise clients can talk to the nearest one, and the traffic goes to the right place. And the system can set the plumbing up and all the routing. And so that system doesn't actually intercept any of the traffic. A large enterprise might instantly spin up machines all over the world in a way that abstracts the actual cloud. So there can be a global infrastructure as a service. There can be a global platform as a service.

In the past, it may have been acceptable to have devices that were not on the enterprise facility premises. VPN was used to access them. But increasingly, the enterprise includes large collections of other cloud services which are in other places. Use of the VPN-model to access such services is not scalable.

For example, the model requires a VPN to one service and then another VPN to another service—similar to a daisy chain. In contrast, a feature of the system includes authentication in one place which provides protection regardless of how and where the user goes.

There can be many end user facing features that are enabled by this system. The local gateway of the system allows controlling when data is sent on and off the device. In a typical routing infrastructure, latency is a concern. That is, there is a desire to transmit a packet out as soon as possible. However, in a mobile routing infrastructure, sometimes latency matters.

For example, a user may be Web browsing various pictures. The user's phone is on and the user is looking at pictures. However, a lot of the battery usage on the device happens when the screen is off in the background, user e-mail. And there is a unique aspect to the ways cell radios work. Consider that there is some channel bandwidth and it is fixed in a cell. There are many more devices than could ever actually use that. So if each of those devices is transmitting at once, there would be saturation of the cell (e.g., everybody at a football game sends a text). So that is when the channel is saturated.

There can be idle bandwidth where there can be a very, very small channel for a few packets here and there; there can be a small amount of bandwidth or a large amount of bandwidth, such as for streaming a movie. Negotiation can be over a control channel. If bandwidth is unused after a certain period of time, the user get pushed down to a smaller amount of traffic so the user cannot just occupy a channel and just keep it open all the time. So what happens is when the user gets an e-mail in the background, about every sixty seconds, send a message. And so what happens is, sixty seconds, the device sends some data, the device negotiates for a big channel, and then after twenty seconds, the network might bring the network down, another twenty seconds brings the network back down again. But let's say the user has four or five applications that are each in the background sending data. Assume that they happen to send data twenty-one seconds apart. What happens is this hysteresis where the devices are constantly switching channels back and forth because it is not timed.

So if there is a gateway on the device, particularly in circumstances where latency is not the goal which is traditional network routing: there is a packet, send it; and not, the device has a packet, let's wait for some sort of other event. A feature of the system includes adding context to that routing decision to recognize, for example, that the screen is off Therefore, the user is probably not using the device. And the system knows on average, the user gets this many things per minute and there can be a determination that they're from the e-mail application and the system knows what its latency bounds are.

And so what the system will do is to hold the packet for about, for example, a minute. The system may acknowledge to the kernel locally that the packet was received by the other end so it doesn't try to retransmit it. Other techniques include store forward. And then at the right time, there may be ten applications with the traffic, send them all at once in a batch and receive the reply and go dormant again. So it is the sending of one large packet in one large letter instead of a many little packets. It is generally more efficient because the system is negotiating one channel, do all the transmitting, then bringing it back down again.

One benefit includes a battery saving aspect. Another benefit relates to knowledge of the user and a billing relationship with that user and their traffic. The system can address the problem of paying for content on the Internet. Consider, as an example, the Wall Street Journal where a user has been sent an article. The user is not a subscriber, does not wish to pay the yearly subscription, but merely wants to read this article. But, payment can require typing in a credit card number, which can have an adverse impact on the user experience. In an implementation, a feature of the system can note that anyone coming from here, just bill us for it. The system can do billing on the backend and say the user might just pay a monthly fee and get all of its unlimited access and then the system handles the settlement on the backend. Or the system can include a micropayment model where, for example, it is one cent per article. It can be perhaps twenty-five cents on the user's bill every month.

For a content owner, who may be receiving a very large number of checks, the system can help reduce the friction between transactions. An issue facing content producers is the pay wall problem. In regards to ecommerce, e.g., click here to buy it, because there is an authenticated network link between the system and the person, the system can reduce fraud. For banks, they do not know if the other person on the other end has malware on their machine or not. However, because the system may include a presence on the device, the system can inform the bank, that this person has malware on their machine, don't trust them. Or this person does not have malware on the machine and it is a trusted customer and verify it and so forth. The services can act at different trust levels based on that as well.

Since there is agency on the device and an added station to the end place of the packet, there are many services that can be layered into the network. There will be increasing gains because the system will attract more consumers, more content producers. If there are enough users, and they are willing to pay a premium tier for Internet, by buying these private links so the system can negotiate better pairing such as high speed pairing with people and also use dark fiber in places that are highly congested, there can be private routes. And so if ordinarily, the user is getting from here to YouTube and it is over a fairly congested public route, if the user is willing to pay a higher tier of service, the system might literally lay fiber from the system to a data center (e.g., a Google data center) directly peer, and then anyone who is on this system would receive a faster Internet experience.

Authentication to the system can be via password or PKI. In a specific implementation, the pipe system may be used for all of the network connectivity of any flavor, and all connections to the pipe authenticate. The pipe infrastructure knows that the user has been authenticated. And it may choose to only remember at intermediate gateways; that the user is an authorized pipe user, not the actual identity of the user. The system can separate identity from authentication from authorization from encryption, and so forth.

The pipe system may be combined with legacy infrastructure. Consider, as an example, an enterprise or N cloud enterprise. For example, there can be resources at Amazon, Rackspace, in Houston, Atlanta, San Francisco, New York, and so forth. Presently, there are VPNs in all these places. A user (using a user name and password) can connect into that and access the services. There can be resistance to implement a full pipe system by asking an enterprise to replace their VPN infrastructure. There can be one or two modes such that these gateways can tunnel into the existing VPN infrastructure and into this MVPN (Mobil VPN). There can be two ways that can operate. One is there is one global system pipe that can be connected into and route traffic for many users. The alternative is as a user who wishes to connect to an internal service that is not accessible to the Internet. And either on demand or already active, a VPN connection is established on the user's behalf into the enterprise to the data center that hosts that service, being simply because the user visited through a Web browser.

Thus, in an embodiment, there can be access-triggered VPN, which is one mode. In an embodiment of a second mode, the established VPN has created a VPN connection under a user account to that service, and it might keep it open indefinitely. So that the user does not have to think about multiple (e.g., ten) VPN connections; not all of the user's traffic is routed through Houston when the user doesn't want it to be. Rather, the user simply visits a Web site and it works.

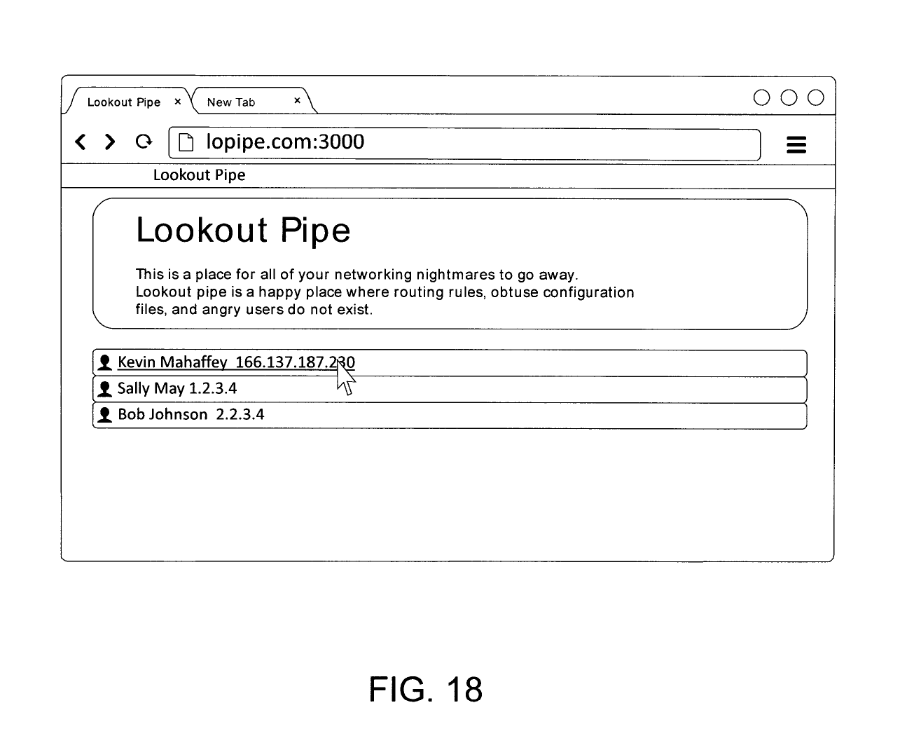

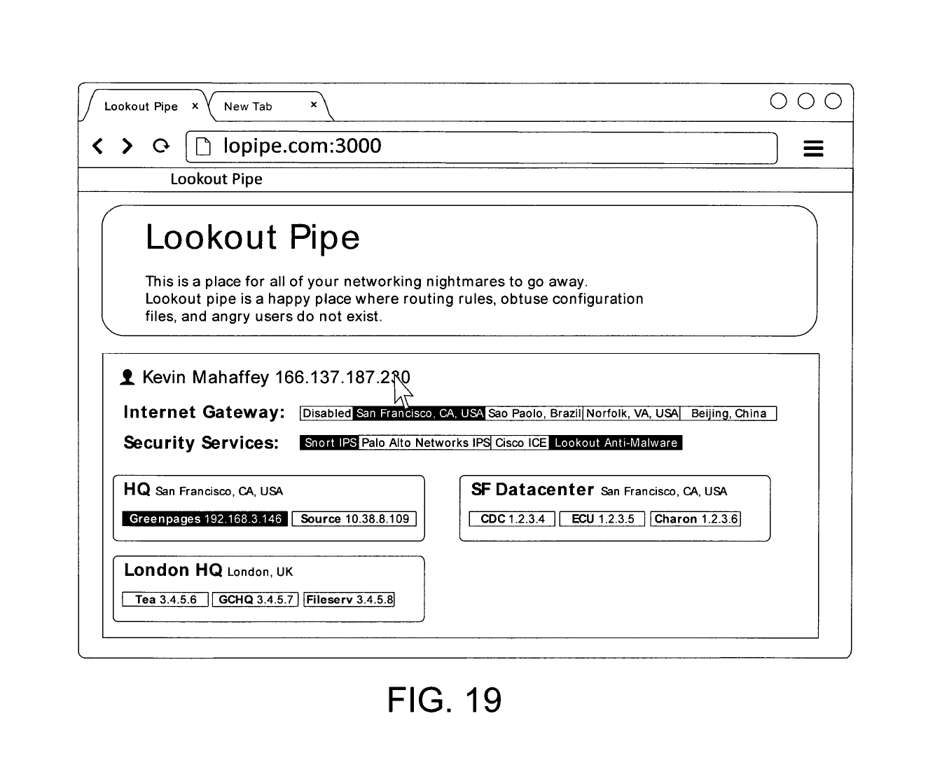

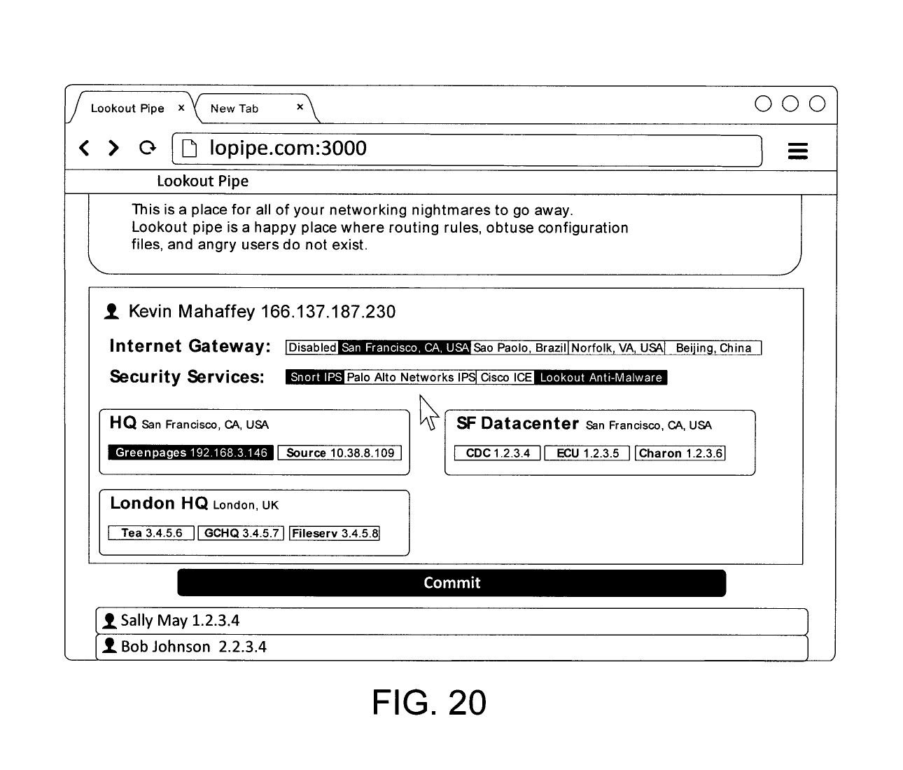

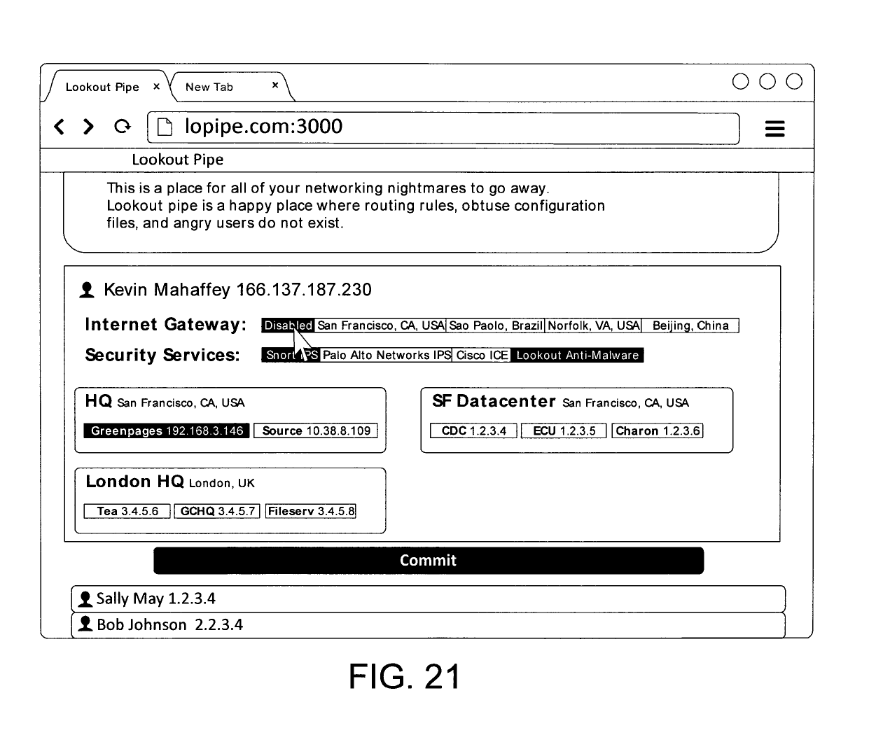

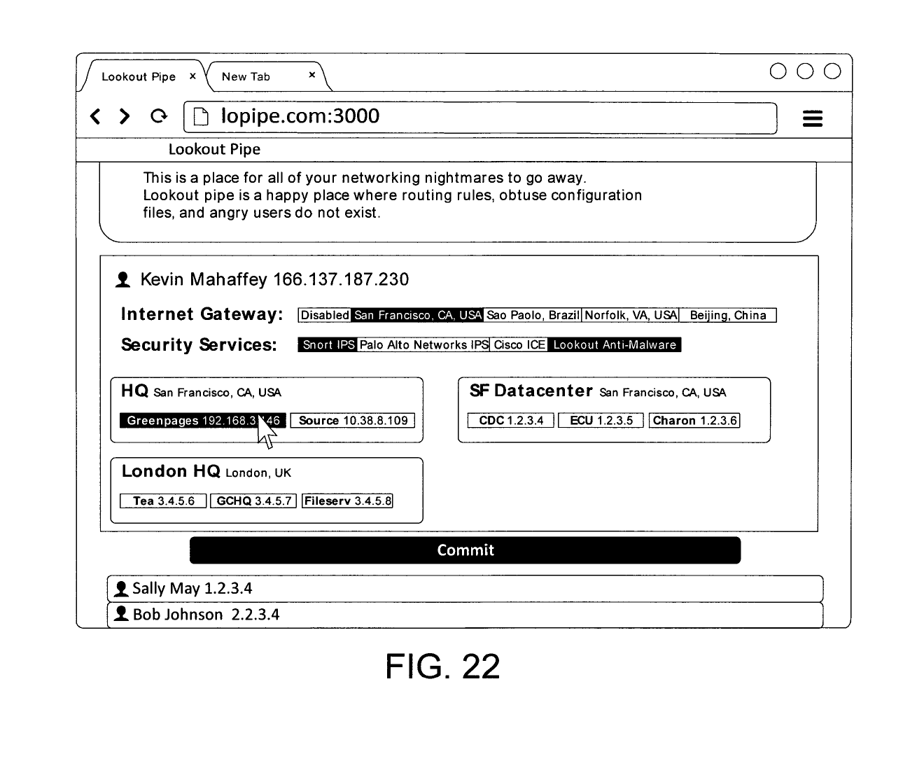

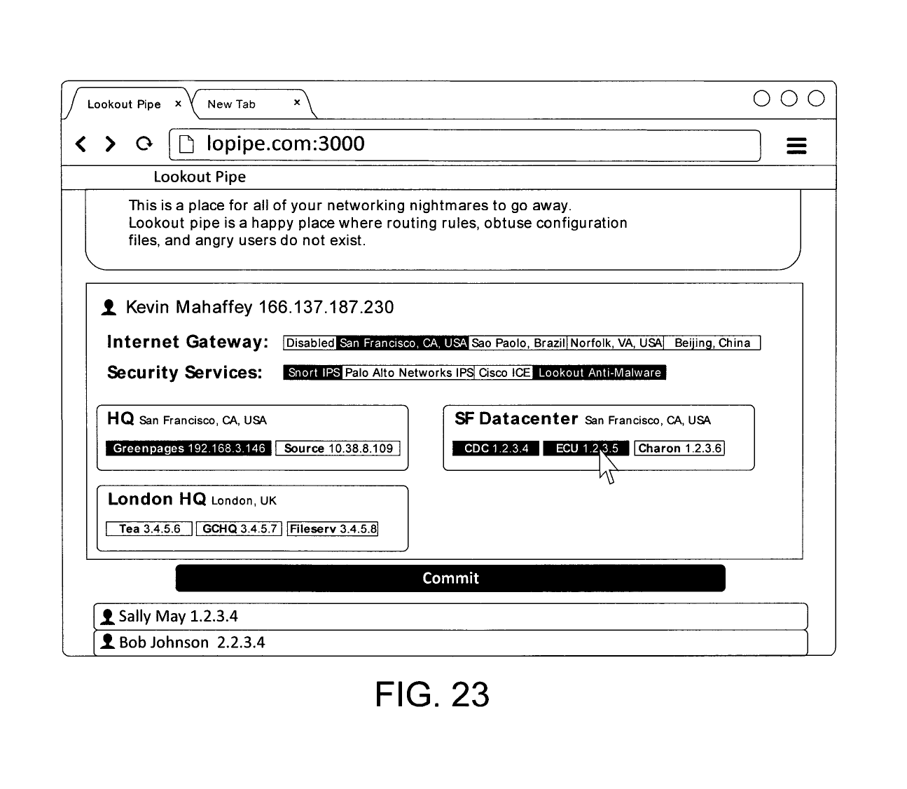

FIGS. 18-23 show some screen shots of a specific implementation of the pipe. In this specific implementation, the pipe is referred to as the Lookout pipe. There can be a control panel that identifies the services to access. There can be a VPN connection from the user's machine, (e.g., phone) to the cloud, and the cloud had a VPN connection back into the system. So most traffic would just run from the phone to the cloud. For example, it can be Amazon—to Amazon and then exit to the Internet. But when the internal service is entered, the system knows that the service is a private route, does the DNS so that it realizes that's a private resource and the user is authorized to do it. Here's the IP address the device should talk to it at and all traffic to that IP address is routed to the cloud and then into the VPN connection to the internal corporate data center and then back out. So as a user, she is just trying to visit a Web site. She doesn't know that it's actually taken an entirely different route through a VPN connection. The system seamlessly handles that.

Such a feature is something that has not been possible with traditional techniques, like, VPN. Either the device has to forward declare and configure the client what things the user wants through the split tunnel which the client has to be aware of and cannot be done dynamically. Or all the traffic is tunneled which has the problem of bringing it back to one corporate data center and it is slow.

In a specific implementation, techniques are provided for negotiating routes, determining destination, authenticating, and policy configuration. If a user accesses an internal service, the cloud system may bring up a VPN connection to the device in order for the user to do that seamlessly and then brings it down when the user is done accessing it. Techniques are provided for functioning in a local network. There can be machines plugged into the wall or Wi-Fi or a software-defined network. In a specific implementation, aspects of the system relate to running all the traffic through the system in the cloud. In another specific implementation, the system can be run locally. So for example, in the example about the HR person opening the malicious .pdf document and then accessing the source code repository, when things are running through a physical switch in the wall that can be more challenging than a cloud implementation. Switches do not understand applications and users typically; they understand packets, and headers.

With a software-defined network—see examples of running all the traffic through a local gateway and then it stays on the local network—it doesn't go up to the cloud, but it routes to one place. Or a software-defined network such as NSX from VMWare, there are several open source projects to do this. There can be intelligence at the virtual switch. With application or user awareness, there can be the creation of a per application virtual port. A virtual switch may provide a virtual port for a machine, a virtual port for another machine, and so forth.

Or if running virtual VMs (e.g., a server that is running all full operating systems into VM), each one of those VMs may be given a virtual port. This can be extended such that each application on a device has a virtual port. This can be further extended such as in the case when the application is a Web browser. Each individual Web application that is being run in the Web browser may have it.

There can be a routing policy that defines routing configuration. The policy may identify which traffic to run, filtering criteria, and traffic destination. There can be two aspects of conditions and actions. They can be processed in a distributed way. Processing can be in one place. Everyone may be aware of everything. Locality may be attached to each configuration rule. Attachment can be done at a terminal gateway during an intermediate gateway and then, if different gateways have different capabilities, there can be the Symantec™ DLP capability on this gateway but not on another gateway. Care must be taken to ensure that if all of traffic's required to run through Symantec™ DLP, that the routing system knows how to get it to the right gateway.

Further, it may be not be configured of gateway A, B, C, D; it is a Symantec™ DLP gateway and the system knows which gateways have Symantec™ DLPs, so it just finds the nearest one. There can be all sorts of Symantec™ policy applied to topological infrastructure.

The traffic can carry authenticated indicators that specify whether this has been through this required gateway type already or it has not. For example, something that has already been scanned, does not have to be scanned again. The system can provide for service discovery. For example, if a user wants to access an internal service, there can be DNS awareness in the system. And because these are all on private IP addresses, it might be a situation where in these end-cloud architecture, the private internal IP ranges might actually be overlapping. For example, 192.168.0.1 and it might have two 192.168.0.1, so it might be technically impossible for the user to connect to both VPN connections at once.

Regarding FIG. 5, in an embodiment of the system 500, there can be a home life 502 and enterprise 504, and everything in one place may have the prefix 192.168, which is one of the IPv4 address ranges defined by RFC 1918 for private networks. Device 502 on the Home network and enterprise 504 may connect by VPN 506, providing a tunnel between two separate private networks that do not share an address space. Network appliances such as firewalls often provide a network address translation (NAT) service to facilitate the connection between two network endpoints on different sides of a firewall or network gateway. Device 502 may connect by VPNs 508a . . . 508n to the cloud 510a . . . 510n. There are naming and addressing considerations for this as well. In this cloud system 500, there can be a mapping of remote IP addresses because the system knows who the user is. This is unlike a traditional NAT solution in which there is a translation of IP addresses between an “inside” and an “outside”; in this system, there are many private networks connected together, and the IP addresses visible to a device connected to the system may be translations of the IP addresses used by actual network destinations. The system can map a remote IP address to an unused IP address (that is, unused on the network to which the device is locally connected). There can be a dynamic allocation of network addressing, or of network address translation. It may be DNS triggered. So, for example, if one looks up a host name, e.g., GreenPages.corp.Lookout.com, that internal address of that server on its own network might be 192.168.1.1, but if the user is on a network that already has that machine, e.g., that's the address being used by the user's local router at home, then the DNS might return 10.1.2.3 and statefully store in the routing system the fact that, for this user, 10.1.2.3 is really this thing over here that is routed through this VPN connection as this user and it is mapping to 192.168.1.1. Thus, the functionality of network address translation is not a thing associated with a single network gateway between a private network and some other network. Rather, the network address translation happens for an identified and authenticated user, for connections from the user's device to a multiplicity of other private or public networks, via various VPNs, tunnels, or other network gateways or connections.

That can be a stateful thing on the cloud that the clients do not know about. All the system may know is that the system should just talk to this. And so the system can have DNS-triggered network address translation. So when the system looks up a host name, it dynamically provisions the ability to talk to that thing. And that might spin up a route negotiation, and the VPN connection might be triggered on a DNS lookup as opposed to the user trying to talk to the system because from a latency standpoint, the DNS lookup happens first and then it does that round trip that is sometimes 2- or 300, and then the system uses the TCP connection to that end device.

If the system can spin up a VPN or coordinate that route, as soon as the system knows what the VPN looks like, it can do the DNS lookup, and the system has saved a round trip and it can parallelize that process. This is a very good optimization. A distinction is because the pipe is authenticated to user, everything including DNS services take advantage of that authentication. The answer for another user from this DNS server may be different because the user is not an employee. That other user may not get to see or browse that DNS directory tree of host names and so forth that the other user would be able to. So, the system may send the same request to the DNS server, where the one user is told it does not exist and the other user is provided an IP address for it.

These features can be based on the authenticating of the user. Different flavors of things can be performed because the system can assume it has authenticated that user. This can apply to DNS lookups which is where things are, mappings from names to addresses. It applies to all the routing cable features which is how does the data get to that destination. It applies to actions in terms of transport in between, in terms of inspection, in terms of priority, and so forth. Many network layers or network functions may be touched.

One challenge is in wireless networks. Packet loss can happen due to radiation, background noise, congestion, and so forth. But in TCP networking, it is assumed that when there are loss of packets, that means there is network congestion, meaning that the network slows down the user's network transmission, the network slows down the window, shrinks the window. And this has been a big problem for wireless networks, just historically, and there have been a lot of tuning to that algorithm.

One way to solve this is use forward error correction, e.g., forward error correction codes like turbo codes or other codes so that the system send more data. So that if there is a packet loss without asking for a retransmit, the network can recover that so long as the network tunes its error correction rate to the amount of expected packet loss. This can be referred to as route awareness and be bundled on top of the tunneling system. There can be the bursting in wireless links. Another is when mobility is involved, the handoffs from one big station to another. This can be as with cellular networks or Wi-Fi as Hotspot 2.0 becomes more prevalent. It will be possible for people to have mobility scenarios automatically connecting to Wi-Fi hotspots as well. And on the handoffs, when the network loses connectivity the system can provide ways to address that such as by policy and context.

Some phones have both Wi-Fi and cell. Typically a phone prefers Wi-Fi over cell; but this can be a configurable policy. If the user got into a weak Wi-Fi signal but the user still has good cell, the user's network will basically be dead for thirty seconds while it is trying to switch off. This is kind of a function of the Internet was made to have single home. The user device has a single home because that is how things get to it. However, if the point of presence on the Internet is somewhere in the cloud and the user has multiple connections from the phone to that cloud so the user can do it from her cell network and Wi-Fi simultaneously, the system may send the packet to both places. And on the device, the system can recognize the same packet.

For latency-sensitive data, if the user's Wi-Fi went down at that point in time, the user would at least get it from one signal. Or the user might choose to send it via both not knowing if the Wi-Fi signal's bad right now because there's typically about ten seconds or so before the user or device realize it's dead. Send it to both the cloud because it is both going to the same place and the cloud can disambiguate it and singularize it before sending it out so that the user can have multiple gateways and minimize the handoff. There can be connectionless Wi-Fi. Consider Wi-Fi access points; a lot of them are unencrypted. But connecting the user and associating the user to a Wi-Fi access point is expensive, takes time, and particularly if the user is moving, that the network won't have enough time to do it. However, the system can see existing traffic on that network.

So the system can spoof traffic from a legitimate host to the Internet using maybe a protocol not being used or using a port the host isn't using (e.g., a very high PCP or EDP port). The system can spoof from that host to the Internet and the Internet can respond to that host and the host would be unaware of what this is, so it must be rejected.

This can be performed on many different devices simultaneously, but to the Internet, it just looks like the user might only get one packet outbound and one packet inbound before the user is gone. And it can be difficult to maintain long term connections over something like that. But in the cloud and by using all the Wi-Fi networks around the user and sending packets up to the cloud—and the network might send the same packets through ten different networks just hope one gets there. And the cloud might send the return packets through ten different networks and hope one gets to the user that the system can sniff it. This is generally not possible on a normal network, but can be performed in a cloud-based system.

There is a fundamental difference with respect to IPv6. Instead of being the network operator where the operator cares about the efficiency of the network as the whole, the system is doing things that care about the efficiency from the standpoint of the end user which means that system may do some other kinds of things. There can be a pooling of the bandwidth between two connections. So if the user has a really fast cell connection and a Wi-Fi connection, the system might use both in parallel to do a download. And send half the data through one, half the data through another and reassemble it. The system can provide for a proxy in the cloud that allows this to talk. So the problem is the service has to be aware of it, the hardware the system is talking to has to know about it. Whereas it'll be many years before that most services are configured to be aware of that. However, by doing all of this through a cloud proxy, to the rest of the Internet, it just looks like a fast Internet connection, even though the system is doing all sorts of network manipulation on the backend.

Regarding route optimizations or route measurement, if the system has two ways to get from here to, for example, Google, the system might choose, if the system has multiple upstream providers, instead of just picking the lowest cost one, the system might actually ping round trip measurements every three seconds and measure, attribute such as this one is congested, start routing traffic over here.

Discounts and other entitlements can be provided to anyone who comes to the pipe (e.g., ten percent off on Amazon). There can be private advertising so the system can inform the advertising networks of demographic profiles of the users, but in a way that the users get to set their demographic profile. This allows the network to act as a secure but anonymous identification system so the user does not have all the data networks building profiles on the user, instead the user gets to build her own profile and then share it with the systems' ad networks.

In a specific implementation, a secure pipe is provided between the computing device and the destination. The pipe may be referred to as the Lookout Pipe. Some benefits of the pipe include rapid control of connections and internet traffic, a control authentication mechanism, increased speed, lower bandwidth, increased security, increased privacy, adblocking, extended device battery life, and others. There can be a batch server which pings when screen is off so that it saves the device battery. Currently apps do not organize this well and keep the device in the high channel all the time. Currently, there are limitations placed on connectivity options and features by carriers. For example, when traveling abroad connectivity may be limited to a particular carrier's or carrier partner's network. In a specific implementation, a secure Wi-Fi (e.g., end-to-end encryption of network traffic and messaging) is provided. A secure connection offers many benefits including, for example, helping oppressed people and providing an ability to “pick malware off the wire.”

In a specific implementation, the pipe includes a cloud-based network security platform that allows users to have all the same protection that users have at their offices everywhere they are. Features of the pipe include cloud based VPN/SSL and WAN acceleration, improvements in security, privacy, speed, performance, connectivity, and battery life on devices. Problems related to network overhead on operator networks such as signaling, etc; background processes on a user's phone sending data at random intervals making the phone radio turn on and off can be addressed by piggybacking pings.

In the event a device is compromised, its internet access can be revoked. In an implementation, with a click of a button, a user can access all of their internal applications just as if the user were in the office, rather than being denied when trying to access the company's internal servers. The pipe also allows users to seamlessly add security to all of their devices without having to tunnel all of the data traffic back to the data center and slowing down all of the internet.

FEC (Forward Error Correction) may be used to reduce retransmissions. An “overnet” can provide features such as a more secure experience and convenient experience as compared to other connection techniques. Access to premium services may be available when using the pipe. Discounts may be provided when online shopping when using pipe. Usage of the pipe may be combined with demographic tagging for advertising (user opt-in/opt-out).

Aspects of the pipe may relate to security (e.g., always HTTPS/VPN'ed/encrypted, detect Malware before it hits device, can see all user network behavior, or firewall services inbound/outbound), browsing (e.g., safe browsing, optimized browsing (faster experience), identity management, cookies, Web bugs/tracking, prevent network or other app fingerprinting of website (network behavior, browser process size)), voice/messaging (e.g., keep dropped calls alive, provision from multiple BW providers, or IP-based texting using data connection), data business (e.g., all user browsing behavior known), connections (e.g., always encrypted, always through secure server(s)), improved scalability, lower cost, increased speed, reduced extra hops, BYOD/MDM management (e.g., provision “Pipe” solution within enterprise walls, apply enterprise polices/firewall for employee mobile devices, or compliance enforcement), privacy (e.g., detect PII leaving device, parental protection built-in, data protection outbound), unified login or single signon system, combinations, Internet of Things (IOT), social, home networks, or combinations of these.

Certain communication protocols were designed to have data used rarely. In an embodiment, the pipe provides an always encrypted connection that is agnostic to how a user is connected. Mechanisms are provided to help make sure the pipe is on or always on. For example, there can be detection on public Wi-Fi hotspot, etc. If encrypted pipes have latency issues, then the system can turn on levels of encryption based on perceived threat environment or destination or from certain apps. For example, the system can detect malware before it hits device. There can be a toll road. There can be leverage of a sensor network to feed data and threat intelligence into protection of the overnet and the cloud using data from a public application. The pipe can be protected by filtering malware, exploits, and attacks.

Privacy can be ensured. In a specific implementation, the system includes operator-level APK scanning. In this specific implementation, given network-layer access from a carrier, the system provides a safe APK HTTP Proxy. The safe APK Proxy may intercept APKs as they are requested by a device and either a) ping the system server (e.g., Lookout) to see if the APK is known malware OR b) if the system server does not know of the APK, upload it to the server. This allows the system to provide some amount of Android-security across all devices, not just system- (e.g., Lookout) enabled ones and provides a large sample binary acquisition system.

The mechanism for performing the inline scanning may act as a standard transparent HTTP proxy, with some amount of intelligence for request handling. Any file with a request or response name suffixed with {{.apk}} may be checked. An APK file is similar to a ZIP file, so the APK Proxy may contain additional intelligence to determine if the file being transmitted is a valid ZIP file (e.g., checking for the magic numbers) and it may look into the [file headers] to verify that a {{classes.dex} } file is present.

Provided the file appears to be a sufficiently valid APK, the APK Proxy may then checksum the file and hit a system provided API to determine whether the checksum matches known malware samples. If the server responds stating that the checksum is *not* known, then the APK Proxy may upload the file to the system out of band, while servicing the request.

If the file is known malware, the APK Proxy can either reset the connection causing the download to fail, or send the requester a different APK such as a stripped down Malware Scanner or the like.

In another specific implementation, a system includes a security and rewriting proxy to provide a safe and rewriting proxy for various communications. In this specific implementation, a proxy stands between supplier and receiver. The proxy ensures policy is met for object. Policy can include: valid format (e.g., no buffer overflow attacks possible from malformed files; format is what it is supposed to be).

The proxy can transform object from one format to another; e.g., from PDF to JPG or HTML; from JPG to PNG; from format A to a smaller space format; from a list of formats B; from apk (identity) to apk but scanning for malware and blocking or notifying; from apk to a rewritten apk with decorations around all internal and external calls, network connections, intent bindings, etc., to meet policy objectives. E.g., like no content from location in blacklist; no content sent to anywhere not on whitelist; archive copy of content sent off box; interdict certain types of content sent off box.

Other examples of decorations include code that can be switched on or off via authorized external policy to do things like: log all invocation parameters and results; perform additional validation or enforcement on interfaces (e.g., no strings greater than length 100 or containing IMEI or other PII); blocking call and return a predetermined simulated result. This “apk passthrough” proxy with rewriting can allow any application to be externally controlled by authorized policy for the device.

There can be a recording of all local modifications made on device by app for many purposes such as audit; transfer of app as installed to other device (includes all settings set written updated by app); can enforce finer grained permissions or policies like can only do location when app is in foreground or not more than x times per day or session; or cannot obtain location at certain times or when in certain places or if battery lower than a threshold; or cannot display ads outside allowed locations; or can limit network locations connected to only certain ones directly or through intent processing; can limit what intents can be listened or responded to.

The rewriting process to decorate internal and external calls can also be used to collect app-specific behavioral information. The process can involve annotating every function or system call, log parameters and parameter lengths, And supporting dynamic policy injection on each such CBPE (Context Based Policy Enforcement Point). E.g., an enterprise could use CBPE for a patching process or based on app trust level, which can include discovered or determined attributes such as: a system or driver or hi-trust app; or a good app; or an untested app; or a suspicious app; or a known bad app or signer; or while device is in a specific geo location; or during a specific time period; or while user is employing device on a particular mission (e.g., a military user of device who is using the device during that mission); or based on a particular determined threat level of the device or a network to which it is connection; or general conditions of heightened threat level; or the presence of particular components in applications, e.g., ad networks or PDF reader capabilities; or the newness of a particular app in time or with respect to the number of installs of the app; or changed permissions by the app from a previous version; or depending on the device user's current mission: if user is in the field on a particular mission speed of operation may be important but security may perhaps be even more so important (mission:=current “mode” of user); or combinations of any of the above. A similar type of process involving rewriting can be applied for network protocols; or for file formats transmitted from or received by the device, or written to or read from a file system; or for browser DOM access or JavaScript calls in a browser.

The process of analyzing normal behavior at calls to set CBPE rules may include collecting app execution profiles, including the number of calls to which particular operating system or library functions or methods; the number of network connections; particular network destination domains; statistics regarding network bytes read or written; or combinations of these.

The system can mine app execution profiles based on pre-existing or newly derived categories and set CBPE based on these norms. CBPE for content providers can include quotas, etc. The system provides for efficient CBPE collection and enforcement rules. There can be CBPE around all usage of intents or binder. There can be CBPE around sensor use by apps. The pending application Ser. No. 14/099,737, entitled “Distributed Monitoring, Evaluation, And Response For Multiple Devices,” filed Dec. 6, 2013, further discusses aspects of such a system and is incorporated by reference in its entirety. The pending application Ser. No. 13/738,850, entitled “Method And System For Protecting Privacy And Enhancing Security On An Electronic Device,” filed Jan. 10, 2013, further discusses aspects of sensor use by applications and is incorporated by reference in its entirety.

A specific implementation provides for installing or running permissions based on criteria such as newness of app type, of user signer reputation threat level mission, geography or time context. Some app installs may be denied, or may be initially denied but permission to continue install will be requested of the device user or of an administrator for the device, or may be allowed but the app will not be allowed to run except in certain contexts, e.g., after certain date time or not after a certain date time (or a combination which can allow pre-provisioning on a device of a new app or a new version of the app and an automatic switch/enablement on the trigger of a certain date/time having been reached or upon an explicit signal); or only run when no high security level apps are running or files open; or only on specific networks (e.g., trusted or home or corporate or public); or to automatically run some apps or automatically switch state on certain events such as a change in network state or connection etc.; or can be allowed but requiring a high level of logging and a high level of CBPE of the system.

There can be a CBPE mechanism that takes snapshot dump of an app state for transmission to server for subsequent analysis.

In order to support android access to resources by multiple apps signed with the same key generates a unique proxy key for each unique original signing key can be generated and used to sign the rewritten apk with that; or all rewritten apks can be signed with a common key for system (e.g., Lookout) rewritten apps but all file and service accesses mediated by the system (e.g., Lookout) policy so as to enforce the sharing/isolation afforded by apps having shared their original signing keys.

A proxy can sit transparently between client and server, e.g., as part of Lookout Pipe. A proxy can be explicitly called from source web page. A proxy can be invoked by rewriting content on the client device to transform URI requests to travel through the proxy. A Proxy can also be used for safe browsing.

In a specific implementation, the pipe may include PoPs (Points of Presence) placed at various locations around the world to improve speed of response. The overhead of a tunnel may be a VPN, such as a corporate VPN to a designated location. The system can provide for outsourced VPN for enterprises. There can be WAN acceleration PoP to PoP; or PoP to device. In some cases, people use VPNs for connectivity not security.

In a specific implementation, a system includes an overnet. The overnet may include a network of globally distributed servers in key strategic countries with privacy/data regulations most favorable to user. Dark fiber may be used to route packets through a fast lane. There can be labeled packets for better QoS. There can be trading connectivity providers as partners.

Consider, as an example, a corporation. Everything, i.e., all servers, PCs, and devices, used to be in the corporation HQ. Now, there are servers in a cloud all around the world. A VPN service may be defined “in the cloud” and it may know access control rules as well as routing rules; there might be multiple tunnels to enterprise boxes. There can be routing tables in the tunnel system that are updated appropriately. Access control for services and QoS can be solved here.

In a specific implementation, a system provides for cloud-based management by the IT administrator. There can be management of the entire enterprise network/etc. for the cloud, because it is a cloud-based service. In this specific implementation, in a cloud-based PoP data may be tunneled there. There can be access to certain resources (e.g., the user wants to access, e.g., the corporate wild). The cloud may include configurable sets of rules. The routing core may know identity, which most cores do NOT.

In a specific implementation, there is a private cloud and/or appliance based solutions. A cloud based service may be provided that can be inserted into another network via existing VPN infrastructure. Communications may be completely seamless to the end device.

In a specific implementation, there is device based access control. For example, devices that are on a low patch level may not be provided access to these services (e.g., network admission control). There can be a selective tunneling policy (e.g., wanting to tunnel all traffic by these apps not those).

In some cases, there may be a connection dominated by packet loss. In wireless connectivity packet loss may just happen and may not be an indicator of congestion. Forward error correction techniques may be used to deal with this. A dial may be set around an acceptable packet loss rate. There can be recovery of lost packets.

Consumer aspects may include a user who pays to access the internet. There can be an arrangement with a content provider (e.g., WSJ) where the user receives access where there is bundled content. A model for services can be packaged like the cable business model. In this specific implementation, payments are made. There is a consumer. There can be an arrangement where there are reduced rates if the user shops via the overnet. Various services and products may be bundled.

In a specific implementation, the overnet is configured for online advertising. In this specific implementation, the overnet maintains a profile the user is in control of. The system may provide this to advertisers. There can be a block of all tracking. A DoNotTrack may be implemented by what is stripped in the overnet/pipe. A model may be provided for revenue sharing to website providers, app developers, and others. There can be a home router pipe service to eliminate the need for client software.

In a specific implementation, the system is configured for small cell applications. Consider, as an example, an IP-based refrigerator. There may be a reluctance to patch that. The refrigerator manufacturer may be allowed to manage the devices securely via the system. The system may provide support for an internet of things that can not manage themselves. The system may provide for a generic infrastructure to manage that cloud. There can be a partnering with operators for provisioning boxes for home router to consumers. A savings of even just one percent of signaling overhead for operators is still desirable.

In a specific implementation, the system provides for continuous monitoring. It can be more desirable for a critical infrastructure vendor to connect to the overnet rather than the internet. “Virtual fiber” may be used where physical fiber can not be run. Techniques are provided for TCP optimizations, and piggybacking, and bundling services together. For example, status reports that are sent everyday may be compressed. There can be requirements for storage/caching on both sides. There can be transparency in the middle of the internet. One problem is SSL. State management over long time periods is not very scalable. An encryption system could use CBC (Cipher Block Chaining) mode or EBC (Electronic Codebook) mode or PCBC (Propagating Cipher Block Chaining) mode, or CFB (Cipher FeedBack) mode, or other block or stream cipher modes. There may be the absence of chaining blocks together. This allows for cryptanalysis. There can be the stateful feed output of a previous block into a next block or SSL servers if they use same key every time. There can be a mode called perfect forward secrecy (e.g., use of a generated key then throw it away).

The overnet may be dynamically rotated to help reduce the ability to be detected. In some cases, circumvention is no longer present and it can be better to hide in plain sight. All traffic may be concentrated into one place. There can be an encrypted tunnel from client to server. For example, China may not be willing to block all traffic to Taiwan, etc. Incentives may be created to disrupt business. The system can help to couple everything to everything. The system may dynamically flush logs of the service.

In a specific implementation, techniques are provided for selecting the places for traffic entry and exit based on legal requirements. There can be problems with knowing who the person is. An entrance node may authenticate a user and verifies who the user is but may not inform the rest of the routers. There can be separate identity and authorization to help thwart interception. Encryption may prevent detection/prevention of malware on content/files/APK downloads, etc.). Thus, a user may choose to use encryption or not. Consider, as an example, a world where a device is preconfigured with an open DNS strategy and it always uses the overnet. In a specific implementation, binaries are acquired over the wire. Secure messaging may be provided through the system.

In a specific implementation, the system can be applied to registered copyrighted material detection. For example, the system may be configured as a digital rights management (DRM) system so users can prove they own material. There can be aggregate reporting of anonymized data regarding flows of copyrighted material. Other detection or enforcement pieces may be provided. There can be detection at a point of source (a public website) but not detection or reporting of users or their activity. The system may be available as a data service to copyright owners so they can know where their content is being hosted; and architected so there is no way (no logs, etc.) that enable the system to know which user is downloading which piece of copyrighted content.

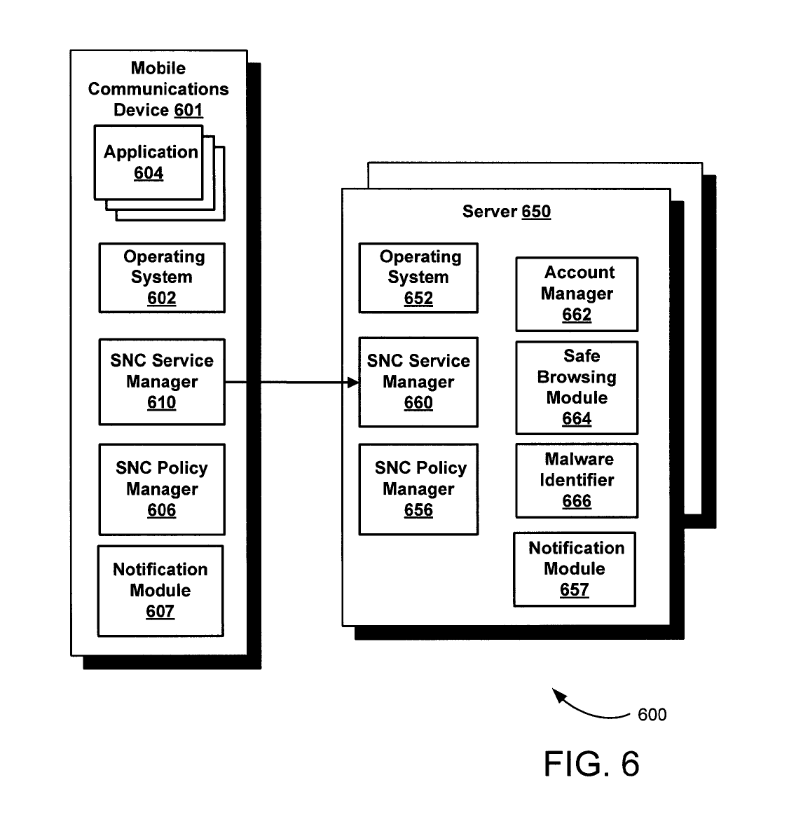

FIG. 6 illustrates an example of a block diagram of a system for automatically providing a secure network connection (SNC) to a computing device, implemented in accordance with some implementations. System 600 may be used to automatically establish a secure and safe network connection via a VPN or other secure network connection technique with a computing device. System 600 implements SNC service managers and SNC policy managers to determine when an SNC connection should be established, and to automatically establish the SNC connection in response to making such as determination.

System 600 may include computing device 601, which may be a computing device such as a Smartphone, tablet personal computer (PC), electronic reader, or laptop computer machine which is capable of a long distance communication such as a cell connection or a Wi-Fi connection, or other personal devices which use other computing devices for long distance communication, communicating with them via shorter distance protocols such as Bluetooth or NFC, devices such as smart watches, physiological monitoring devices, smart headmounted glasses, or other devices which may be worn or carried about a person.

Computing device 601 may include operating system 602, which may manage hardware resources on computing device 601 and provide services to one or more programs or applications 604 installed on computing device 601. Accordingly, computing device 601 may include one or more applications 604, which may be software programs implemented on computing device 601 that provide one or more services or functionalities to a user of computing device 601.

In some implementations, computing device 601 communicates with server 650, which may be an account creation server used to provide secure network connectivity to computing device 601 and applications 604 implemented on computing device 601, as discussed in greater detail below.

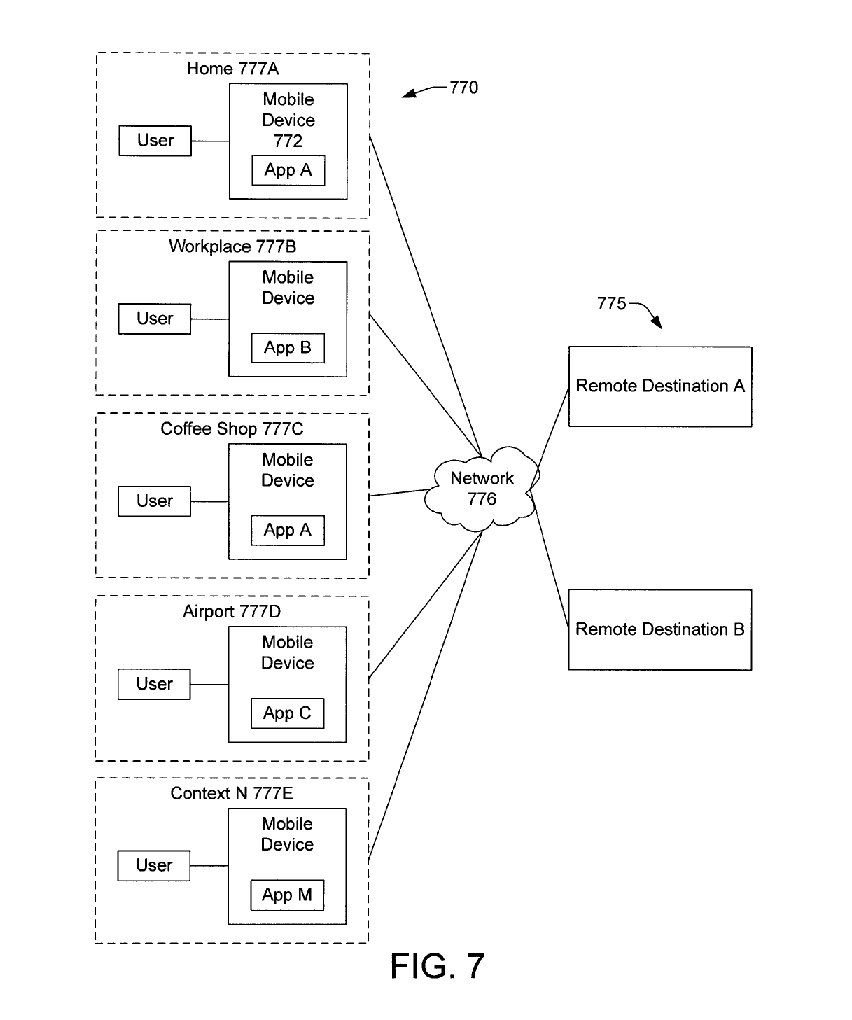

FIG. 7 shows a block diagram of various contexts 770 in which a computing device 772 may connect to various remote destinations 775 via a network 776 (e.g., wide area network or Internet). The network is as shown in FIG. 1 and described above. A remote destination may include a server or server system including a website, web server, application server, corporate or company network, service, computing node, and the like. A remote destination may be referred to as a target destination.

As an example, in a first context 777A, a user may be at home. While at home, the user may be using an application program A on a computing device 772 to exchange data with a remote destination. As another example, in a second context 777B, the user may be at work. While at work, the user may be using an application program B on the computing device to exchange data with the same or different remote destination.

As another example, in a third context 777C, the user may be in a coffee shop. While at the coffee shop, the user may be using an application program B on the computing device to exchange data with the same or different remote destination. As another example, in a fourth context 777D, the user may be in an airport. While at the airport, the user may be using an application program C on the computing device to exchange data with the same or different remote destination, and so forth.

Users may desire a secure connection (e.g., VPN) for safe communications from a mobile device in some situations, and not at other times. For example, when the user is in the user's work environment, connected to the company network, the user may not want to have a VPN connection in place because such a connection may add undesired overhead and complexity.

When the user is at home doing normal browsing or other activities, the presumption could be made that the user's home network is secure, and once again, the user may not want to have a VPN connection in place because it may add desired overhead and complexity. For example, transmitting data through a secure tunnel or connection such as a VPN may include encrypting and decrypting data packets. Encryption and decryption involves computing resources such as processing time. Network throughput and quality-of-service (QOS) may be reduced because of the encryption and decryption processes.

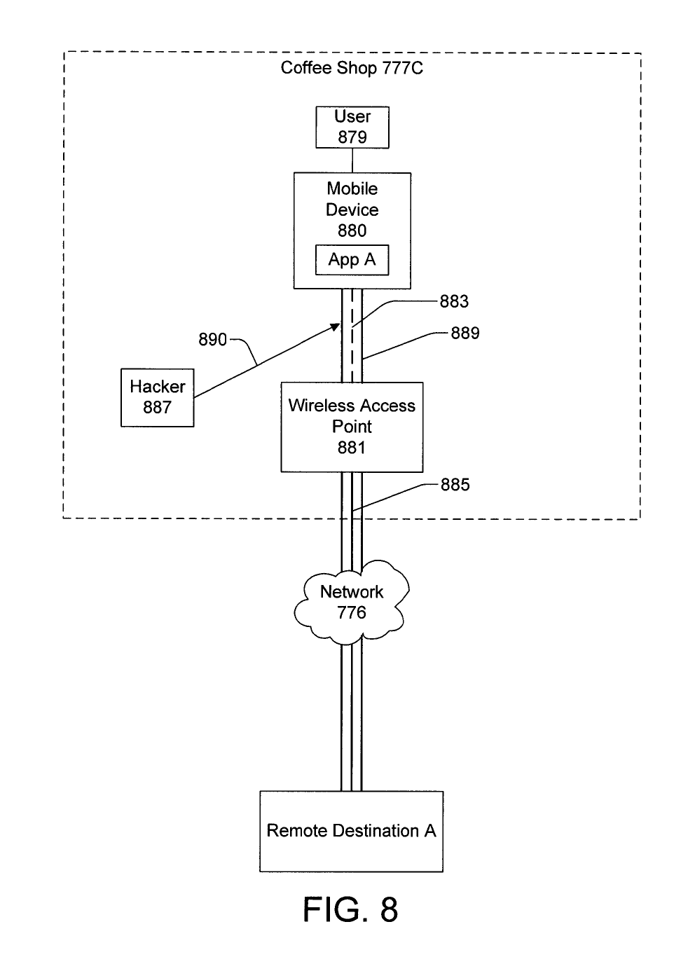

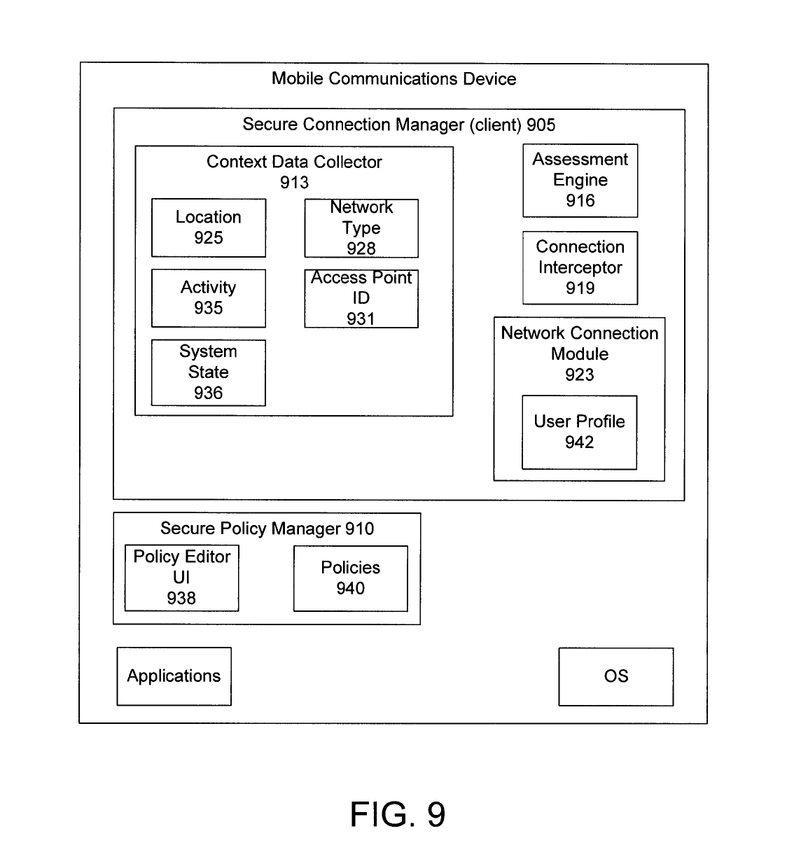

But if the user is in a coffee shop connected to a public Wi-Fi access point, a VPN (or other secure connection) may be desired to preserve the privacy and security of information being communicated. For example, FIG. 8 shows a network topology of context 777C. In this example, a user 879 in a coffee shop is using a mobile device 880 to connect to a remote destination A. The coffee shop includes a wireless network including a wireless access point 881.

The mobile communication device is connected to the wireless access point via a connection 883. Connection 883 is a wireless connection. The wireless access point, in turn, provides a connection 885 to another network (e.g., Internet) to the remote destination. Locations such as coffee shops are generally open to the public. In the example shown in FIG. 8, there is a hacker, spy, or eavesdropper 887 in the coffee shop. The hacker may be using a packet sniffing program to “sniff” 890 the wireless transmissions and discover the data being transmitted. In this context, a secure tunnel 889 can help to preserve the privacy and security of the information being exchanged.

Also, mobile devices are often configured to attempt to connect to available Wi-Fi access points that are detected; it can often be the case that the mobile device has connected to a Wi-Fi access point that was not explicitly selected by the user, and in fact it may not be the Wi-Fi access point that was desired. E.g., a user in the office seated next to a window may have a mobile device which has connected to a Wi-Fi access point from the building next door because the device “thought” that that network was stronger than the corporate Wi-Fi network.

The user would be unaware that this had happened (a fleeting notification message may have been displayed, e.g., “Connected to Neighboring-Unsecure-Network-of-Attacker” instead of “Connected to Secure-Corporate-Wi-Fi-Network.” Increasingly mobile devices make network connections autonomously without explicit action by a user (or without a user being necessarily aware of what connections are being made—e.g., IEEE 802.11u standard and Hotspot 2.0 (also known as HS2 and Wi-Fi Certified Passpoint) specifications are designed with automatic network connection in mind); the user's device may have connected to a network with an inappropriate level of security protection for the user's current context, or may have connected to a network that the user does not wish the user's mobile device to be connected to. The iOS 7 may be supporting Hotspot 2.0.

In another situation, a user may be playing an online game on the user's mobile device while sitting in an airport; a secure connection (e.g., VPN) may not be desirable for this application because it may not require a higher level of security. In this case, the secure connection may not be made.

In another situation, a user may be in the user's workplace, but may be using an application or interacting with a website that uses private financial or medical information of the user; in such a situation, the user may desire that there be a VPN connection in place, effective for that application or that website session, to protect and preserve the user's privacy.

What all of these situations share is that there is a decision being made by the system based on contextual factors as to whether or not a secure connection should be used for a particular application, website, activity, or communication. A secure connection or tunnel can include a VPN, SLL/TLS (Secure Sockets Layer/Transport Layer Security), or https proxy or other means of securing a network connection.

More particularly, in a specific implementation, a method includes detecting the context on the mobile device, assessing the current network connection, deciding what level of security is necessary for the context, and taking action to have the appropriate level of security on the network connection. When the destination context (running a particular application or class of application (e.g., banking app), or browsing to a particular location dictates, according to user preference or policy (set by user or by user's parent or by user's corporate administrator or set by the destination itself (e.g., a banking site that requires a secured connection be used)), then establishing a secured network connection.

The method may further include when the geographical context (location of user and mobile device) dictates, according to user preference or policy (set by user or by user's parent or by user's corporate administrator or set by the destination itself (e.g., a banking site that requires a secured connection be used)), then establishing a secured network connection.

The method may further include when the user's geographical context is a known one for which there is a user preference or a policy regarding which network the user's mobile device can or should be connected to, breaking an existing network connection or establishing a new network connection that meets the preference or policy with respect to security or privacy.

The method may further include identifying the network context (is it a secure Wi-Fi connection or not, is it the corporate or home network, is it this specific MAC address (Media Access Control address) or BSSID (Basic Service Set ID) or SSID (Service Set ID) or HESSID (Homogenous ESSID (Extended basic Service Set ID), as per 802.11u hotspot specification).

When the device has been reported lost or stolen, a different policy may be in place to restrict the set of services or network connections that can be made. The system can assess the situation and establish the appropriate level of security based on policy for the situation (which can be to not use a secure connection such as a VPN). The system can perform actions such as breaking the existing network connection and establishing a new one at the lowest network layers (e.g., the case in which the mobile device has made an automatic connection to a network provider which is either not preferred by policy or is prohibited by policy).

In a specific implementation, there can be a piece of network infrastructure (e.g., a Wi-Fi access point device). In this specific implementation, the mobile device establishes a secure connection with the piece of network infrastructure, which then creates appropriately secured network connections upstream of the network device according to policy previously provisioned to the network device, or supplied by the mobile network device itself (it sends its policy to the network device, which acts on behalf of the mobile device to establish the appropriate level of secured connection based on context). In a specific implementation, instead of a server it is a piece of network infrastructure, e.g., a Wi-Fi access point which is making the decision about what type of network connection is appropriate.

In this specific implementation, a method may include detecting the context on the mobile device, passing the context information to a network device, which assesses the current network connection, deciding what level of security is necessary for the context, and taking action to have the appropriate level of security on the network connection(s) from the mobile device.

The network device could also be a server, such as a network server operated by Lookout® or another provider of secure connections. In this specific implementation, the mobile device connects with Lookout® via a tunneling operation, and policies regarding security of network connections are applied at the server (thus affecting the network connections as they continue beyond the server to elsewhere in the internet).

In the above, the discussion of context may lead to there being more than one type of secured network connection active at the same time; e.g., there could be VPN connections to be used by different applications according to user choice and/or security policy. Some mobile device operating systems directly support per-application VPN connections, some do not. In either case, the secure network connection manager can implement per-application secure network connections whether the OS directly supported it or not.

There can be connections by different apps (application programs). There can be connections by two different web applications/destination websites within the same browser (application program), wherein each of the two different web apps could have different policy-driven requirements for security levels. Not all transactional access may occur in dedicated apps, some may occur in web browsers, and in such a case the same application (the web browser) may have different network connections depending on what the network destination actually is.

More particularly, in a specific implementation, a method includes allowing the computing device to maintain a second existing network connection for a second application program executing on the computing device. In this specific implementation, a level of security offered by the first existing network connection for the first application program is greater than a level of security offered by the second existing network connection. In another specific implementation, a level of security offered by the first existing network connection for the first application program is less than a level of security offered by the second existing network connection.

The case of a destination establishing a policy regarding secure connection that is to be followed may include a site hosting a file similar to the “robots.txt” file, call it, for example, “vpn.txt” which can establish security requirements depending on what resources are being accessed at the destination site. Alternatively, similar specifications can be expressed in HTTP headers. E.g., “vpn.txt” could contain statements like:

User-agent: *

RequireVPN: /

—or—

User-agent: *

RequireVPN: /onlinebanking/

The case in which network destination context is used can be accomplished by intercepting network connections in the OS or in the browser or in a separate security program (secure network connection manager) to assess and decide regarding the level of security that is appropriate based on context.

It should be appreciated that the specific contexts shown in FIG. 7 are merely examples. One of skill in the art would understand that the principles of the system can apply to other contexts including other location-based contexts such as in a school, library, restaurant, park, bus, train, and many others.

The contexts may be organized according to an ontology or taxonomy having hierarchies of classes. A context can include a class, subclass, and so forth. Each class, subclass, or both may be associated with a set of attributes, aspects, properties, features, characteristics, metatags, labels, parameters, or combinations of these. U.S. patent application Ser. No. 13/686,028, filed Nov. 27, 2012, provides additional discussion of context models and is incorporated by reference.

As an example, a particular context may be represented as “Public>Coffee Shop>Banking.” In this example, the user is in a public space and, in particular, is in a coffee shop. While in the coffee shop, the user is using a banking application. Another context may be represented as “Public>Coffee Shop>Playing Game.” This example is similar to the earlier example. In this example, however, the user is playing a game while in the coffee shop. Based on the network connection policies, different types of connections may be used for the different contexts. In the former (or first) context a first type of network connection may be established. In the latter (or second) context a second type of network connection may be established.

A level of security offered by the first type of network connection may be different from a level of security offered by the second type of network connection. For example, the level of security offered by the first type of network connection may be greater than the level of security offered by the second type of network connection.

Thus, when the user is engaged in the banking activity, the connection will be very secure to help protect the user's financial data. When the user is engaged in playing a game, the connection may be less secure as the data associated with game may not be as sensitive as the data associated with financial transaction. The advantage of the less secure connection, however, is that the connection may provide a faster response as compared to the connection for the banking activity.

Providing a secure connection or safe browsing experience may be facilitated through controlling a domain name system (DNS) server for resolving network addresses of all connections via whitelisting or blacklisting by specific domains or top-level domains (TLDs) or categories of destinations. A network connection can include any combination of Wi-Fi, VPN, cell network, macro cell network, small cell network, micro cell or microcellular network, Bluetooth, near field communication (NFC), Zigbee/802.15.x/wireless personal area network (WPAN), mobile ad hoc network (MANET), mesh network, or the like. U.S. patent application Ser. No. 12/255,614, filed Oct. 21, 2008, now U.S. Pat. No. 8,051,480, issued Nov. 1, 2011; Ser. No. 13/284,248, filed Oct. 28, 2011, now U.S. Pat. No. 8,505,095, issued Aug. 6, 2013; and Ser. No. 13/919,901, filed Jun. 17, 2013, include further discussion of preventing malware, inspecting network traffic, and monitoring and analyzing multiple interfaces/protocols, and are incorporated by reference.

In a specific implementation, a greater level of security includes encryption of the network connection. The greater level of security may include providing safe browsing by controlling the DNS server for resolving the network address of all connections (via whitelisting or blacklisting by specific domains or TLDs (Top Level Domains) or categories of destinations).

Referring now to FIG. 6, in various implementations, computing device 601 further includes SNC service manager 610, which may be a process or application implemented on computing device 601. SNC service manager 610 may be configured to communicate with server 650 and may handle and manage SNC connections made with computing device 601.

Thus, SNC service manager 610 may be configured to provide SNC services, such as establishing and terminating an endpoint of a SNC tunnel, and applying one or more policies to a SNC connection. In various implementations, the operations of SNC service manager 610 are controlled or configured by one or more rules or policies stored in SNC policy manager 606.

Thus, SNC policy manager 606 may include or be coupled to one or more data stores that store policies that configure or manage one or more actions or operations performed by SNC service manager 610. For example, a policy stored in SNC policy manager 606 may configure SNC service manager 610 to establish a SNC connection in a first geographical location, but not in a second geographical location.

In various implementations, SNC service manager 610 may be preloaded or installed on computing device 601 prior to being provided to the user. Thus, SNC service manager 610 may already be installed when it is received by a user from a carrier or manufacturer. Furthermore, SNC service manager 610 may be a component of and built into operating system 602. When built into operating system 602, SNC service manager 610 may be invoked directly by applications 604 without requiring execution of or function calls to a separate application.

System 600 may also include SNC service manager 660 and SNC policy manager 656 that may be implemented on one or more servers, such as server 650. SNC service manager 660 may provide server-side SNC services and functionalities associated with SNC service manager 610. Thus, an instance of SNC service manager 660 and SNC policy manager 656 may be created for each computing device or user that is provided SNC services by system 600. As discussed above with reference to SNC policy manager 606, SNC policy manager 656 may be used to configure or control the operation of SNC service manager 660.

According to various implementations, SNC policies can be modified at computing device 601 or at server 650. If changes are made to an instance of one SNC policy manager, the changes may be communicated and incorporated into the other instance. For example, an administrator may change policies at a server-side SNC policy manager 656. The changes may be communicated to computing device 601 and implemented in SNC policy manager 606.

In another example, if a change is made to SNC policy manager 606, a message may be sent from computing device 601 to server 650 that identifies the changes that were made. The information included in the message may be used to modify SNC policy manager 656 to reflect the changes that were made to SNC policy manager 606.

In some implementations, policies may be managed at several levels of granularity. Policies may be modified on a per-user basis. Alternatively, policies may be changed or modified for one or more groups of users at a time. A management console may be provided to a user, such as an administrator, that may provide the user with a user interface that may be used to manage policy settings for one or more users and their computing devices.

Alternatively, a user may modify or change settings via an input device of the computing device. For example, a user may have administrator privileges and be able to change or modify the policies applied to the user's own computing device. In this example, separate polices may be changed or modified for each device or user using system 600.

In another example, policies may be managed at a group level by a group administrator. In this example, the group administrator may be an administrator for an organization, corporation, or enterprise. The group administrator may change or modify policies associated with the applications the organization has installed on its employees' computing devices. Once the administrator makes one or more changes, they may be applied to the computing devices of one or more groups of users that work for the organization.

In yet another example, a parent-child relationship may exist between multiple devices. Thus, several computing devices may be designated as children of a parent device that resides elsewhere, such as a laptop computer or a desktop computer. If a change is made to a policy of the parent device, the change may be automatically applied to the computing devices by virtue of the parent-child relationship.

In yet another example, a mother or father or guardian for a minor child may manage the policy for any devices operated by the minor child. Such policy management may occur even in situations in which the device is owned by another organization, e.g., the child's school. In this case there may be two levels of policy management: one by the administrator for the school, and another by the parent of the minor child.

System 600 may further include account manager 662 which may be a process or application implemented on server 650. Account manager 662 may be responsible for authenticating requests from computing device 601, and for creating an account associated with a user of computing device 601. For example, account manager 662 may be configured to generate an account having one or more account settings associated with the user. The account may be a temporary account used to provide SNC services to the user via computing device 601.

Account manager 662 may be configured to remove or delete the temporary account when the SNC connection is no longer used. Account manager 662 may also handle load balancing and scaling of functionalities provided by server 650. For example, if more users or computing devices initiate SNC connections with server 650, account manager 662 may spawn or spin up additional server instances to provide additional SNC services for those additional users and computing devices. In this way, the processing load incurred by servicing users may be balanced among several servers.

Furthermore, account manager 662 may transfer SNC functionalities to another server based on a geographical parameter associated with a user or computing device 601. For example, computing device 601 may be located in a first geographical region and may initiate a connection with server 650 which is also located in the first geographical region. If computing device 601 moves to a second geographical region, account manager 662 may transfer the connection to an account creation server located in the second geographical region.

System 600 may include malware identifier 666, which may inspect network traffic flowing to and from computing device 601. Malware identifier 666 may be configured to identify attempts to exploit vulnerabilities of computing device 601 and applications 604 which may be installed and running on computing device 601. Malware identifier 666 may monitor traffic and identify malicious files and/or activities based on a predetermined list of filenames. Malware identifier 666 may also identify malicious files and/or activities based on detected behaviors. U.S. patent application Ser. No. 12/255,635, filed Oct. 21, 2008, now U.S. Pat. No. 8,060,936, issued Nov. 15, 2011; Ser. No. 12/255,632, filed Oct. 21, 2008, now U.S. Pat. No. 8,087,067, issued Dec. 27, 2011; Ser. No. 12/255,621, filed Oct. 21, 2008, now U.S. Pat. No. 8,108,933, issued Jan. 31, 2012; Ser. No. 12/868,669, filed Aug. 25, 2010, now U.S. Pat. No. 8,347,386, issued Jan. 1, 2013; and Ser. No. 12/868,672, filed Aug. 25, 2010, now U.S. Pat. No. 8,533,844, issued Sep. 10, 2013, include further discussion of malware identification and monitoring, and are incorporated by reference.

Thus, malware identifier 666 may identify malicious files and/or activities dynamically based on behaviors, such as a frequency of requests generated, or a type or recipient of a request. The list of malicious files and/or activities may be stored locally or remotely in a storage location accessible by other components of server 650.

Malware identifier 666 may be configured to scan applications that are being downloaded to the device and determine whether or not the applications are malicious. Malware identifier 666 may be further configured to scan for abnormalities or malformedness of files and file formats being sent to computing device 601.

For example, malware identifier 666 may examine file formats such as Adobe Acrobat® documents, Microsoft Office® documents, Adobe Flash® player files, and image files, such as .JPEG, .PNG, and .TIFF. Furthermore, malware identifier 666 may be configured to scan network protocol data units for format consistency and validity. Techniques for safe browsing are further described in U.S. patent application Ser. No. 13/160,447, filed Jun. 14, 2011, which is incorporated by reference along with all other references cited in this application.

System 600 may also include safe browsing module 664, which may be an application or process implemented on server 650. Safe browsing module 664 may filter network traffic based on DNS or IP addresses associated with the network traffic. For example, safe browsing module 664 may be an implementation of a modified DNS server that is configured to filter traffic that is being sent to bad or malicious websites from the computing device.

Safe browsing module 664 may include a data store that stores modified DNS entries for known or dynamically identified malware sites. The modified DNS entries may be used to redirect a data packet or request to a safe website. Alternatively, safe browsing module 664 may be configured to refuse to resolve the DNS address, which may result in a failed DNS resource resolution for the client on computing device 601.

Safe browsing module 664 may also be configured to point a user of computing device 601 to a location which explains the vulnerability and may optionally allow the user to choose to continue or not. The actions performed by safe browsing module may be configured by one or more active policies stored in a SNC policy manager.

In some implementations, sites which are identified by malware identifier 666 as serving malware have their domains and/or interne protocol (IP) addresses added to a list of blacklisted sites for use by safe browsing module 664. In this way, a black list may be populated dynamically, and safe browsing module 664 may be configured dynamically and on-the-fly. Thus, safe browsing module 664 may populate a blacklist while a SNC connection is in use and in response to malware identifier 666 identifying a site as malicious.

Safe browsing module 664 may also be configured based on previously determined information. For example, a system administrator may pre-load a list of malicious sites to be used as a black list. System administrators may choose to allow their list of malicious sites to be shared with a central server or directly with other system administrators. A system administrator may specify that any site listed as malicious by a configurable number of other system administrators is to be added to the system administrator's list of malicious sites. Such a configurable rule may also specify the type of organization or a specific list of organizations whose black lists are to be examined for automatically populating the administrator's own list.

System 600 may further include notification module 607 and notification module 657. Notification modules 607 and 657 may be configured to generate one or more user interface components capable of providing a notification to a user. The user interface component may be a graphical icon presented in a display of the computing device. The graphical icon may display a color-coded image, or display automatically generated text descriptive of a SNC connection status.

Accordingly, the notification may display information about the current status of a secure network connection, such as a SNC connection, or various events and conditions that may be associated with a SNC connection. For example, if a SNC connection is currently established and active, notification module 607 or notification module 657 may indicate that the computing device is protected. If the computing device is in a poor service area or does not have a strong network signal, notification module 607 or notification module 657 may provide a notification indicating that the computing device's connection strength is not strong enough to generate an account and establish a SNC connection.

Notification module 607 or notification module 657 may also provide the user with the option to proceed to connect to a network unprotected. Notification module 607 or notification module 657 may also provide a notification that indicates that a computing device is not protected when no SNC connection is established.

FIG. 9 shows a more detailed block diagram of a specific implementation of a client-side secure connection manager 905 and secure connection policy manager 910. As shown in the example of FIG. 9, secure connection manager 905 includes a context data collector 913, an assessment engine 916, a connection interceptor 919, and a network connection module 923.

The context data collector is responsible for collecting context information associated with the mobile device. Context information may include data identifying, representing, or describing the real-time physical environment or setting of the computing device, ambient audio, video and photographs of the physical surroundings, computing execution environment (e.g., device configuration settings, system services, active processes, or task status), user activity data, system state, accelerometer data, location data, and the like.

More particularly, in a specific implementation, context information may include a geographical location 925 of the device, information identifying a type of network 928 that the device is connected to, information identifying an access point 931 that the device is connected to, user activity data 935, system state 936, or combinations of these.

The geographical location data may include Global Positioning System (GPS) coordinates such as latitude and longitude. Network type 928 may include information indicating whether or not the network connection is secure, information indicating whether or not the network connection is unsecure, an identification of the secure connection service or protocol, an identification of the communication protocol, an identification of the physical network type, or combinations of these. Some examples of protocols include Point-to-Point Tunneling Protocol (PPTP), Layer 2 Tunneling Protocol (L2TP), Secure Sockets Layer (SSL), Internet Protocol Security (IPsec), Secure Shell (SSH), and OpenVPN—just to name a few examples.

Access point identifier 931 may include the media access control (MAC) address assigned to the access point, base station identifier (BSSID), extended service set identification (ESSID), Ethernet hardware address (EHA), hardware address, physical address, IP address, or any other identifier or combination of identifiers that can uniquely identify the access point. Context information may include an identity of a physical provider of the network connection.

User activity data 935 may include information identifying application programs that the user is currently using, browsing activity, files that have been accessed (e.g., files that the user has opened, read, or modified), and the like. User activity data can include any combination of an identification of a specific application program on the computing device, an identification of a web application, an identification of a website connected to, a class or category of the specific application program (e.g., a financial services app or web app; an enterprise app or a web app, and so forth), a day of week, or a time of day.

System state data may include information indicating remaining battery power (e.g., battery voltage measurement), configuration information (e.g., operating system version, system memory, firmware version, or processor type), or combinations of these.

Other examples of context information include:

1) Existence or not of a device lock personal identification number (PIN) or device passphrase or other device lock authentication process;

2) Existence or not of a biometric device lock authentication process;

3) Occurrence of unsuccessful unlock attempts prior to a successful unlock;

4) Occurrence of a failed authentication attempt to an app or a web application;

5) Elapsed time since last successful device unlock;

6) Elapsed time since last successful or unsuccessful authentication attempt to an app or a web application;

7) Evidence of possible user lack of physical control of device (e.g., accelerometer readings showing device has fallen or been set down and is unattended for a period of time, as on a desk. The co-pending application Ser. No. 14/207,100, entitled “System And Method For Changing Security Behavior Of A Device Based On Proximity To Another Device,” filed Mar. 12, 2013, further discusses aspects of such a system and is incorporated by reference in its entirety); counter-evidence of user attendance is continued periods of interaction with device (typing input, touches on device, application launches) or continued carrying of device (accelerometer readings showing device has been placed in user's pocket or handbag or holster or is being carried in hand, with continued movement indications, not interrupted by quiet periods of no movement); or

8) Elapsed time since possible user lack of physical control of device.

Secure policy manager 910 may include a policy editor user interface 938 for editing connection policies, and a database 940 to store network connection policies. A network connection policy may include conditional statements, expressions, constructs, consequences, alternatives, actions, operators, or combinations of these. A policy may be referred to as a security policy. An example of the structure of a rule that may be included in a policy is shown below:

IF <boolean condition> THEN <consequence> ELSE <alternative>

For example, a policy rule may specify:

IF <current context=y> THEN <establish a first type of connection> ELSE <establish a second type of connection>

In the example above, if the Boolean condition evaluates to TRUE (i.e., the current context corresponds “y”) then the action is to establish the first type of connection. Alternatively, if the Boolean condition evaluates to FALSE (i.e., the current context does not correspond “y”) then the action is to establish the second type of connection. The first type of connection may be a secured connection (e.g., VPN). The second type of connection may be an unsecured connection, or vice-versa.

A context can include location data and user activity data. Below is another example of a policy rule:

IF <location=“coffee shop”> AND <user activity data=“banking”> THEN <establish a first type of connection>

In the example above, the context includes a first condition (location=“coffee shop”) and a second condition (user activity data=“banking”). The two conditions are joined by the “AND” operator. In this example, both conditions must evaluate to TRUE in order for the first type of connection (e.g., secured connection) to be established. The connection policies allow for making very granular decisions on when a particular type of network connection should (or should not be) established. For example, below is another example of a policy rule:

IF <location=“coffee shop”> AND <user activity data=“playing game”> THEN <establish a second type of connection>

In the example above, playing a game while in a coffee shop results in establishing the second type of connection (e.g., unsecured connection). Establishing an unsecured connection can result in faster response times as compared to a secured connection and thus improve the user experience.

While an unsecured connection may be vulnerable to eavesdropping, the data at risk may be less critical as compared to the user's financial data. Thus, a user may be willing to accept the trade-off. In contrast, if the user is accessing a bank account while in a coffee shop as in the earlier example, the user may desire a secure network connection so as to protect sensitive financial data.

In a specific implementation, connection policies are user-configurable. In this specific implementation, the system allows users to create and edit their own network connection policies that reflect their own preferences and priorities regarding tradeoffs between response time and security. In another specific implementation, connection policies are not user-configurable. For example, editing and creating policies may be allowed only for IT administrators. This specific implementation of the system can help enterprises implement policies uniformly.

A policy may originate from: 1) User; 2) Administrator for the mobile device; 3) Administrator for the physical network to which a connection is made (e.g., the Starbucks coffeeshop providing Wi-Fi to the mobile device, or the corporation operating the Wi-Fi network in a corporate office); 4) The network destination (e.g., a bank or a corporation's server); 5) A combination of policies from the above sources. There can be more than one applicable policy.

In a specific implementation, a security policy does not exist as a separate thing or object, but rather there is a collection of user choices/preferences. In this specific implementation, there is not really a “thing” called a policy, rather, the user has made some choices which essentially constitute a policy; thus there is in this case essential a single “policy” which is configured by the user making settings choices. A security policy may be selected as a user preference. A security policy may include a collection of user choices or preferences.

In a specific implementation, the system determines the appropriate type of network connection based on inferring one or more user choices, preferences, options, or settings. In a specific implementation, a method includes displaying for a user a list of contexts (e.g., home, office, coffee shop, or train), and a network connection security option associated with each context.

In this specific implementation, the user can indicate whether a secure or unsecure network connection is desired for a particular context. Enabling a network connection security option associated with a context may indicate that the user desires a secure network connection for the context. Disabling the network connection security option indicates that the user desires an insecure network connection for the context.

In another specific implementation, the system can evaluate a user-selectable option to infer whether or not there should a secure connection for a particular context. For example, very privacy conscious users may disable location services, cookies, browsing history, or the like. In this specific implementation, the system may infer that the user prefers secure network connections based on the user disabling location services, cookies, browsing history, or the like.

In contrast, less privacy conscious users may enable location services, cookies, browsing history, or the like. For this user, the system may infer that the user prefers the convenience of less secure network connections based on the user enabling location services, cookies, browsing history, or the like.

Connection interceptor 919 is responsible for intercepting an attempt to make a network connection. For example, the interceptor may intercept an attempt by an application program on the mobile device to connect to a network.

The assessment engine is responsible for evaluating or applying a connection policy based on the current context. Network connection policy evaluations can occur before a connection is established, after a connection has been established, or while a connection is established. For example, upon the connection interceptor intercepting a connection attempt, the assessment engine may be called to determine the type of connection that should be established. Determining the type of connection that should be established is based on the collected context data (e.g., location and user activity).

Alternatively, a connection policy may be evaluated after a connection has been established. A policy may be evaluated during or while there is an existing network connection. Evaluating the connection policy while there is an existing network connection helps to account for changes in the current context. For example, a user may have initially been playing an online game where, based on a connection policy, the connection network could be unsecured.

Subsequently, however, the user may have switched to a banking application in order to pay some bills. In this case, the policy may specify that a secure network connection be used. If the existing network connection offers a security level different from what is specified by the policy, the system can terminate the existing network connection and establish a new network connection that offers the appropriate level of security for the current context.

Network connection module 923 is responsible for establishing and terminating network connections. The network connection module may store a user profile 942. The user profile can include user credentials (e.g., username and password) for establishing a secure network connection. A user profile may include multiple sets of credentials for different types of secure services.

For example, a first set of credentials may be used for first type of secure connection (e.g., point-to-point tunnel protocol). A second set of credentials may be used for a second type of secure connection (e.g., layer 2 tunneling protocol).

The first and second set of credentials may have the same or different levels of authentication. For example, the first and second set of credentials may use single factor authentication (e.g., username and password). Alternatively, one set of credentials may use single-factor authentication and the other set of credentials may use multi-factor authentication (e.g., two-factor authentication). In an implementation, the network connection module is capable of establishing different types of network connections, where each type offers a different level of security.

That is, the connection module may establish a first type of connection that offers a first level of security, and a second type of connection that offers a second level of security, different from the first level of security. For example, the first type of connection may be point-to-point tunneling protocol. The second type of connection may be a layer 2 tunneling protocol. L2TP can offer a higher level of security than PPTP, but can be more complicated to establish.

The ability to access different types of secure services that offer different levels of security helps to ensure that high security can be provided in very sensitive contexts while less security (and less complexity) can be provided in less sensitive contexts. Further, in some cases a particular secure service may be unavailable. For example, a VPN server associated with a particular secure service may have crashed or may otherwise be offline. In this case, the system can use a different secure service in order to help ensure that the communications to and from the mobile device remain secure.

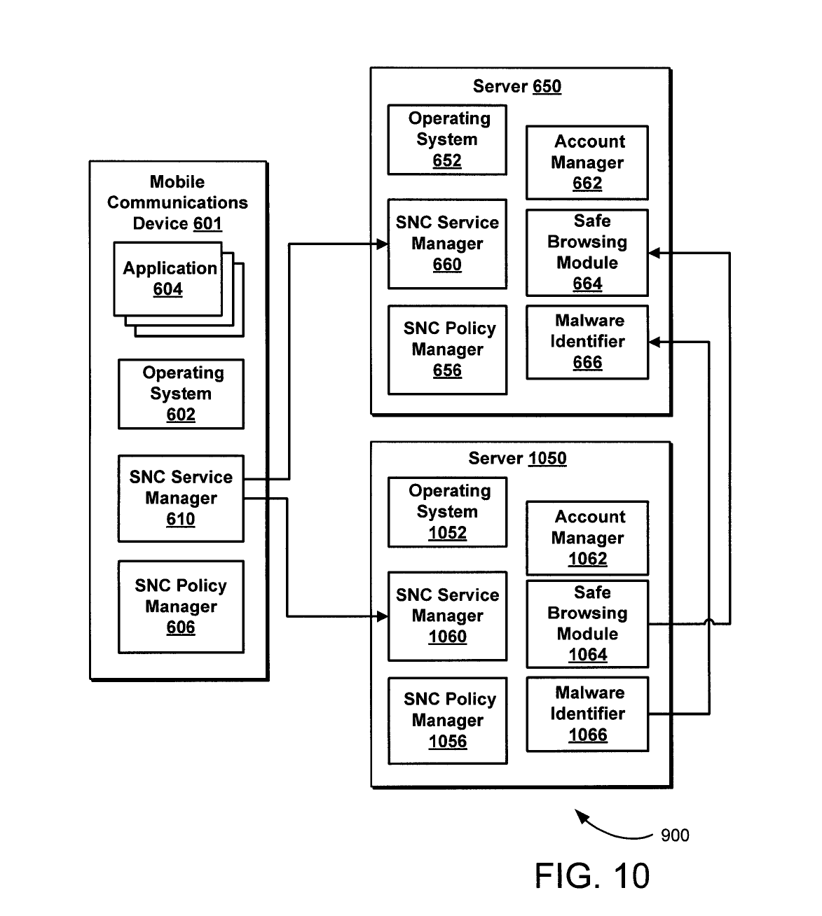

FIG. 10 illustrates an example of a block diagram of a system for automatically providing multiple secure network connections to a computing device, implemented in accordance with some implementations. System 900 may be used to automatically establish a several SNC connections between a computing device and multiple service providers.

As discussed above with reference to FIG. 6, a computing device may use an instance of a SNC service manager implemented on a server. In various implementations, computing device 601 may use different instances of SNC services implemented on different servers. The use of a particular instance may depend on a context, application, website, or network connection that is currently being used. Computing device 601 may connect to an appropriate SNC service manager based on one or more policies, as may be determined by SNC policy manager 606.

Connections to both SNC service manager 660 and SNC service manager 1060 may be active simultaneously. Thus, multiple connections may be active with multiple SNC service managers. For example, a bank may have setup a SNC infrastructure for use by its customers when using the bank's website or banking application program. The user's employer may have a setup a separate SNC infrastructure for use when connecting to the employer's in-house or cloud-based services. The user may also be using a SNC infrastructure provided by a service provider, such as Lookout®, to manage other network connections. Each SNC connection may be associated with an instance of a SNC service manager provided by the respective servers of each service provider. Each SNC connection may be managed and governed by SNC service managers and SNC policy managers implemented on the computing device and on the servers of the service providers.

According to various embodiments, server 1050 is a server operated and maintained by a service provider, such as Lookout®. Server 1050 may include various components which may be used to provide automatic and safe SNC connections to users of computing devices. Accordingly, server 1050 may include safe browsing module 1064 and malware identifier 1066, which may be in communication with other components of the service provider's infrastructure.

For example, safe browsing module 1064 and malware identifier 1066 may be in communication with one or more databases that serve as a centralized repository for libraries of safe and malicious websites and IP addresses, as well as safe and malicious files. In addition to maintaining a centralized repository of information, the infrastructure components may provide services such as safe browsing and malware identification instead of components of a local server.

Thus, other components in the service provider's infrastructure may be performing safe browsing checks and malware identification as a service for server 1050. Alternatively, the infrastructure components may send current or updated information to server 1050 so that components local to server 1050 may perform the appropriate safe browsing and malware identification operations. In various implementations, the current or updated information sent to server 1050 includes data or executable application code, such as a software update.

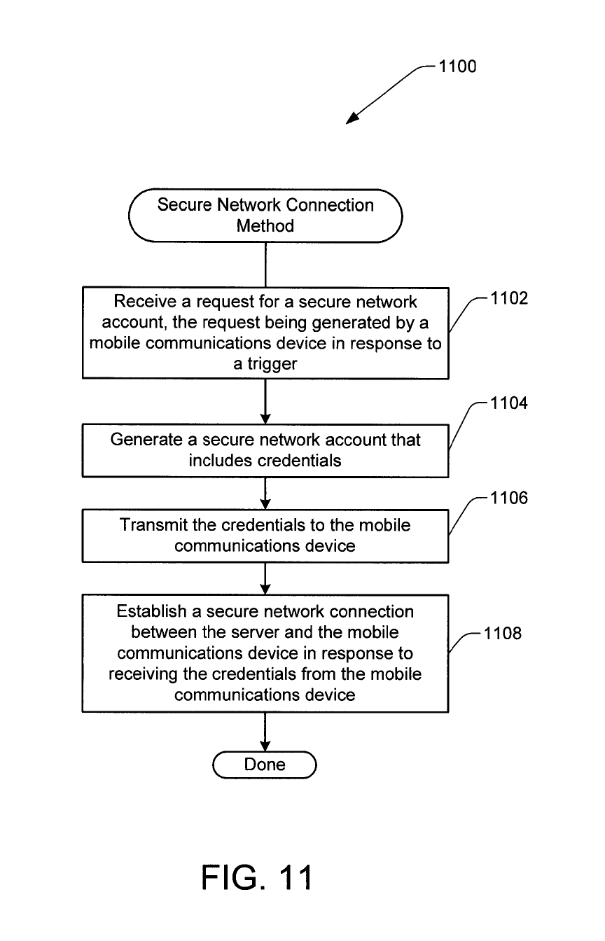

FIG. 11 illustrates an example of a block diagram of a method for providing a secure network connection to a computing device, implemented in accordance with some implementations. The co-pending application Ser. No. 14/071,366, entitled “Methods And Systems For Secure Network Connections,” filed Nov. 4, 2013, further discusses aspects of such a system and is incorporated by reference in its entirety. Method 1100 may be used to automatically identify situations in which a secure network connection should be used, and automatically configure and establish a secure network connection.

Configuration and establishment of the secure network connection may occur dynamically and based on the computing device's current context. Furthermore, the configuration and establishment of the secure network connection may be automatic and transparent to a user. Once established, network traffic flowing through the secure network connection may be analyzed to determine if modifications should be made to the secure network connection, or if the connection should be terminated.

Accordingly, at step 1102, a request for a secure network connection account may be received at a server. In some implementations, the request may be generated by a computing device in response to a trigger. Thus, a process or application installed on the computing device may identify an event or situation in which the computing device should use a secure network connection. This may occur automatically and based on one or more secure network connection policies stored on the computing device and/or on the server.

The policies may include several rules that define events, situations, and conditions that trigger the automatic configuration and creation of a secure network connection. In some implementations, a policy may indicate that if the computing device leaves or enters a particular geographical region, a SNC connection should be used for any outgoing network access requests, and a request for a secure network connection account may be generated and sent to a server.

For example, public locations, such as cafés and other public hotspots, may be prone to eavesdropping attempts made by malicious entities, such as hackers. A list of public locations may be generated by a service provider, such as Lookout®, and stored on the computing device. If the computing device enters one of the locations identified by the list, a policy may indicate that a secure network connection account should be requested.

Accordingly, a secure network connection account may be requested and generated, and a secure network connection may be established. Once established, the secure network connection may provide the computing device with a safe and encrypted network connection that is not susceptible to eavesdropping attempts.

At step 1104, a secure network connection account may be generated at the server. The secure network connection account may be a temporary account that includes credentials for a secure network connection. The credentials may be randomly generated authentication information that is generated specifically for the request. Thus, in response to receiving the request at step 1102, a server may automatically generate a new account with new credentials which may subsequently be used to establish a secure network connection, such as a SNC connection. The credentials may be used to authenticate endpoints of a SNC tunnel, such as the computing device and the server.

At step 1106, the credentials may be transmitted to the computing device. The computing device may use the credentials to automatically configure a secure network connection, such as a SNC connection. The server may also automatically configure the secure network connection. In this way, both endpoints of the secure network connection may be configured automatically and without any intervention from a user or administrator.

At step 1108, a secure network connection may be established between the server and the computing device in response to receiving the credentials from the computing device. Accordingly, the computing device may use the credentials to authenticate itself to the account creation server, and a SNC connection may be established. This may occur automatically and without user intervention.

Moreover, once the connection has been established, traffic in the SNC tunnel may be monitored and modified to ensure that the computing device remains protected and complies with the policies that are currently active. For example, if malware has been previously and inadvertently installed on the computing device, traffic in the SNC tunnel may be dropped to prevent the malware from communicating with a malicious server, such as a command and control server.

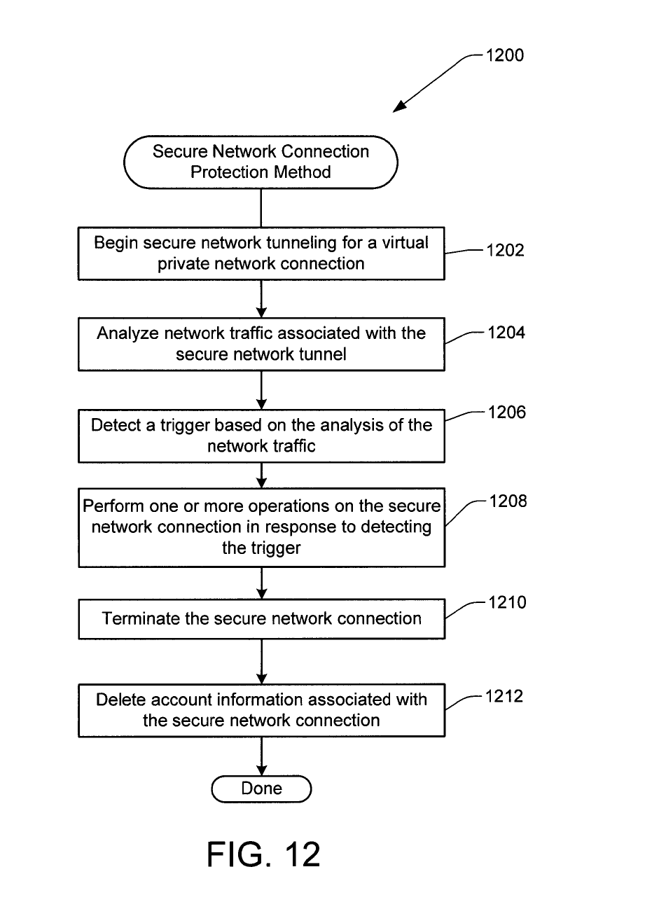

FIG. 12 illustrates an example of a block diagram of a method for automatically protecting a secure network connection, implemented in accordance with some implementations. Once a SNC connection has been established, traffic flowing through the SNC tunnel may be analyzed to continue to protect the computing device during the entire time the SNC connection is established. Thus, a server may analyze information being transmitted to the computing device and from the computing device and determine whether or not the flow of network traffic should be changed in any way.

Accordingly, at step 1202, tunneling may begin for a secure network connection. As discussed above with reference to FIG. 7, various events and conditions may trigger a computing device to automatically establish a SNC connection with a server. Once established, network traffic flowing to and from the computing device travels through the established SNC tunnel and is subject to the policies associated with the SNC connection that are managed by policy managers.

At step 1204, network traffic associated with the secure network tunnel may be analyzed. The server providing an endpoint of the SNC connection may continually analyze information that is sent through the SNC tunnel, such as header information included in data packets.

Thus, traffic sent through the SNC tunnel may include header information that identifies where a packet or request came from, and where it is being sent to. The server may be configured to monitor and analyze information included in the header by parsing and retrieving one or more data values from the header. The server may compare the retrieved data values with data values identified by one or more policies associated with the computing device that is using the SNC connection.

Accordingly, at step 1206, a trigger may be identified based on the analysis of the network traffic. As similarly discussed above with reference to FIG. 7, various triggering events and conditions may trigger the establishment of a SNC connection.

Thus, an account creation server may have one or more components, such as SNC policy managers, that identify events or conditions that may trigger or cause the server to perform one or more actions or operations on traffic flowing through the SNC tunnel. The triggering events may be identified by an active policy that governs the flow of traffic through the tunnel.

For example, a triggering event may be downloading a malicious application, requesting a page or resource from an unsafe website or server, or transgressing a geographical boundary. The triggering event may be identified based on the comparison of the analyzed information and the policies associated with the SNC connection.

For example, a security policy may be implemented for a computing device that provides a user of the computing device with safe browsing by identifying and blocking known malicious websites and servers. The policy may include one or more rules that identify a several malicious servers, provide identification information for the malicious servers, such as an IP address, hostname, or DNS address, and specify one or more actions or operations to be taken for each malicious server.

If retrieved information, such as a DNS address, retrieved from the network traffic in the SNC tunnel matches any of the addresses identified by the policy, a triggering event may be identified, and the one or more actions or operations specified by a policy may be performed on the data packet or file associated with the retrieved information.

Accordingly, at step 1208, one or more operations may be performed in response to identifying the trigger. Thus, a server may perform one or more operations identified by the policy that was used to detect the triggering condition or event. The operations may be performed to modify a flow of traffic through the SNC tunnel, and protect the computing device from a threat associated with the triggering event.

An operation performed by the server may include providing a user with a notification, dropping a packet, dropping all packets or information sent through the tunnel, or terminating the SNC connection. For example, in response to detecting an application attempting to connect to a malicious command and control server, the user of the computing device may be provided with a notification that displays the text, “We have found malware on your device. We have stopped all connections. Please rescan your device to remove any malware.”

In another example, an application on a computing device may request a webpage from a website that has been identified as a phishing site. A system component, which may be a SNC policy manager implemented on the computing device or on the server, may identify the website as a phishing site based on its DNS address.

In response to identifying the request for the phishing site, the SNC service manager may stop or pause traffic passing through the SNC tunnel. In this instance, an application on the computing device may continue to send requests. However, SNC service manager may prevent the requests from being sent to the phishing site and its associated server.

In some implementations, the user may be provided with a notification that indicates that the user, the application, or the computing device is attempting to access or navigate to a website that may be a phishing site. The user may provide a response via a user interface of the computing device. The response may indicate whether or not the SNC connection should be resumed or terminated.

In yet another example, a user may leave a geographical region by leaving a country. A system component, such as a SNC policy manger, may determine that all communications should be blocked when the computing device has left the country.

Thus, in response to determining that the computing device has left the country, a system component, such as SNC service manager, may drop any traffic passing through the SNC tunnel. In this instance, applications executing on the computing device may continue to send requests, such as hypertext transfer protocol (HTTP) requests, using the SNC connection. However, instead of sending the requests to their intended destinations, the SNC service manager may drop the requests so that no requests are sent to their intended destinations.

In some implementations, an operation may be performed in response to determining that an application is attempting to connect to or request content from a server in a particular country. For example, a SNC policy manager may include a country blacklist that specifies that all traffic being sent to one or more particular countries should be dropped. A system component, such as a safe browsing module, may identify a destination country for each request leaving the computing device based on the country that the DNS address associated with the request resolves to. If the country identified based on the DNS address or based on an ip-based geolocation service for the DNS resolved ip address matches a country identified in the blacklist, a system component, such as a SNC service manager, may drop the request.

In various implementations, an account creation server may maintain historical information about a computing device and applications executing on the computing device. The historical information may include information detailing access requests and connection attempts made by the computing device. The historical information may be used to implement a policy based on an aggregation of one or more triggering conditions or events.

For example, historical information may be maintained for a particular SNC connection made with a computing device. If an application on the computing device that is using the SNC connection makes an access request to a potentially malicious server, a policy may indicate that the SNC connection should be allowed to proceed normally.

However, if the application makes more than a predetermined number of requests, the policy may indicate that an action or operation should be performed. For example, if the application on the computing device makes three or more access requests to the potentially malicious server, all traffic in the tunnel may be dropped and communications and requests made by the application may be effectively blocked.

At step 1210, the secure network connection may be terminated. The SNC connection may be terminated as part of the normal SNC connection process. Thus, a computing device may finish using the SNC connection and the server providing the SNC connection may terminate the connection according to a conventional SNC termination method.

At step 1212, account information associated with the secure network connection may be deleted. As set forth above, the accounts and credentials generated for the requested SNC connection may be temporary. Accordingly, accounts and credentials may be generated dynamically and on-the-fly for each connection request, and subsequently deleted. Additionally, a DNS cache may be flushed or cleared to remove any residual information from a previous SNC connection.

Generating and deleting accounts and credentials for each request in this way provides greater security because in the event account information is compromised, the compromised account information is automatically retired and deleted when the connection is terminated. New account information is automatically generated for any subsequent request made by the user or computing device.

Thus, a particular user is not tied to a single account or set of credentials. If account information is compromised, traffic from the computing device is only compromised temporarily. As soon as new account information is generated, the compromised account information becomes obsolete and unusable by the entity that has procured the information.

In various implementations, the accounts and credentials are deleted after a grace period. Accordingly, if the SNC connection between the computing device and the server is terminated, the server may retain the credentials for a predetermined period of time. By retaining the account information and credentials, the computing device has a window of time in which it may re-establish a connection with the server. Once the window of time elapses, the server may delete the account and credential information. The duration of the period of time may be determined by a user or an administrator.

It should be understood that although account information and credentials may be created and later discarded for security reasons, the account information and credentials may be retained for future use. Furthermore, the account may have been setup and configured in advance and may be reused when another request for an account is made.

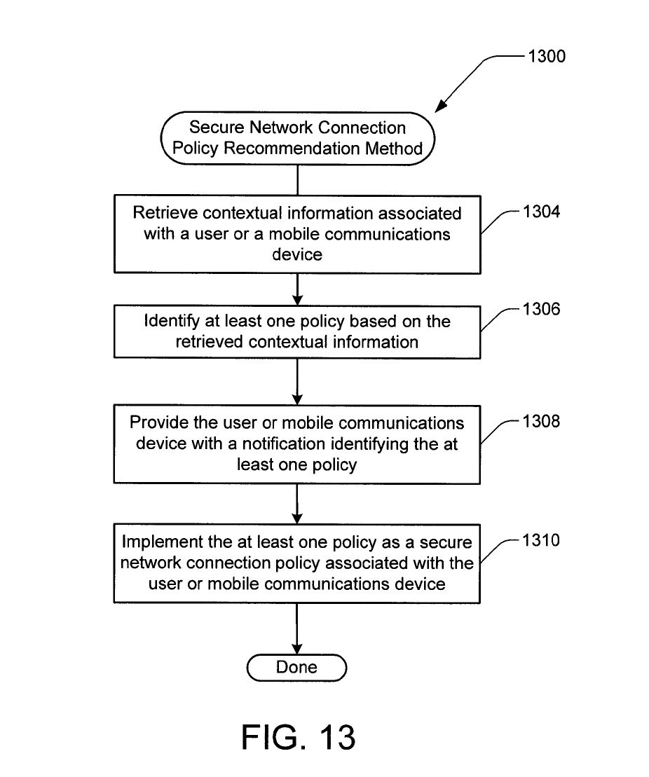

FIG. 13 illustrates an example of a block diagram of a method for recommending a policy for a secure network connection, implemented in accordance with some implementations. Method 1300 may recommend and implement a SNC connection policy based on a user's context and behavior. Accordingly, method 1300 may identify a policy and provide a user with a notification and recommendation based on the user's present situation and based on the user's previous actions.

Accordingly, at step 1304, contextual information associated with a user or computing device may be retrieved. In various implementations, contextual information may be information that identifies actions, activities, and locations associated with a user or the user's computing device.

For example, contextual information may include a user's browsing history for a web browser installed on the computing device. Contextual information may also include a configuration of the computing device, such as applications installed on the computing device, which applications have been accessed recently, and which applications have been used the most. For example, the presence of certain applications, such as gaming or corporate applications, on the computing device may provide configuration information that forms the basis of recommending a policy specific to those applications.

Contextual information may also include data and information collected by sensors and sensing devices installed on computing device. For example, contextual information may include a user's current geographical location, and geographical locations where a user has been in the past. The geographical location may be determined by global positioning system software and hardware installed on the computing device. The geographical location may also be determined from cellular tower information or other such connectivity information.

The contextual information may be retrieved from one or more data stores of the computing device. In some implementations, contextual information is collected and stored in one or more data stores as part of the computing device's ordinary operations.

For example, a web browser installed on the computing device may record recent websites visited by a user as the user's browser history. The browser history may be stored as a data record in the computing device's memory or storage media. An application installed on the computing device may retrieve contextual information from multiple sources to generate a centralized repository of contextual information. Thus, an application provided by a service provider, such as Lookout®, may collect contextual information from various different sources, such as a web browser, global positioning system, and an operating system installed on the computing device.

At step 1306, at least one policy may be identified based on the retrieved contextual information. The policy may be identified by one or more components of the computing device, such as a policy manager. A policy manager installed on the computing device may be configured to identify one or more SNC connection policies based on the retrieved contextual information and based on one or more rules that may be included in the existing policies stored by the policy manager.

In one example, the policy manager may monitor contextual information, such as the computing device's geographical location. In response to detecting a change in the computing device's location, such as entering a different country or geographical region, the policy manger may identify a policy. For example, if the computing device enters a different country, the policy manager may identify a policy in which a SNC connection is always used.

In some implementations, the policy is identified by the server. Thus, the application on the computing device may package the contextual information in a message and send the message to the server. The application on the server may receive the message, and use the contextual information included in the message to identify a policy. As similarly set forth above, a server-side policy manager may identify one or more SNC connection policies based on the contextual information and based on one or more rules stored by the policy manager.

At step 1308, the user or computing device may be provided with a notification identifying the at least one policy. In some implementations, a notification module implemented on an account creation server may generate a notification that may be sent to the computing device. The notification may be displayed on a display of the computing device. Thus, a user of the computing device may be presented with a visual representation of the notification in a display of the computing device.

The notification may provide the user with a generated text string that provides the user with information identifying a recommended policy. The notification may further provide the user with information identifying the basis of the recommendation. For example, if the user's browser history indicates that the user often goes to online banking sites, a policy that requests SNC connections for banking websites may be identified and recommended. The notification generated based on the recommendation may display text, such as “We noticed you visit online banking websites. We recommend using a secure network connection.” In some implementations, the notification may prompt the user for an action and may be configured to receive an input from the user.

Thus, the notification may ask the user whether he or she wants to implement the recommended policy. The user may provide an input via an interface of the computing device, such as a touch screen display. The input may be relayed to a server-implemented instance of a SNC policy manager.

At step 1310, the at least one policy may be implemented as a secure network policy associated with the user or computing device. In various implementations, the policy is implemented automatically. Thus, a recommended policy may be identified, a user may be notified, and the policy may be implemented automatically by a policy manager implemented on a server or on the computing device itself.

In some implementations, the policy is implemented in response to a user input. As similarly discussed above, in response to being provided with a recommendation, a user may provide an input indicating that a recommended policy should or should not be implemented. A system component, such as a policy manager, may implement or not implement a recommended policy based on the received input.

Accordingly, if a user has indicated that a recommended policy should be implemented, a policy manager may implement the recommended policy for the user's computing device. Alternatively, if the user has indicated that the recommended policy should not be implemented, the policy manager may continue to use the policy that was already being used. The recommendation may be cached, saved, or stored in a data record that may be used in future iterations of policy recommendation method 1300.

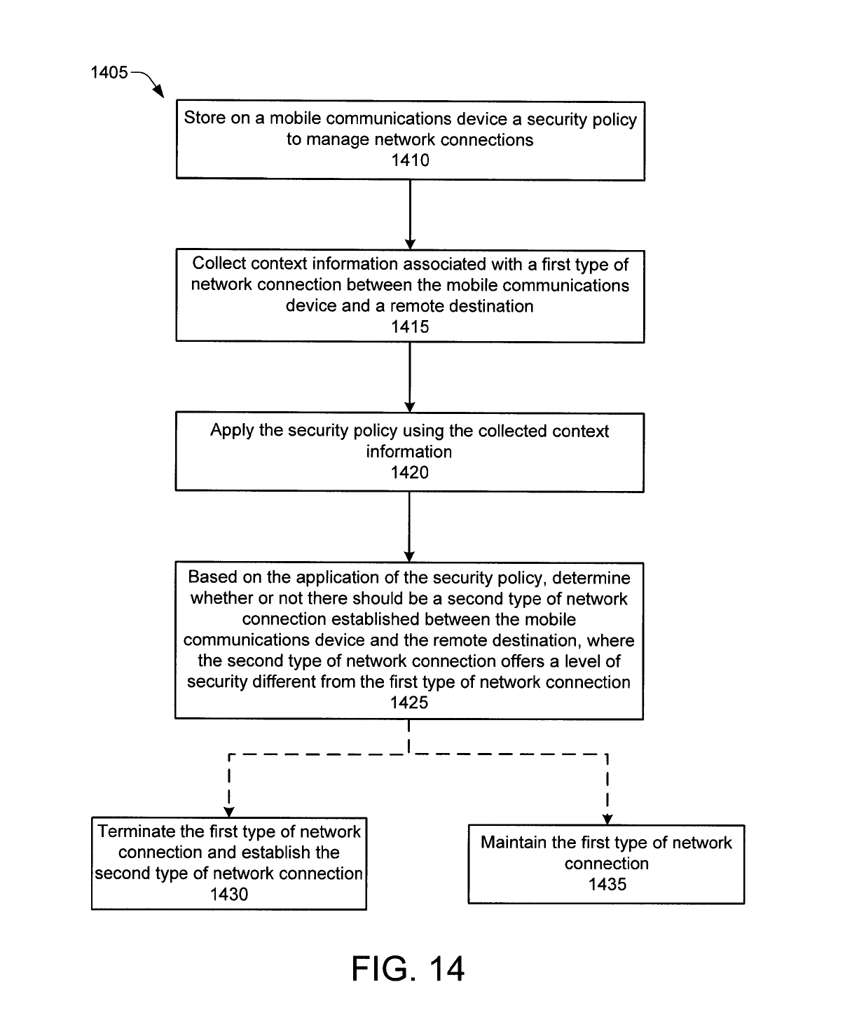

FIG. 14 shows a flow 1405 for determining whether the security level of a network connection is appropriate based on the context. In a step 1410, a security policy to manage network connections is stored on a computing device. In a step 1415, context information associated with a first type of network connection between a computing device and a remote destination is collected.

In a specific implementation, the context information is collected while a first type of network connection is established between the computing device and a remote destination. In another specific implementation, the context information is collected after a first type of network connection is established between the computing device and a remote destination. In another specific implementation, context information is collected before the network connection is established.

The remote destination can include, for example, a server, web server, application server, e-mail server, website, application, data store, node, service, another client device, access point, router, or the like. The remote destination may be referred to as a target device or target destination.

In a step 1420, the security policy is applied using the collected context information. In a step 1425, based on the application of the security policy, the system determines whether or not there should be a second type of network connection established between the computing device and the remote destination. The second type of network connection offers a level of security different from the first type of network connection.

In a step 1430, if the network connection of the second type should be established the system can terminate the network connection of the first type and establish the network connection of the second type. Alternatively, in a step 1435, if the first type of network connection offers an appropriate level of security, the system allows the first type of network connection to be maintained.

In a specific implementation, determining the appropriate type of network connection is based on a category of the remote destination. For example, the remote destination may be identified through a domain name. The collected context information may include the domain name. Further detail is provided below.

In some cases, the level of security offered by the second type of network connection will be greater than the level of security offered by the first type of network connection. Consider, as an example, a scenario where the collected context information indicates that the user is managing their financial accounts, the security policy specifies that such an activity should be performed using a secure connection (e.g., HTTPS or VPN), but the current connection is a relatively unsecured connection (e.g., HTTP). In this case, the system may terminate the unsecured connection with the remote destination and establish a secured connection with the remote destination. The secured connection helps to protect the user's sensitive financial information.

In other cases, the level of security offered by the second type of network connection will be less than the level of security offered by the first type of network connection. Consider, as an example, a scenario where the collected context information indicates that the user is reading sport scores, the security policy specifies that such an activity should be performed using an unsecured connection, but the current connection is a secured connection. In this case, the additional computing overhead associated with maintaining a secured connection may not be desirable because the information is not particularly sensitive. Thus, the system may terminate the secured connection and establish an unsecured connection. The unsecured connection may provide for a faster response and improved user experience than the secured connection.

Referring to step 1415 (FIG. 14), context information may be collected during or while the network connection is established. Context information may be collected after the network connection is established. Collecting context information while the network connection is established allows for continuous monitoring that helps ensure the type of network connection offers the appropriate level of security for the user's current activity.

Context information may be collected in response to the attempt by the computing device to establish the network connection. Context information may include information collected prior to the attempt by the computing device to establish the first network connection, and information collected in response to the attempt by the computing device to establish the first network connection.

In a specific implementation, the “while” case involves the system acting while the network connection is being established; the “after” case involves the system acting post that event. The “while” case can be for when the architecture can support the system being “in the flow” of the network connection being established, e.g., as part of an operating system module, or in the case in which the system code is the one which is actually doing the work of establishing the network connection. The “after” case can be for when the architecture does not let the code of the system participate or “get in the flow” of the original network connection being made. In this case, the system can observe the connection being made and then react to that after the fact.

In a specific implementation, after terminating the first type of network connection and establishing the second type of network connection (step 1430), context information may continue to be collected. A policy evaluation can be made based on the newly collected context information to determine whether the second type of network connection remains appropriate. If the security offered by the second type of network connection remains appropriate, the second type of network connection continues to be maintained. If the security is not appropriate, the second type of network connection is terminated and another type of network connection (e.g., first type of network connection) is established. For example, the security may not be appropriate for the user activity, location, the device, and so forth.

Similarly, after allowing the first type of network connection to be maintained (step 1435), context information may continue to be collected. A policy evaluation can be made based on the newly collected context information to determine whether the first type of network remains appropriate. If the security offered by the first type of network connection remains appropriate, the first type of network connection continues to be maintained. If the security is not appropriate, the first type of network connection is terminated and another type of network connection (e.g., second type of network connection) is established.

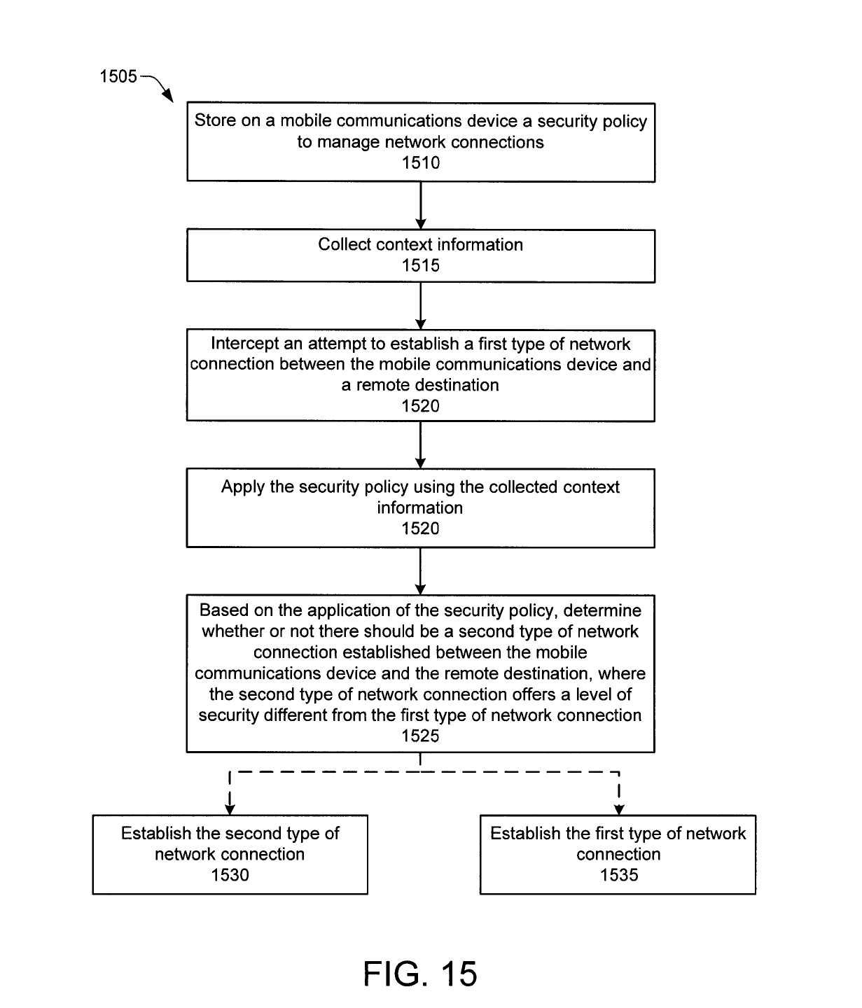

Context information may be collected before or prior to a network connection is established, in response to an attempt by the computing device to establish a network connection, or both. Context information can be collected prior to attempt to establish network connection, context information can be collected in response to attempt to establish network connection, or both. FIG. 15 shows a flow 1505 of another specific implementation for determining the type of network connection that should be established. In steps 1510 and 1515 a security policy is stored on a computing device and context information is collected.

In a step 1520, the system intercepts an attempt to establish a first type of network connection between the computing device and a remote destination. The interception may be an operating system event, a network driver event, a baseband processor event, a security application event, or an Android intent filtering event.

In a step 1525, the security policy is applied using the collected context information. In a step 1530, based on the application of the security policy a determination is made as to whether there should be a second type of network connection between the computing device and the remote destination, where the second type of network connection offers a level of security different from the first type of network connection. If so, the second type of network connection is established (step 1535). If not, the first type of network connection is established (step 1540).

In a specific implementation, a method includes collecting context information before a network connection is established, determining based on policy what types of network connections (security levels) are appropriate for the current context, and then if an attempt is made to establish a network connection, determining if the network connection which is attempting to be established should be allowed to continue, or if a different network connection should be made. In this specific implementation, the context-based decision is being determined at least in part prior to the attempt to establish the network connection.

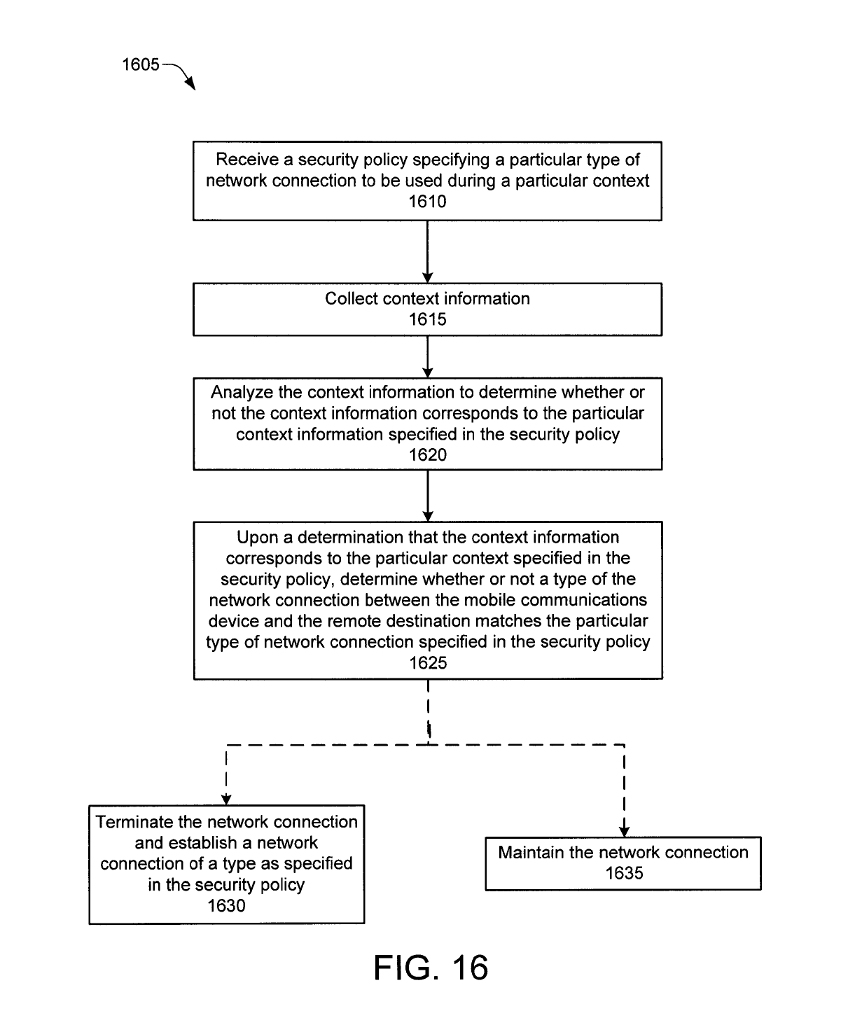

FIG. 16 shows a flow 1605 of another specific implementation of a system for ensuring a network connection having an appropriate level of security. In a step 1610, a security policy associated with a network connection between a computing device and a remote destination is received. The security policy includes a specification of a particular type of network connection to be used during a particular context. The security policy may be transmitted from the remote destination to the computing device.

Thus, an administrator of the remote destination can, via the security policy, specify the type of network connection that should be used to communicate with the remote destination. The security policy may be received while the network connection is established. The security policy may be received after the network connection is established. The security policy may be sent from the computing device to the server for the server to apply the policy.

As an example, the remote destination may provide a combination of non-sensitive and sensitive services. An example of a non-sensitive service provided by the remote destination can include a webpage that lists publically available mortgage rates. An example of a sensitive service provided by the remote destination can include a webpage that displays the user's account balances. The administrator can specify via the security policy that a non-secure network connection be used when the user accesses the non-sensitive services. Instead or additionally, the administrator can specify that a secure network connection be used when the user accesses the sensitive services.

In a step 1615, context information is collected. In a step 1620, the context information is analyzed to determine whether or not the context information corresponds to the particular context information specified in the security policy. In a step 1625, upon a determination that the context information corresponds to the particular context specified in the security policy, the system determines whether or not a type of the network connection between the computing device and the remote destination matches the particular type of network connection specified in the security policy. If the current or existing network connection does not match, the system terminates the connection and establishes a new network connection of a type as specified in the security policy (step 1630). Alternatively, if the connection does match, the system allows the connection to be maintained (step 1635).

Continuing with the example above, if the context information indicates that the user is merely browsing the mortgage rates, but the current network connection is a secure connection, the connection may be terminated and a non-secure network connection (or less secure network connection) may instead be established (see step 1630). The less secure network connection may offer a quicker response time than the more secure connection which can thus improve the user's experience. Alternatively, if the context information indicates that the user is accessing their account balances, the system may allow the current secure network connection to be maintained (see step 1635).

Similarly, if the context information indicates that the user is accessing their account balances, but the current network connection is a non-secure connection, the connection may be terminated and a secure network connection (or more secure network connection) may instead be established (see step 1630). Alternatively, if the context information indicates that the user is merely accessing publically available mortgage rates, the system may allow the current non-secure network connection to remain (see step 1635).

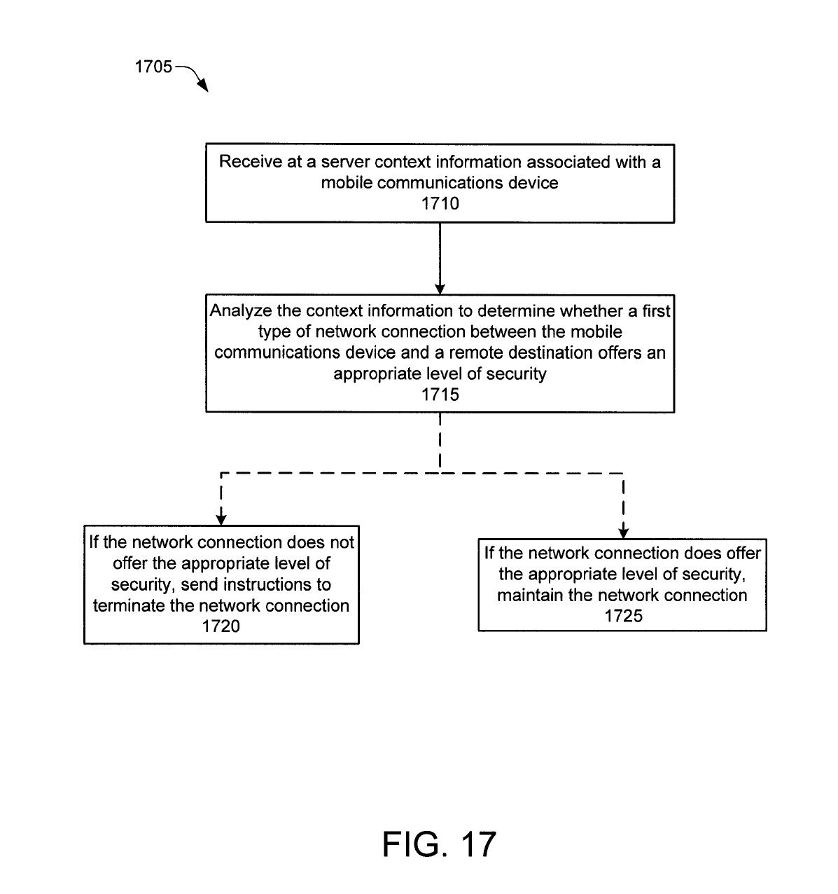

FIG. 17 shows a flow 1705 of another specific implementation of a system for ensuring a network connection having an appropriate level of security. In this specific implementation, context information collected at a computing device is transmitted to a server for analysis. In particular, in a step 1710, a server receives context information associated with a computing device. In a step 1715, the server analyzes the context information to determine whether a first type of network connection between the computing device and a remote destination offers an appropriate level of security. The remote destination may be same as or different from the server.

If the network connection does not offer the appropriate level of security, the server sends instructions to the computing device to terminate the network connection (step 1720). The instruction may additionally include instructions to establish a new network connection that offers the appropriate level of security. Alternatively, if the current or existing network connection does offer the appropriate level of security, the network connection may be allowed to remain (step 1725). Depending upon the context, policy, or both, the new network connection may offer a level of security greater or less than the level of security offered by the previous network connection.

Network connection types may refer to different types of physical connections, different types of overlay connections, different application connections, a physical connection with or without an overlay connection, or combinations of these. More particularly, in an embodiment, a physical connection refers to a connection at the lower network layers, e.g., a cellular network connection, a Wi-Fi network connection, a BLUETOOTH network connection.

An overlay connection refers to a secure tunnel or VPN or other connection made atop the physical connection. An application connection request refers to an app or browser requesting a connection be made with a specific destination, e.g., opening a TCP or UDP socket, issuing an HTTP GET or a DNS request from an application.

There can be more than one physical connection possible, or even currently active at any point in time from a device. For example, at any point in time a device may have a cellular network physical connection, a Wi-Fi network physical connection, a Bluetooth physical connection, and so forth.

A physical connection may have one or more overlay connections atop it. An overlay connection may have one or more application connections active over it, from the same or multiple applications. An overlay network is a logical network built on top of a physical network. An app or web browser can have more than one application connection requests active at any point in time; these may be over a single socket connection or multiple socket connections.

As can be appreciated, there are many aspects and embodiments of the system. Presented below in outline format are various embodiments, features, and aspects of the system. The system may include any one or combination of the aspects recited.

In an embodiment, a pipe system may include gateways and a host. Gateways may include terminal and intermediate gateways. In the embodiment, a host may be any system on a network. For example, hosts may be a user device (e.g., PC, laptop, mobile phone, or table), an embedded device (e.g., industrial control system, automobile, smart meter, or refrigerator), a server, network infrastructure, or any other system that might be reachable on the network.

In embodiments, VPNs may be used in a variety of ways. For example, they may be used to provide a client with access to a remote network for connectivity (e.g., to access Intranet services) or security (e.g., to encrypt traffic, apply enterprise network policy/security). VPNs may also be used to establish connectivity to a remote network (e.g., provide connectivity between multiple sites in a private network).

The use of VPNs presents a number of issues. For example, VPNs may require manual setup, such that each link must be set up and maintained by an administrator, often times with difficult configuration parameters and no centralized management. Additionally, VPNs may increase latency. VPNs that tunnel all traffic will often have the effect of slowing down Internet access because of un-optimal traffic routing through an enterprise data center, an overloaded VPN infrastructure, or because of congestion on a corporate network.

The use of VPNs may lead to the undesirable growth of the distributed enterprise network. Instead of only running internal applications in a single enterprise datacenter (or small number of datacenters), many enterprises are using cloud services either to deploy their software to (e.g., Amazon EC2) or using hosted application services (e.g., Box, Google Apps) that they no longer manage. VPN connectivity to provide access control to enterprise applications is now problematic: either there is a need for many tunnels (one to each cloud infrastructure), or a need for a complex network where devices are required to connect to a central service and have multiple tunnels out to the cloud from there. Neither is desirable from a complexity or latency standpoint.

The use of VPNs in conjunction with mobile devices creates further complications. Historically, enterprise desktops did not move. Rather, they accessed a fixed set of services from a fixed location (physical and network). The growth of laptops made it necessary to access the enterprise from outside the enterprise. Thus prompting the introduction of the VPN to provide secure connectivity back to the enterprise. Now, connected devices (mobile phones, tablets, etc.) interact with enterprise networks from many locations (e.g., mobile networks, Wi-Fi) in addition to accessing cloud services. Using a traditional VPN to bring all of connected device traffic to a corporate datacenter increases latency (and is a bad user experience) and is often undesirable.

In an embodiment, a gateway may be a key element of the core technology. A gateway is a system that is able to transport data (e.g., in the form of network packets) to its destination. Gateways may pass data unmodified, or may modify or even reject the data (e.g., network address translation, filtering security issues).

Gateways may perform a number of tunnel-related operations. For example, gateways may pass data into a tunnel (e.g., take network packets as an input and forward them via a VPN tunnel). Gateways may receive data from a tunnel and pass it on un-tunneled (e.g., receive packets from a VPN tunnel, remove the tunneling layer and pass them on un-tunneled). Gateways may re-tunnel data (e.g., receive packets from one VPN tunnel and forward the packets into another tunnel, removing the first tunnel's encryption and encrypting with the second tunnel's). Gateways may inspect and forward data in an existing tunnel (e.g., with a VPN tunnel's decryption key, the gateway may inspect the traffic and forward it without re-tunneling or de-tunneling). Gateways may perform network address translation (NAT) on traffic. Gateways may perform DNS proxying or DNS lookup services that reflect the results of network address translation.

In embodiments, a local gateway may run on a host that interacts with locally generated (or locally destined) data. An example of such a gateway would be one that handles network packets generated by that host before they are transported on the network. A remote gateway handles traffic from remote systems. Such a gateway is neither the intended source or destination of traffic. A terminal gateway is a gateway at an end of a tunnel. When running a network tunnel, the system has two or more gateways that terminate (i.e. form ends of) a secure tunnel. These are called terminal gateways. A terminal gateway may be a host accessible on the internet to remote hosts (e.g., a tunneling service in the cloud), or a local terminal gateway that is resident on a host for transporting locally-generated traffic (e.g., a local tunneling client). In embodiments, such tunnels may contain data encrypted between terminal gateways so that observers between the gateways cannot observe the traffic. An intermediate gateway may be located between terminal gateways. Intermediate gateways may be used where it is not desirable for traffic to flow directly between two terminal gateways. The making of gateway routing decisions is described within.

In embodiments, an intermediate gateway may terminate a tunnel and then re-tunnel the data to another intermediate gateway or to a terminal gateway. Thus, in this case, the intermediate gateway performs the same operations as a terminal gateway, but because no traffic exits the intermediate gateway de-tunneled, it is not considered a terminal gateway.

Intermediate gateways may be used in embodiments where it is desirable for traffic flowing through a tunnel to be inspected, modified, or otherwise analyzed. In such cases, an intermediate gateway may perform the inspection either in parallel with or serial to the tunnel. For example, if a web-filtering system is analyzing HTTP traffic for malicious javascript attacks, the web filter may be configured as an intermediate gateway (or attached to an intermediate gateway) so that all traffic flowing across the tunnel is analyzed.

In embodiments, intermediate gateways may be able to inspect traffic via multiple mechanisms. In one embodiment, traffic between terminal gateway and intermediate gateway is tunneled in such a way that an intermediate gateway can decrypt the data. In this embodiment, the terminal gateways and any intermediate gateways utilize a shared session secret that is exchanged to all parties during initial key exchange. The secret may be shared by one of the terminal gateways transmitting the session secret to an intermediate gateway when required. In an example, if one terminal gateway initiates a tunnel to a second terminal gateway, with an intermediate gateway between the terminal gateway and intercepting and relaying traffic, the intermediate gateway and the second terminal gateway may share the same asymmetric private key and certificate (e.g., if using RSA or EC asymmetric cryptography). Thus, with the second terminal gateway performing the key exchange and setting up a secure tunnel with first terminal gateway, the intermediate gateway can decrypt and optionally modify the traffic.

In embodiments, an intermediate gateway may terminate the tunnel on both sides so that it establishes separate tunnels to each terminal gateway. Such tunnels may be the same form of tunnel or different (e.g., interfacing with legacy infrastructure is discussed elsewhere in the application).

In embodiments, an analysis gateway is a gateway that performs analysis. This gateway may be terminal or non-terminal, local or remote, internal or external, etc.

In embodiments, gateways are elements of transport architectures. The following exemplary transport architectures refer to bi-directional communication flow. A series of connection-oriented steps may combine to create a particular architecture or set of connections. For example, a local terminal gateway may connect to a remote terminal gateway to establish a tunnel, rather than the other way around, though once connected, traffic can flow both ways. Exemplary transport architectures include (listed as bullet points for clarity):

local terminal gateway ⇄ remote terminal gateway;

local terminal gateway ⇄ remote intermediate gateway ⇄ remote terminal gateway;

local terminal gateway ⇄ local terminal gateway;

local terminal gateway ⇄ remote intermediate gateway ⇄ local terminal gateway;

remote terminal gateway ⇄ remote terminal gateway; and

remote terminal gateway ⇄ remote intermediate gateway ⇄ remote terminal gateway.

Embodiments of the system may contain an arbitrary number of intermediate gateways. And gateways may inspect, analyze, modify, or drop traffic. In fact, any gateway may intercept traffic, reassemble streams (e.g., in the case of TCP), and perform analyses, including local gateways, terminal gateways, and intermediate gateways.

Many types of analyses are envisioned, including, for example, anti-malware scanning, IDS/IPS analysis, and DLP analysis. There may be many types of security analyses performed. An analysis component itself may be integrated with a gateway (an intermediate gateway, for example) directly, or may be attached via a standardized interface (such as the ICAP protocol).

In embodiments, the result of an analysis is a response, which may be an action such as: sending an alert (e.g., via email, to a security alerting console, to a SIEM system); terminating the connection; modifying the traffic to remove the issue (e.g., in the case of an exploit, removing the exploit from the content carrying it and inserting a message in the content informing a user that the exploit has been removed); and logging the alert in a database for further action by a policy system. And such further action by a policy system may include: preventing the device from accessing any enterprise systems, starting the logging all of the device's traffic for forensic purposes, increasing the risk level of the device, and erasing all sensitive data from the device.

In embodiments, the traffic may be analyzed in-line or in parallel. If analyzed in-line, traffic is not forwarded before the analysis has resulted in an initial response. If analyzed in parallel, that traffic is forwarded without waiting for a response.

Embodiments may interface with existing infrastructure. For example, in embodiments, a gateway may utilize existing network infrastructure to route data. And such existing network infrastructure may include: an existing VPN system, an existing network, and an existing mobile network APN (Access Point Name). Similarly, a gateway may use a protocol supported by existing network infrastructure to transport traffic. Such use an existing network infrastructure in an architecture may be implemented if a company has a legacy VPN system (e.g., Cisco SSL VPN, OpenVPN, Juniper SSL VPN, IPSEC), but wishes to utilize embodiments of the secure tunneling and routing system to provide connectivity and access control to internal services.

In an example of using existing an existing protocol, a first remote gateway has an SSL VPN connection to a VPN concentrator in an enterprise. A client with a local terminal gateway connects to the remote gateway utilizing a network tunnel, such as one described herein. The remote gateway terminates the first tunnel and routes traffic via an SSL VPN tunnel to the VPN concentrator.

In an embodiment, there is a single tunnel between a remote gateway and a VPN concentrator that other gateways use to transport multiple clients' data. In this embodiment, the remote gateway has the ability to inspect traffic because it is re-tunneling data. And the remote gateway performs access control—only allowing authorized users to transmit data into the enterprise network.

In any gateway, all of the features and functionality of a routing and tunneling system according to the various embodiments may be performed by a gateway before passing traffic to or from an existing network infrastructure. Such features and functionality include, for example, traffic analysis and filtering. And may include access control, including access to the network as a whole, access to services on the network, or more granular forms of access control.

In an embodiment, an internal gateway is inside of a perimeterized network. The internal gateway may handle traffic via a remote intermediate gateway—outside of the perimeterized network. Perimeterized networks, themselves, are common and most typically take the form of a firewall that prevents outside hosts from connecting directly to hosts inside the perimeter. Often, however, hosts inside the perimeter are allowed to connect to hosts outside the perimeter.

Regarding the use of internal gateways, in an embodiment, an internal gateway is a terminal gateway. This internal terminal gateway may connect to a remote intermediate gateway because it is likely the internal terminal gateway is behind a firewall and the remote intermediate gateway cannot reach the internal terminal gateway directly. However, in an embodiment, the internal terminal gateway is directly reachable and, therefore, the intermediate gateway may connect directly to it. In another embodiment, an existing network infrastructure, such as an SSL or IPSEC VPN, may be used to transport data from a remote intermediate gateway to internal terminal gateway. In still another embodiment, an internal gateway is an intermediate gateway that communicates with local terminal gateways on hosts inside the network.

In an example of an embodiment, a mobile device with a local terminal gateway connects to a remote intermediate gateway. The remote intermediate gateway has a pre-existing connection with an internal terminal gateway within the perimeter of an enterprise network. When a client attempts to connect to a service on the enterprise network, the intermediate gateway first decides whether the client is authorized. If the client is not authorized to communicate with the network and/or the service, the traffic is not relayed to the internal terminal gateway. If, however, the client is authorized, the intermediate gateway relays the traffic over the existing connection and the internal terminal gateway relays that traffic to the service.

Embodiments may use an internal terminal gateway as primary default network gateway. For example, it may be desirable to not have local terminal gateways installed on all clients in a network, yet still provide the functionality disclosed herein. An embodiment making this happen replaces a normal default network gateway that simply routes remote packets to a carrier network with a terminal gateway. In the embodiment, instead of a local network having a default gateway that routes directly to the internet, the network's default gateway is an internal terminal gateway that routes traffic received from the local network.

Embodiments regard traffic that is both sourced from and destined for the local network. In an embodiment, the internal terminal gateway does not route or even interact with this local traffic. This provides the functionality of a typical network gateway. In a different embodiment for traffic that is both sourced and destined for the local network, an internal terminal gateway manages the routing of local traffic. The internal terminal gateway does not need to tunnel local traffic from source to destination if neither have local gateways. In such a case the internal terminal gateway is used to provide the authenticated source a picture of the network, which can include only the destinations for which the authenticated source (user and/or device) are authorized. In such a case, the internal terminal gateway routes the un-tunneled traffic. If only one host has local gateway, the internal terminal gateway may tunnel traffic to or from the host's local gateway. And if both hosts have local gateways, the internal terminal gateway may act as an intermediate gateway, enforcing routing policy, but not being required to terminate the tunnel. Rather, it may re-tunnel the traffic after inspecting or analyzing it (intermediate gateway functionality is described within).

In a further embodiment, the internal terminal gateway interacts with software defined networking systems. In this embodiment, the internal terminal gateway may dynamically modify virtual networks (e.g., VPNs) in response to changing routing rules. For example, the internal terminal gateway may dynamically modify a virtual network where the gateway has analyzed traffic and determined that a first host can no longer communicate with a particular network service because the service has been deemed high risk. In an example, an internal terminal gateway interacts with any SDN system that supports OpenFlow. Such an SDN system is Floodlight [http://www.projectfloodlight.org/floodlight/], which provides the ability to have virtual switches [http://www.projectfloodlight.org/virtual-switch/] to create virtual networks that enforce routing rules.

In embodiments, hosts on a local network can only communicate with each other via internal terminal gateways. In one such embodiment, switching infrastructure may prevent normal hosts from communicating with each other, instead only allowing hosts to communicate to internal terminal gateways, which can route packets between hosts. In another such embodiment, an internal terminal gateway is built into a switch so that it can control routing policy without requiring a separate piece of network infrastructure. Such switch may be a physical switch or a virtual switch, for example Floodlight Virtual Switch. In an embodiment, an internal terminal gateway configures a switch to control which hosts can communicate with each other on the network. In an embodiment, an internal terminal gateway only inspects and analyzes internal network traffic and does not enforce routing policy. In an embodiment, all hosts on the network may be configured to have a 255.255.255.255 (i.e. 32-bit) netmask so all traffic must flow through the default gateway (i.e. the intermediate terminal gateway) and no traffic can flow directly between hosts on the network. In an embodiment, an internal terminal gateway controls all ARP (Address Resolution Protocol) protocol messages in an internal network according to the following. If a first host is allowed to communicate with a second host, then ARP resolution of the second host by the first host is allowed. If the first host is not allowed, then ARP resolution is blocked. If the first host's traffic must be analyzed by the internal terminal gateway, the internal terminal gateway responds to the first host's ARP request and proxies traffic between the first and second hosts.

Additional embodiments regard traffic that is destined for or sourced from a remote network (i.e. not the local network). In an embodiment, an internal terminal gateway tunnels traffic to another terminal gateway—for any traffic that a routing policy determines should be tunneled, the internal terminal gateway routes the traffic to the appropriate destination. For example, it may be desirable to bridge two local networks remotely without any of the traffic traveling over the network in clear-text. In such case, two internal terminal gateways may route all traffic over a tunnel established between them. If both these internal terminal gateways are behind a firewall, a remote intermediate gateway may be used. In cases using a remote intermediate gateway, an arbitrary number of internal networks may be joined together without each network needing to be aware of all other networks. An arbitrary number of remote intermediate gateways may be used to avoid needing to tunnel traffic to a central location. In another example, it may be desirable that traffic from a company's remote office enters the internet from a corporate datacenter. In such case, an internal terminal gateway may tunnel the traffic to a terminal gateway at the corporate datacenter.

Additional embodiments regard traffic that is destined for or sourced from a remote network (i.e. not the local network). In an embodiment, a tunneling policy is selective. That is, based on a routing policy, an internal terminal gateway may choose to tunnel some traffic, but not all (the section on routing decisions provides further embodiments and examples of this). In an example, a routing policy may require that all unencrypted HTTP traffic be tunneled to a secure internet peering location if the local network is located in a hostile network environment.

Additional embodiments regard traffic that is destined for or sourced from a remote network (i.e. not the local network). Embodiments use identity for routing decisions and analysis. And for traffic on a local network, different types of identity can be inferred using different characteristics. For example: device identity can be inferred from the device's MAC address on the network; and user identity can be inferred utilizing 802.1x (where a user must supply login credentials on their device to connect to the network), or a pre-registered set of device-to-user mappings (e.g., a database which contains a listing of users and their corresponding device MAC address mappings). User identity may also be determined based on the internal terminal gateway presenting a captive portal where a user must login to have the gateway route traffic for that user (e.g., as is common with hotel Wi-Fi systems).

In embodiments, routing policy may take the form of conditions and actions that are connected together directly, or through labels. Routing policy may be permissive by default (e.g., if no policy matches, perform default routing and allow), or restrictive (e.g., if no policy matches, refuse to route), and may allow only a single entity to control it (e.g., an organization's IT administrator), or multiple parties to apply their own policies that are layered together (e.g., a carrier network administrator, an IT administrator, and an end user may each specify policy).

In embodiments where implementing routing policy uses traffic labeling, instead of direct condition to routing action mapping, conditions may be used to “tag” traffic, with routing policies being applied to traffic according to its tag. This may be advantageous by allowing complex conditions to result in particular tags, thereby eliminating the need to repeat certain actions. For example, traffic may be given the tag “high-risk” by a number of conditions (e.g., source country is China, source is a high risk device, source is a low-prevalence application, or an analysis engine determines it is using an unknown protocol). Even though there are many things that could lead to high-risk traffic, a network administrator may wish to route all such traffic to a traffic logging system, and prohibit access to source code repositories.

In embodiments, traffic labels may be used for implementing routing policy only within a particular system, or may be may be transferred between systems—either alongside the data (e.g., as part of a tunneling protocol), or out of band. For example, traffic labels may be encoded as 16-bit integers, and included in the protocol format for a tunneling protocol. In the tunneling protocol data format, there may first be an 8-bit integer that specifies the number of labels that follow, with that followed by 16-bit label identifiers. A gateway may have a database that maps labels to label identifiers so it can map labels to routing policy actions. In an embodiment, there is no such database and all policies compiled to run on gateways only reference labels. In an embodiment, instead of fixed-length integers, labels are represented by variable-length integers, such as the variant format from Protocol Buffers (e.g., see https://developers.google.com/protocol-buffers/docs/encoding).

In embodiments, routing policy is implemented using configuration rule matching. For example, if there is no match, the traffic is denied routing, or is routed through a default route. If there are multiple matches, the rules that match are following according to a pre-set ordering or hierarchy. Alternatively, if there are multiple matches, the match following is the most specific match (e.g., each condition has a level of specificity, e.g., an application hash has a higher specificity than a package name, which has a higher specificity than a source country). In an embodiment, any match to a “deny” configuration rule has higher precedence than other specific routing actions.

In embodiments, routing policy may be based on conditions. Exemplary conditions that may affect routing include: the source or destination user or device group (e.g., part of an organization, in a department in an organization, arbitrary grouping specified by LDAP (Lightweight Directory Access Protocol) or Active Directory); the source or destination user or device is a specific user or device; the source or destination location (e.g., in China); the source or destination network (e.g., ATT Wireless, Vodafone, corporate internal network, AS 26918); the source or destination IP or hostname; the source or destination network type (e.g., Wi-Fi, secure Wi-Fi, unencrypted Wi-Fi, cellular data network, 3G, LTE, public internet, internal network); the source or destination device type (e.g., PC, laptop, smartphone, tablet, server, virtual machine); the source or destination OS or OS+ version (e.g., Windows 8, Windows XP, OS X 10.5, Android 4.2, iOS 6.0.1, Ubuntu 10.04.4, Linux 2.6); the source or destination application as identified by name, version, hash, package identifier, signer, or any other identifier (e.g., Outlook 2012, Angry Birds Seasons, Lookout, Google Chrome 14.0.1, com.android.camera, application with SHA-1 hash b811107c6bce6604ee436e3d4b3fcfbfb08027f2, application signed by certificate with SHA-1 fingerprint 62d19419f7cff0df82476d3d8bf662dbd4312d13); whether the device, user, application, source, or destination has particular attribute (e.g., device was tagged as high risk by an analysis system, the device has malware present, the application was tagged as high risk by an analysis system, the application has a low prevalence in the world or in a subset of devices (e.g., the devices under management by an enterprise administrator or a managed service provider), the destination domain was tagged as malicious, the destination was tagged as high risk); the traffic protocol (e.g., HTTP); the HTTP URL (e.g., partial URL, wildcard, full URL); and the content or type of data transmitted or received.

In embodiments, routing policy may ask for certain routing actions. Such actions, when implemented, may relate to, for example: causing traffic to exit through a specified gateway (e.g., San Jose, or an Internal gateway for an organization); causing traffic to exit through a gateway in a specified country; not allowing traffic to exit in a particular country; causing traffic to be analyzed by a specific analysis system attached on an intermediate gateway; limiting data rates; allowing or denying routing; allowing or denying routing to a particular destination IP, hostname, IP range, or host group (e.g., pre-defined list of engineering source code servers, marketing file shares, patent attorney docketing systems).

In embodiments, implementing or applying actions to a routing system may drive requirements that must be satisfied acceptably before traffic is routed. Such requirements may change as a result of analyzing routing policy. And some conditions or requirements may have pre-requisites to be satisfied before the traffic is evaluated regarding the condition (e.g., traffic must be run through an analysis system). For example, routing and analysis requirements may be pre-requisites to evaluate policy or actions enacted as a result of evaluating policy. In an example requirement, traffic must be passed through an analysis system (e.g., traffic must be analyzed with an anti-virus system to evaluate a condition that depends on the output of such a system). And any of the routing actions described above may be implemented as a requirement.

In a further example, if it is desirable to block Android malware being downloaded over TCP port 80, one embodiment would map traffic, with a condition or label of “Android Malware Detected” and the server port being equal to 80, to the action of blocking the labeled traffic. In such case, an embodiment of the system would evaluate the policy and determine that, to process this condition, an anti-malware system would have to evaluate all traffic over TCP port 80. This would result in a related routing requirement that ensured that all TCP port 80 traffic passed to such an anti-malware system.

In some embodiments, there are no condition pre-requisites; however, conditions may create dependencies. For example, the previous desire to implement the blocking of Android malware could be implemented by two rules: 1) all TCP port 80 traffic must be routed through an anti-malware system, and 2) all traffic evaluated by the anti-malware system as having Android malware is blocked. Is this example, there is no complex pre-requisite calculation; however, such rules may become cumbersome to maintain.

In embodiments, a policy analysis system may evaluate all rules that have dependencies (e.g., based on analysis systems) and may produce a report showing which traffic has the potential to conform to these rules. Such an analysis system may also identify orphaned policies—policies that cannot possibly be triggered currently.

In embodiments, routing may be coordinated amongst multiple gateways. In an embodiment, a first gateway may evaluate routing policy, specify a full route, and indicate to other systems in a data path what that route is. An example involves a client with a local terminal gateway that transmits traffic to a first remote intermediate gateway. The traffic is to be analyzed by a second intermediate gateway and routed to an internal terminal gateway in an enterprise network. In this example, the first intermediate gateway may perform the routing policy evaluation, and tag the traffic with the full route. The first intermediate gateway may use a number of the methods described within to evaluate the traffic and apply a routing policy (the methods including, e.g., re-tunneling, having access to a decryption key used to encrypt traffic, not having access to encrypted traffic). The second intermediate gateway—the gateway performing the analysis of the traffic—may modify or ignore the routing information if the results of analysis change the routing policy that, as a result of the analysis, needs to be applied.

In an embodiment, a data transport protocol (e.g., a tunneling protocol, an IP protocol) includes routing information that specifies routing decisions for other systems in the routing path to make. If the data transport protocol is an IP protocol, the routing information may be carried as IP headers, whereas for a tunneling protocol, the information may be carried in the tunneling protocol format.

In embodiments, the routing information, itself, may include an ordered set of identifiers for systems involved in the routing path. In such embodiments, the systems in the routing path may be gateways. Identifiers for such systems may include an ID, IP address, or hostname. In the case of an ID there may be a database that provides the IP address or hostname for a given ID. Alternatively, the ID may map to a DNS request by which the system can be looked up. For example, for ID 12211, the IP of the gateway may be resolved by performing a DNS request for: gw_{—}12211.example.net. Ideally, the results of the request are cached to avoid latency. And caching can be accomplished by standard DNS resolution caching mechanisms.

In embodiments, for the final terminal gateway, the routing information is stored so that any return traffic may be tagged with the reverse routing information (which is usually just the opposite of the forward-path routing information) to reach its final destination.

In embodiments, at each system in the routing chain, the routing information may be popped (i.e., the current hop is removed, leaving only the remaining hops) or routing information may remain intact. In an embodiment where the routing information is popped, each intermediate system that removes routing information must store return path information so that return path routing information can be added back onto any returned data packet.

In an example, each protocol message containing one or more encrypted packets in a tunneling protocol may contain an ordered set of 16-bit integers specifying the route that the tunneled data should take. The header specifying this information may have an 8-bit integer specifying the number of route identifiers that follow, then a successive array of 16-bit route identification integers. Each network system knows its own route ID so it knows which element is next in the routing chain. At the last hop in the routing chain (i.e. a terminal gateway), the packet(s) are de-tunneled and surfaced to the network. Because the tunneling system may employ network address translation (NAT), any connections that are created must be tracked on the terminal gateway so that return-path traffic can be routed to the originator of the exchange. In this example, reverse-routing path state information (e.g., the same format, but the 16-bit integers reversed, specifying a reverse routing path) is stored in addition to normal connection state (e.g., TCP or UDP state tracking) information. When return-path data is received, the terminal gateway tunnels that data, adding the reverse routing information, and sends it to the next gateway in the chain.

In embodiments, a gateway evaluates routing policy and executes any routing requirements it can. The gateway then specifies the remaining requirements that must be met. In such embodiments, to determine routing requirements, a gateway first executes routing policy, then based on the actions determined by the routing policy, determines the requirements. In embodiments where routing policy may have pre-requisite requirements, those pre-requisite requirements are also determined.

In an example, where the overall goal is the same as the example in which the full routing path was decided ahead of time, a client with a local terminal gateway transmits traffic to a first remote intermediate gateway for analyzing by a second intermediate gateway and for routing to an internal terminal gateway in an enterprise network. In this example, the first intermediate gateway both performs the routing policy evaluation (using the same methods of evaluation as described in previous embodiment), and determines the requirements that must be met to process and transport the traffic. The first intermediate gateway may perform some of the requirements, e.g., choosing a destination terminal gateway, performing some analysis, etc. The rest of the requirements are tagged on the traffic so that later gateways (e.g., the second intermediate gateway, or the internal terminal gateway) may satisfy them. As discussed previously, an analysis of the traffic may result in the modification or ignoring of the routing information, if the results of analysis change the routing policy applied.

In embodiments, a gateway may evaluate routing policy and tag traffic with requirements to be satisfied by later gateways. Such requirements may be tagged as a set of identifiers, or may be more complex structures that specify parameters for the requirements as well. Requirements, themselves, may only specify actions to be taken (e.g., exit traffic through this gateway) or may be full policies (e.g., conditions+actions) to be applied. A particular gateway may pass along all requirements after it has evaluated them, indicating which requirements have been satisfied, or may only pass along requirements that have not yet been satisfied. In an embodiment where all requirements are passed along, the final terminal gateway may store the requirements so that they may be applied to return path traffic. In an embodiment where only the remaining requirements are passed, each gateway that has satisfied one or more requirements stores the requirements that it has satisfied for the traffic. The requirements are stored (coupled with state information on the route between source and destination), so that return path traffic may also satisfy the requirement.

For example, the requirements may be specified by a field in a protocol (e.g., a field in a tunneling protocol, or an IP header). This may include one array, prefixed with an 8-bit count of requirements, followed by an array of 16-bit requirement identifiers. In this example, the requirement identifiers are either known to all gateways, or may be retrieved from a separate system by the gateways. If gateways must retrieve policies from a separate system, the gateways ideally cache them so they do not need to re-fetch a policy for a given identifier in the future. This may include two arrays, one of requirements that have been satisfied, and another of requirements that remain to be satisfied. Each array formatted as previously mentioned (an 8-bit count of requirements followed by a 16-bit requirement identifiers). This may include either one or two arrays, both discussed above, where instead of 16-bit requirement identifiers, the elements in an array are binary structures containing information and parameters for each requirement. And this may include in a binary or text-based data format (e.g., JSON, XML, BSON, Avro, Protocol Buffers)

In an embodiment, a requirement specification is combined with a route specification to include both the identity of gateways along the routing path and the requirements that need to be satisfied. In an example of such a combination, a first intermediate gateway that receives data from a local terminal gateway on a mobile device may examine routing policy and determine that two requirements must be met: 1) that filtering for malicious PDF documents must be performed; and 2) that the traffic must exit the tunnel at an endpoint controlled by a particular organization. The first gateway then encodes those requirements into a tunneling protocol field, e.g., with requirement IDs 0x2131 and 0x3212, and routes them to a second intermediate gateway that has the ability to perform malicious PDF scanning. The second intermediate gateway examines the requirements, stores a record of the PDF scanning requirement in its state tracking table (so that it can apply the requirement to any return-path traffic), and then routes traffic with only the second requirement (i.e., to exit at an organizationally controlled gateway) to an internal terminal gateway inside of the organization. The organization de-tunnels the traffic and sends it to its destination. Return path traffic is passed by the internal terminal gateway to the second intermediate gateway, which performs malicious PDF scanning, and, if no malicious PDF data is found, routes traffic to the first intermediate gateway.

In an embodiment, a gateway evaluated routing policy, executes requirements it can, and routes traffic. In the embodiment, routing policy may not be able to be evaluated completely on one system. For example, if a routing policy condition depends on the output of an analysis system a gateway that does not have that analysis system cannot evaluate the policy. Thus, a gateway may evaluate a subset of a routing policy to determine routing requirements (e.g., actions triggered by routing policy or pre-requisites to evaluate policy conditions).

In an embodiment, for each condition in a policy, there may be criteria regarding which gateway evaluates the condition. Example criteria may regard or call for: a first remote gateway, an analysis gateway, a last terminal gateway, an analysis gateway with anti-malware analysis system, a local terminal gateway, an internal terminal gateway, all gateways, an enterprise-controlled gateway, or a plaintext gateway (i.e. gateway that has access to decrypted traffic). By clearly identifying which system executes which aspect of policy, a system can have confidence that all policies are executed without having to communicate coordination data with its traffic (and potentially causing additional data usage and latency)

In an embodiment, a policy is executed by multiple systems for redundancy. For example, a criteria for a given condition may include multiple systems, e.g., both first remote gateway and last terminal gateway, or for very important policies, every gateway.

In embodiments, the decision for where to route traffic next is determined both by what unevaluated policies remain and the routing requirements made or added as a part of already-evaluated policy. Thus, in an embodiment, a gateway has a database of other gateways it may route traffic to, along with their attributes. (See the discussion of the gateway registry within for embodiments and examples of the types of attributes and how such a system may be implemented). For example, if there are unevaluated policies that may only be evaluated on a system with a data-loss-prevention (DLP) system, then the gateway routes the traffic to an analysis system that has such a gateway available. In a further example, if a requirement is such that the traffic must exit through a terminal gateway that is located in the US, then the gateway routes the traffic to such a terminal gateway.

In embodiments, routing rules may be pre-configured for a gateway. One method of pre-configuring includes pre-compiling routing policy into conditions and routing destinations so that full policy evaluation does not need to take place at runtime. For example, if routing policy is known from traffic known to be from a particular device, user, group, organization, application, host, or IP range (etc.), then deep traffic analysis or policy evaluation may not need to be applied. Similarly, if routing policy is known for traffic known to be destined for routing destinations, e.g., drop traffic, exit traffic to internet, route to specified gateway, route traffic to gateway matching given criteria (see gateway registry), analyze traffic with particular analysis system, only allow traffic to specified destinations, don't allow traffic to specified destinations, then deep traffic analysis or policy evaluation may not need to be applied.

The pre-configuration may be stored on a gateway as a set of rules, or may be stored in a database accessible to a gateway so that it can be retrieved. In an example of such pre-configuration, traffic from email applications on Acme, Inc. devices is routed to an internal terminal gateway inside Acme's firewall. The traffic is allowed to travel only to mail.internal.acme.com from that terminal gateway (i.e. the company's email server).

In an embodiment, a gateway may evaluate conditions and specify traffic labels so that routing actions can apply to it. A gateway may determine traffic labels when evaluating policy conditions (e.g., in the above embodiments of policy evaluation). Labels can be a direct consequence of determining if policy conditions are true (see traffic labeling above). And routing actions may be linked to conditions via the application of labels. That is, instead of or in addition to directly transmitting requirements (e.g., routing actions), the gateway may determine traffic labels and transmit those to other gateways. For example, in a tunneling protocol, traffic labels are encoded as 16-bit integers, prefixed by an 8-bit count of labels. In another example, a first intermediate gateway executes conditions that label traffic as “internal” and “smartphone.” An internal gateway may have different actions applicable to smartphone internal traffic from laptop internal traffic, but it may be undesirable for the first intermediate gateway to control setting those requirements (especially if that intermediate gateway routes traffic for many organizations, storing all such policy may be undesirable).

In an embodiment, routes are communicated and established separately from tunneled traffic. In the embodiment, routes are pre-negotiated, rather than having all tunneling protocol packets contain routing requirements, labels, explicit routing, etc. A completed route stretches between two terminal gateways, and may span no other systems, or may span a number of intermediate gateways. Note: because a gateway may de-tunnel and re-tunnel traffic, a route may or may not maintain the end-to-end cryptographic keying. Still, one benefit of pre-negotiated routing is that it can ensure crypto-path requirements are met. In a further benefit, a tunneling protocol may allow pre-negotiation of routes, so that when a terminal gateway builds a tunnel to another terminal gateway, the routing for that tunnel is set. Thus, each data packet flowing through the tunnel does not need to explicitly contain all routing information.

In the embodiment, a first gateway identifies a second gateway as a candidate for the next hop in the route. The first gateway requests that a route be created from the second gateway. The second gateway determines if the route from the first gateway to it is acceptable (e.g., allowed/disallowed given current policy, second gateway is operating correctly and not overloaded). If the route is unacceptable (e.g., not allowed), then the second gateway responds with a negative response and indicates the reason that the route is unacceptable. Such a response may be a “temporary” negative, indicating that the reason for denial is a temporary condition that may resolve itself. Such a response may be a “persistent” negative, meaning that the reason for denial will not go away unless the configuration of the system changes. The second gateway also determines if it is a terminal gateway or whether it needs to find another gateway to complete the route. If the second gateway is a terminal gateway, then it stores a record of the route and replies to the first gateway that a route is complete. If the second gateway is not a terminal gateway, then the second gateway performs this process recursively to complete the route. That is, to complete the route, the second gateway acts as the first gateway did—the second gateway identifies a third gateway and requests that a route be created to the third gateway. The third gateway either responds with information that the route is complete, or with a negative response (persistent or temporary). If the second gateway receives a “route complete” response from the third gateway, it stores a record of the route and replies to the first gateway that the route is complete. If the second gateway receives a negative response from the third gateway, then the second gateway may look up alternate next-hop gateways, or may return a negative response to first gateway (temporary or permanent depending on the response from third gateway). If the first gateway receives a route complete response from the second gateway, all gateways as part of the route will have knowledge of the route (based on the recursive lookup). The first gateway stores a record of the route and the route is now active. Further, all other gateways as part of the route will have the route stored and consider it active. Thus, per the embodiment, for an active route, the first gateway in that route receives traffic destined for that route and routes the traffic to the appropriate next hop gateway (after performing any processing or analysis of the traffic to determine if the traffic is allowed to follow this route). Each gateway along the route does the same until the traffic reaches a terminal gateway.

In the embodiment, there may be various ways of handling negative responses from potential next-hop gateways. In one, if a potential next-hop gateway returns a negative response to a requesting gateway (e.g., the second gateway responds to the first gateway with a negative response), then the requesting gateway trying to identify a next hop (e.g., first gateway) may identify an alternate next-hop gateway to try and establish a route with. If the alternate next-hop gateway can complete the route, then the requesting gateway stores a record of the route and, if it is a terminal gateway, makes the route active gateway. If the alternate next-hop gateway provides a negative response to requesting gateway, then the requesting gateway may continue requesting additional alternate gateways to complete the route. In an embodiment, if the requesting gateway receives a negative response from a next-hop gateway, the reason for the response may change the behavior of the requesting gateway. If the negative response is temporary, then it will continue searching for an appropriate next-hop gateway; however, if the negative response is persistent, then the requesting gateway will not continue and fail the search for a next-hop gateway. In an embodiment, negative routing responses are cached by requesting gateways to avoid repeatedly retrying routes that have failed. Temporary negative responses may specify a time after which it is OK to retry, or the requesting gateway may automatically retry after a period of time. This period of time may increase after successive temporary aborts (e.g., exponential backoff).

In embodiments, a route identifier may be propagated. In such embodiments, a first gateway, when it wishes to create a new route that is not in response to an incoming request, creates a routing identifier, e.g., a 64-bit integer. When the first gateway initiates a routing request, it sends the identifier to the second gateway. Each gateway in the recursive request receives the identifier and sends it to any additional gateway. Similarly, route information, e.g., for a device, org, user, app, etc.) may propagated as well. And changes may be applied to the routes, propagated or otherwise defined. And, as may be expected, routes may expire for a number of reasons, such as inactivity.

In embodiments, information is supplied to the system in multiple ways. In one example, application-based authorization allows an application to talk to a particular server and transmit traffic via a particular route. In application-based authorization, application origination information is attached at the network tunnel. Application-based authorization allows realtime analytics of application traffic across a network (e.g., the network tunnel may aggregate traffic information and can view in real time). Realtime analytics are also possible using device-tagged traffic and enforce routing policy. And content-based analysis may be performed by intercepting or “sniffing” network packets, e.g., the “little snitch in the cloud.” And the functionality described above could also result from using device- or access-gateway based authorization. The application-based authorization can be used to implement a strict known-behavior enforcement policy for communications from a particular application. That is, only known destinations and/or protocols may be used on the network for communications from a particular application. Traffic from that particular application that involves other destinations or protocols (not previously known and configured for authorization) is denied. In an embodiment, instead of denying traffic with previously unknown or unapproved network destinations and/or protocols, an additional routing configuration is used to supply a special routing path that takes the traffic through a special analysis server, which analyzes the traffic associated with this abnormal network behavior of the particular application. The analysis server may choose to allow or block communication, or to further modify the routing configuration for this particular application.

Embodiments show that traffic may be routed for analysis in a variety of ways. In one, a client with a local terminal gateway sends traffic to a remote terminal gateway for analysis at the remote terminal gateway. In another, a terminal gateway tees the traffic to an analysis system (that is not inline) and the destination; that is, the same traffic is sent to the destination, and a copy of the traffic is sent (via a “tee”) to an analysis system that is not inline. In another, the route includes a local gateway, a first hop gateway, a route to an intermediate analysis gateway, and a route to a final terminal gateway. Optimization of these embodiments may include caching decisions locally, particularly if large portions of traffic for a given destination flows through a given analysis system. Further optimization may include a global object analysis lookup of a central database or distributed databases, which may be faster than re-analysis of an object.

Embodiments envision supporting a number of service discovery protocols. With DNS-based service discovery, an embodiment provides authenticated DNS with fanout and network address translation capability, with the client having access to multiple private networks. An embodiment provides a database of services, and the database may be auto-populated by device access, e.g., via DNS.

In embodiments, service discover protocols may implement access controls, such as including a link with Lightweight Directory Access Protocol (LDAP), or an auto-detection mode that detects user groups that access certain services and/or detects anomalies of usage.

In embodiments, service discovery involves application-based routing in which the client sends traffic to an identified destination, not to a particular IP address. The system's routing infrastructure knows that the particular destination identifier is not in fact an IP address (even though it looks like one), but is treated as an abstract specification of a particular application, copies of which may be running at multiple places in the network, and chooses the best way to get (route) to that application. Such an application identifier may have been returned to an authenticated user or device in response to a DNS request for a particular application server or service name.

In embodiments, a gateway registry may be provided, which may contain attributes of gateways and support the management of gateway selection by clients and during routing. For example, initial remote terminal gateway selection may be destination-based, locality-based, or fixed. A destination-based selection may include a client-based PoP selection in which a client chooses a PoP locally and directly sends tunneled traffic to that PoP. This sending may be based on information about the location of the destination, which may be determined a number of ways, including: using a local database of IP countries; via a network request serviced by a pipe infrastructure, e.g., where is this IP located?; or by DNS extension. A locality-based selection may include a network-based PoP selection in which a client sends traffic to a first PoP, or its host, or a network service. That PoP may choose a second PoP from which the traffic should exit the tunnel. In a fixed selection, the gateway is hard coded by IP or domain name.

In general, things to be considered in embodiments include: non-public networks, route authorization, geo-distributed hosts, analysis systems, crypto-path requirements, route optimizations, and permanent naming. Options that may be available in embodiments include: application attribution, path characterization, selective tunneling, and roadblocks. In application attribution, a tunnel knows which application on a host is responsible for sending/receiving which data. Path optimization may include: path MTU (Maximum Transmission Unit) discovery (e.g., via ICMP (Internet Control Message Protocol)); and/or bundling multiple small packets together to form a single larger packet, e.g., many 200 byte packets. Optimization may be possible where, e.g., protocols assume a 1500 byte MTU, but the network path supports more. With selective tunneling, a network PoP may identify application traffic and tunnel it appropriately, e.g., sending browser traffic to a proxy, but not network traffic.

Such considerations may also include potential roadblocks. For example, latency due to encryption may be addressed by dynamically tuning encryption based on latency requirements, or the risk of the network link (e.g., international vs. domestic). Latency may also be addressed by filtering attacks in the network layer, or using end-to-end cryptography with authorization. Such cryptography may involve separation of ownership, e.g.: terminal gateways controlled by an enterprise, or intermediate gateways controlled by third-party cloud provider. Such cryptography may also involve an authorization layer and a cryptography layer. For example, an authorization layer may be encrypted to all pipe users, with a cryptography layer only to the last mile exit node.

Configuration and management of the embodiments may include: “security groups” for users, devices, or services; a Wi-Fi router or Ethernet device that provides a virtual network, but all traffic on that network is tunneled to the cloud; an isolated stack that only routes overnet traffic; and device pre-configuration.

Use of the several embodiments may be beneficial to, or provide enhancements to, for example: transport-layers, networks, mobile network operator services, routing, performance, application-level performance, browsing, general privacy, data analytics, connectivity, threat detection/prevention, data security/controls, risk reduction/policy, auditing/forensics, and battery life.

Transport-layer enhancements illustrate several embodiments. In one example, embodiments may improve the situation in many networks in which packet loss is wrongly interpreted as congestion, resulting in showed throughput. In greater detail, a problem in flow control on packet switched networks, is that packet loss is often used as an indicator of congestion and used as a signal to reduce the amount of traffic being sent before waiting for acknowledgement (the window). However, on some networks (particularly wireless networks) packet loss may result from extraneous conditions (e.g., RF interference) that do not indicate congestion.

Some solutions involve Forward Error Correction (FEC), discussed briefly earlier. To reduce packet loss, a tunneling/routing system may implement a form of error correction (e.g., Turbo Codes, or LDPC or Gallager codes), across multiple packets so that, for a given packet loss rate of the tunneled data, the untunneled stream will suffer no loss rate. This may be implemented in a system where a client with a first local PoP is communicating with a second PoP and the communication between PoPs traverses a route that suffers non-congestive packet loss. The local PoP may take the data provided by the client and produce output packets that contain FEC. This may include re-segmenting input packets to ensure that maximum transmission unit requirements are still satisfied. At the second PoP, the packets containing error correction may be decoded to produce the original input packets even if some of the error correction packets are lost. If too many packets are lost, the second PoP may communicate with the first PoP to increase its error correction rate. Such FEC may be implemented where both PoPs are local to their hosts, where only one is local, or where neither are local (e.g., in the case where a client is connected to a wired network, but that wired network utilizes a wireless link to reach a destination host).

Some solutions involve a modified stream protocol, such as wireless transmission control protocol (WTCP). Multiple options to overcome shortcoming to TCP are possible. However, many modifications require multiple hosts to support their modifications (e.g., WTCP), so their usefulness is limited in practical circumstances. In a solution using embodiments, PoPs use modified stream protocols (WTCP instead of TCP) or specialized congestion-avoidance algorithms when communicating with each other, but transform into a standardized stream protocol otherwise.

Some solutions involve a route-aware congestion-avoidance algorithm. TCP congestion-avoidance algorithms are usually memory-less, that is, for a given connection, they optimize without knowledge of previous connections between the same hosts or along the same route. In a solution using embodiments, a PoP stores information about the congestion of a given route or congestion to a given destination so that the PoP may start new connections with knowledge of how previous connections have fared. This avoids the need to optimize all new connections (i.e. waiting for packet loss to determine congestion). The PoP may choose to re-segment a TCP connection from a client or another PoP, change its window, or engage in other modifications that optimize throughput, latency, or other goals.

Network enhancements illustrate several embodiments. A network may benefit from embodiments because pushing data to an application that is running on a device behind a firewall is challenging and requires application-layer push routing mechanisms. One solution may be to establish an application-specific virtual network so that standard network primitives may be used, e.g., so that an application can simply listen on a port via TCP/UDP and not have to be aware that firewall traversal, network address translation, or any other special provisions are taking place. In an embodiment, a client library produces a virtual network for access by an application where the application is peered with other desirable hosts (e.g., a set of push services). The application may then simply listen on open ports using standard primitives (e.g., accept( ), bind( )) or, if necessary, the SDK may implement a parallel set of networking primitives. The library may implement a whole TCP/IP stack so that it can act as a fully functioning host on the virtual network. The virtual network may use a standard VPN protocol or may utilize a routing/tunneling system.

A network may benefit from embodiments because a device with multiple internet gateways would like to always use the optimal one or multiple in parallel. In greater detail, in many cases, including when a mobile device is connected to a cell network and Wi-Fi, the selection of which internet gateway to use is of often a static configuration (e.g., if Wi-Fi, then use Wi-Fi as gateway, else use cell network). However, where the Wi-Fi network is out of range, but the device has not yet disconnected, there may be a period of internet non-connectivity. Similarly, if a device has access to multiple networks simultaneously, it may be desirable to route traffic over all of them to maximize throughput.

One solution involves a client communicating via a network tunnel with a PoP, with the communications flowing over multiple IP addresses and network routes without breaking the tunnel. In this, a network tunnel session is first established between a client and a PoP, allowing the device to route packets to/from the PoP. The PoP then routes those packets to/from the Internet. In typical network tunnels (e.g., VPNs), there is an assumption that a client's IP address does not change, so that if the client changes network connectivity, a new tunnel session must be created. The tunnel may be over TCP, UDP, a custom IP-based protocol, or another protocol (e.g., DNS).

According to an embodiment, when establishing the network tunnel connection, the client may provide metadata to the PoP about the connection, including information such as cost (e.g., is this connection “free” or a cost metric (e.g., $21.99/GiB). The tunnel also supports an authentication mechanism that does not rely on the underlying transport protocol (e.g., TLS, DTLS (Datagram Transport Layer Security), a secret key with an HMAC (Hash-based Message Authentication Code), or each message being signed with a private key). The tunnel may also be desirably resistant to packet spoofing attacks (e.g., its protocol authenticates each packet independently). For each packet, the tunnel may support “application attribution,” described elsewhere in this disclosure.

The PoP that terminates the tunnel from the client in this embodiment maintains session persistence in the payload (e.g., by a session identifier, private key, etc.) and does not utilize a client IP address as a fixed parameter of a session. Thus, a client may maintain a consistent tunneling session with the PoP even if it changes IP addresses, with the underlying protocol being session oriented (e.g., TCP), or stateless (e.g., UDP, raw-IP). And, thus, the client may have a virtual network interface that chooses which real network interface to use when transporting data to PoP.

For a forward path, such as client to internet via PoP, the decision of which real network interface to use may be based on an up/down status of the real network interface (e.g., don't send data over a Wi-Fi interface if the interface is not associated with an AP (Access Point)). It may include recent indicators of disconnection (e.g., What percentage of packets sent at least 200 ms ago and less than 5 seconds ago are unacknowledged? When was the last packet received over the connection? When was the last time a beacon frame was received from this Wi-Fi access point? Has the radio seen other client traffic for this IP in the last second?). It may include radio information (e.g., signal strength, BER, retransmit rate). It may include the type of connection or application trying to send data (latency sensitive vs. non-latency sensitive, large volume vs. high volume of data transmission). Or it may include a cost of routing (e.g., Wi-Fi networks may be cheaper than non-Wi-Fi, but in some cases may be slower).

For the forward path, the client may, alternatively, choose to transmit the same packet over multiple gateways simultaneously or after a delay. In an embodiment, the tunneling protocol may choose to route multiple copies of the same data to remove statefulness on the side of the client, as some protocols traveling over the tunnel (e.g., TCP) can handle this gracefully. Alternatively, the tunneling protocol may include de-duplication of underlying data. This is may be more important if protocols flowing over the tunnel cannot tolerate packet duplication.

For a return path, such as from the internet to the client via PoP, PoP may remember the last source from which it successfully received data from client. To validate that the IP from which the PoP received data is the same as the client that initiated the session, session authentication may be used as described above. Regarding what to remember, in the case of TCP, this may simply be an existing TCP connection between the client and PoP. In the case of UDP, it may be an IP address and remote port. In the case of a custom IP-based protocol, it may be a protocol-specific identifier associated with the IP address.

Still regarding the return path, when the PoP needs to route data to the client over the tunnel (e.g., self-generated or received from the internet), it may choose to transmit the data to one or more destinations. Also, the choice of whether to only use one vs. multiple destinations simultaneously may use a similar set of decision criteria as the forward-path data. For example, those criteria may regard: recent indicators of disconnection, the type of connection or application on the client receiving data, the cost of routing of each connection, stickiness (i.e., a PoP may simply use the last connection from which it received client data to route return-path data, or it may prefer that connection, but quickly fail to another connection if it does not receive acknowledgement). After choosing between one or multiple, the PoP then transmits tunneled data to client via one or more connections.

In embodiments, if a client no longer is reachable via a first connection, a mechanism is in place for the PoP to stop routing packets via that connection. The PoP may use one or more mechanisms to determine when a client is no longer reachable. For example, a client may use a second connection to send a disconnect message that informs a server that the first connection should be forgotten. The client may do this by describing the connection addresses (e.g., IP address, port+IP), or by a pre-set connection identifier sent from client to the PoP (or the PoP to the client) upon connection initiation. In another example, a session disconnection may be handled by timeouts. Ordinarily, when a connection is alive, a client may send data to a PoP to keep the session open. This may be especially desirable if a client is behind a NAT firewall that closes connections after period of inactivity. If the PoP does not receive data over a given connection after a period of time, then the PoP may choose to stop routing traffic to that connection.

In an embodiment, the network tunnel may treat different packets differently, based on the protocol in use. For example, packets being tunneled using TCP may not have any additional de-duplication, whereas those using UDP (given that it is often used in applications that generate a lot of traffic) may have simple de-duplication mechanics. Or packets may be treated differently based on the application in use. For example, if a web browser is transmitting or receiving data, the tunnel may choose to allow lots of duplication—transmitting and receiving data on all available paths to improve user experience. In contrast, a background downloader application may only route over free connections to reduce cost to the end user.

Routing enhancements may make use of several embodiments. Routing may be improved where some internet routes are chronically slow or experience temporary slowdowns. In greater detail, because routing on the Internet relies on a series of network interconnects, the overall packet routing decisions for a given network flow may not be globally optimized. For example, Border Gateway Protocol (BGP) may use metrics relating to the length (in terms of number of unique autonomous systems) of a route (e.g., AS-path) in order to route packets. However, latency and the number of network hops are not taken into account, leaving opportunity for optimization. Prior art anticipates a fixed enterprise IT infrastructure, whereas modern infrastructures are distributed (with servers in the cloud, and everywhere laptops, mobile devices, and branch offices) and dynamic (things move around all the time).

One solution employing embodiments is to perform intelligent packet routing, in which traffic is tunneled from clients to one of a number of gateways (which are ideally dispersed across the Internet, preferably as close as possible to each node). At the gateway, the packets are intelligently routed (e.g., addressing latency, packet loss, and route stability). In an embodiment, the gateway has access to multiple upstream providers and, by measuring a destination's metrics (e.g., latency, packet loss, route stability), may choose which upstream provider to route traffic through for that destination. That is, on receiving an incoming packet, the gateway decides which route to use by using a decision process.

The decision process may use information collected by, for example: measuring the latency or packet loss of a particular carrier to a known location on their network (e.g., another gateway or a known host on the network); sending packets to the destination AS via each different carrier and measuring the relative latency/packet loss rate; or using a known dataset of current route health statistics, perhaps one not measured by the gateway (e.g., downloaded from another system). The decision process may be pre-computed (e.g., for a packet destined for this autonomous system (AS), use this particular carrier/route), or may be computed dynamically. The pre-computation may take place on the gateway or by an external system.

In an embodiment, multiple gateways can collaborate by sharing data amongst each other, or to a central service. In this sharing, statistics are gathered about various routes so optimal routing decisions between all points in the network can be made. Gateways may send their latency and/or packet loss statistics to a route analysis system that measures the health of all routes accessible to the system. This route analysis system may use the resulting measurements to provide routing decisions to collaborating gateways. Because routing decisions may change very rapidly (in a matter of milliseconds), collaborating gateways and the route analysis system may have a persistent connection open to each other so that the entire system can optimize itself and route around network failures or congestion very quickly.

In an embodiment, if it is preferable for traffic to use a very particular route, packets are routed between intermediate gateways instead of letting the normal routing infrastructure make routing decisions to a destination. That is, instead of a gateway simply choosing which carrier to route packets to (and having that carrier make routing decisions from there), there is a network of gateways distributed throughout the internet, and one of these gateways routes packets to another of these gateways. In this way, packets can be routed along a specific route from gateway to gateway until they reach their destination. If there are a sufficient number of distributed gateways, the route may be controlled without influencing the underlying routing policy of the carrier's network. Alternatively, and if the underlying routing policy is known, gateways are only necessary where the preferred route is different from the default route. Thus, a gateway routing a packet to a destination along a preferred route, may choose to transmit the packet to a gateway in the next autonomous system, or may choose to use the routing gateway's system's routing infrastructure to choose the next system to route to. With the gateway knowing how such systems route packets, the gateway can make optimally decide between when to use the standard routing infrastructure and when to use gateways to force a particular route.

Still regarding routing, some users may be willing to pay a premium for improved transit. One solution involves embodiments directed to backbone-level preferred routing. In one such embodiment, an internet transit provider provides preferred transport to all traffic generated by a gateway. The preferred transport may take the effect of routing packets via less congested routes, or other forms of QoS. In deciding whether to provide preferred transport, a router may examine or base its decision on the source of the traffic (e.g., is it from a known gateway that has registered to receive preferred transport) or the content of the packets (e.g., IP header that contains an authorization token). Another solution involves embodiments directed to private links. In one such embodiment, a gateway has access to non-public network routes (e.g., dark fiber) and can selectively route traffic to them. In an example, for very popular network services (e.g., Google), it may be desirable for a gateway to have a direct link to the service provider (e.g., Google datacenter) and bypass external systems altogether. In the embodiment, a gateway may receive a packet with a destination. The gateway may have access to one or more links to local carriers and one or more private links to the destination. The gateway then may decide whether to utilize a private link or a carrier link to provide transit to the destination.

Performance enhancements may make use of several embodiments. Embodiments allow for a system that may dynamically move data around a cloud-based network—making a massive dynamic Content Delivery Network (CDN) a reality. Embodiments also provide for caching. There may be a giant cache-in-the-cloud with unique object identifiers and stateful knowledge of where objects have “gone” (e.g., posted into cloud-storage services (most notably including Lookout™ backups from a device)), so the system can avoid re-sending objects from a device. Rather, the system may send an object from a known cloud-based source of the object. Such a cache-in-the-cloud would similarly be available for incoming objects. Embodiments may also de-dupe based on content (e.g., a global dictionary, or a per-site dictionary)

Application level enhancements using a network-based intermediary may make use of several embodiments. Current methods for providing access to premium content include: 1) requiring a user to sign in using an account for a particular service, or 2) accessing a service from a dedicated location (e.g., university network, library). Both of these are inconvenient. The former because creating an account for virtually every site for which a user wishes to view premium content is challenging, particularly in a situation where much content discovery takes place outside of the content owner (e.g., social networking, email, etc.). The latter is inconvenient because users are more often browsing content using mobile devices and tablets instead of using a desktop terminal. One embodiment provides for a premium content provider that allows access to premium content for all users coming from one or more whitelisted PoPs (e.g., whitelisting IP addresses or ranges). In this embodiment, users may access the premium content via a routing/tunneling system that only allows usage of the whitelisted PoPs if the user is authorized to access the premium content. Other embodiments may involve ad-blocking or desirable ad-targeting systems.

Browsing enhancements may make use of several embodiments. Embodiments may provide for optimized browsing by providing, e.g., a faster experience. Such optimized browsing may arise as a result of using, for example, combinations, as when both validating/transcoding objects for malware detection or prevention and performing compression/size reduction. For example, some malware uses specially constructed objects which do not conform to standard file format specifications (e.g., .jpg images, .pdf documents, etc.) in order to conduct buffer overflow attacks on vulnerable software—validating or transcoding such objects can remediate such file format based attacks in objects. Such optimization may also arise from a tie-in with a unified login or single sign-on system. Further optimization may arise from: implementations of “do not track” in PIPE infrastructure, other tactics for privacy preservation performed in the network regarding cookies (primary vs. third party, session vs. persistent, etc.), IP masking, referer's [sic; the HTTP header is in fact misspelled as “Referer:”], fingerprinting (via headers, user-agent strings, lists of plugins or fonts installed, etc.), web bugs, or other tracking.

Connectivity enhancements may make use of several embodiments. Some embodiments may provide enterprise policies/controls/network filtering to decentralized networks, or access control to complex networks. As data is routed over the Internet between two parties, there may be intermediaries who have an undesirable amount of visibility and control over the data. In greater detail, because of the topology of the Internet, a user in country A accessing a service in country B may have their traffic pass through additional countries where both the service and the user do not wish to have their traffic subject to inspection or modification. Some examples of routes that may not be desirable include: routes traversing or under the control of undesirable countries, routes with nodes known to intercept signals, or routes of known low-quality/traffic filtering/shaping. For example, a user in Switzerland wishing to access a servers in the US and Australia may not want their traffic to be intercepted by Germany, France, or other countries that network links may traverse. In this example, the user's traffic to the US is encrypted to a PoP in the US while the traffic to AU is encrypted to a PoP there.

In an embodiment, requirements regarding countries through which traffic could be routed or tunneled may be specified either as: a set of user preferences, a configured policy, or a set of connection specific header information embedded in the communications stream. For example, a policy specification “Disallow-Country-Routing: AF, BY, CU, IR, IQ, KP, LY, MM, SD, SO, SY,” would prevent any traffic routing through any of the countries specified in the list (using the country's ISO 3166-1 alpha-2 codes). A policy specification “Require-Country-Tunnel-Through: CD, CI, CN, CY, ER, KG, LB, LR, RU, VE, VN, ZW,” would allow routing through any of the listed countries, but would require all traffic routed through any of these countries to be encapsulated in an encrypted tunnel that begins in a country not on the list and terminates in a country also not on the list. A policy specification “Require-Country-Tunnel-To: AU, CH, US” would require end-to-end or piecewise tunnels when traffic is being routed to a destination in Australia, Switzerland, or the United States.

In an embodiment, both hosts have local PoPs and all data is securely tunneled between them (e.g., via a VPN), or tunneled via a secure tunneling and routing infrastructure relying on other systems. In another embodiment, if one host does not have a local PoP (e.g., a standard HTTP server), and some traffic must be sent over the internet, a PoP not local to the host is chosen to minimize undesirable packet routes.

In a further embodiment, a client may not have a local PoP and a server may not have a local PoP. Thus, the client needs to send data to a remote PoP near the server in a way that the data between the remote PoP and the server does not flow across any undesirable routes. In choosing a PoP, the client may use the location of the destination server and a database of locations of remote PoPs to determine which remote PoP to use. The client lookup of the destination server location may use a local IP location database, or it may reference a network service that provides the server's location. The client may also store routing information that allows it to determine the route that the traffic will take from the remote PoP to the host. If a remote PoP is not chosen by the client, e.g., in the case where routing decisions are made in an intermediate node of a routing/tunneling service, that intermediate node may examine the destination host and the preferences of the client (stored at or available to the intermediate node) to determine which PoP to use in communicating between the client and host. In choosing an optimal remote PoP, the intermediate node may have available to it an IP geolocation database as well as a database of multiple PoPs.

In an embodiment, if neither client nor host have a local PoP, an originating PoP (typically a PoP chosen by the client in the case of a client/server application such as a web browser) may receive a destination from the client and choose a remote PoP close to the destination host. In doing so the originating PoP uses the same criteria as a remote PoP not being chosen by the client, discussed above.

Embodiments regard a configurable point of presence in which traffic is tunneled from a client to a point of presence in a chosen country. In that country, the route is chosen by either the client with a local PoP, an originating PoP, or an intermediate node.

In some cases, a user is given access to an application that will allow their devices to talk to a given port on a given host. Such access may also allow the devices access to capabilities on that port or host. In another embodiment a user's role or department in an enterprise organization may be used to allow or deny use of an application, or application-specific communication or communication to a specific type of server. E.g., a person in the enterprise's marketing department should ordinarily never be using the git command application, nor communicating via git protocols, nor communicating to get servers (Git is a distributed version control system used by developers; the presumption in such a rule is that there are no developers in the enterprise's marketing department). In general, an assigned level of privilege for an application can be used in conjunction with a file share that tags data explicitly, with the network enforcing user privilege to that level of data access. E.g., an application that is tagged as being authorized for use by operations department personnel will be disallowed from communicating with a file share that does not have a tag allowing access by operations department personnel, but only finance department personnel. The authorization can also be performed dynamically, at the time of attempted data access, by an analysis component that determines from inspection of data or metadata that a given application label or tag should not be allowed to access this data content.

Embodiments may benefit implementing network policy for connected devices. It is a concern that many connected devices will not have the capability to make their own security decisions or deal with the overhead of manual configuration. Embodiments may address such concerns by providing an infrastructure that manages network connectivity policy in the cloud. Specifically, such embodiments may manage who a given device may talk to and who can talk to it. To bring this about, the infrastructure may: configure endpoint-side firewalls; and enforce transport policy at a network infrastructure level. Enforcing transport policy at the network infrastructure level may include: sending all network traffic via a tunnel to a controlled infrastructure, where flow decisions can be made by that infrastructure (e.g., a cloud service maintains configuration policy for a device's firewall and the device (or local network infrastructure) receives that policy and applies it locally); and the network infrastructure accomplishing all this without awareness by the device of any special requirements and without the need for the device or applications on the device to have done anything different from normal to be able to operate with this special network infrastructure (e.g., each device is on its own private network, where the network infrastructure (e.g., a router, or switch) contains policy as to how to handle data to and from the device).

Enforcing transport policy at the network infrastructure level may also involve tunneling by the device itself (e.g., using a VPN), so that it does not affect the underlying network topology. For example, the device may deploy the VPN on a home network without any additional configuration.

In an embodiment regarding network policy, a refrigerator brings up an encrypted tunnel to a secure network service and authenticates. The owner of the authenticated user can configure what destinations the refrigerator can send packets to as well as what sources may route packets to the refrigerator.

The system may integrate with continuous monitoring systems such as those described in U.S. patent application Ser. No. 14/099,737, filed Dec. 6, 2013, which is incorporated by reference.

Threat Detection/Prevention enhancements may make use of several embodiments. In one embodiment, content is scanned for known malware. The embodiment may also include a risk model that includes analysis for structural anomalies. Scanning content may include, e.g., characterizing typical content (e.g., URLs, binary protocols), and flagging unexpected traffic. The scanning may allow or result in the real time blocking of threats using: continuous monitoring plus network filtering, closed loop security using data and feeding protection into network sensors.

Data security/controls enhancements may make use of several embodiments by tagging data sent to a device and blocking it from ever going out of the device, e.g., to Dropbox. Such embodiments may use hashes or a fuzzy content algorithm.

Risk Reduction/Policy enhancements may make use of several embodiments. Configurable host firewalls that rely on users are cumbersome, and a non-starter for many users, particularly novices. Embodiments present a different “internet” to each application (e.g., allowing the application access to only certain things, or to only special things). This may include access to particular IPs/Domains, and access to private network resources/private routes. It may include setting data access by crowd-sourcing. For example, application data access may be characterized by a particular critical mass of functionality. If, e.g., 75% of users attempt to access this domain, then access to it is allowed. Conversely, if only 1 user or 1% of users attempt to access a given domain, it is flagged to IT admin and access is blocked.

Risk reduction/policy enhancements also include an embodiment in which a network applies policy on connection. Upon connection, security software is installed. It then checks for any malware present and determines risk based on any installed applications. Subsequent network access may be different based on a determined risk posture (e.g., access to total vs. access to public only). An embodiment characterizes devices based on network traffic and take action accordingly. A further embodiment develops a device credit report. In the embodiment, a network generates a report based on network traffic about the security of a device and any presence of malware or certain applications. Other networks and web services may pull the resulting device credit report.

Auditing/Forensics enhancements may make use of several embodiments. Embodiments may provide which users talked to which servers, and how often; anomaly detection; tripwires; data transfer inventory (what did this device send/receive to this host); and SSL Certificate auditing. And battery life enhancements may make use of embodiments that provide battery-life related information, such as: whether the screen is on or off, whether Wi-Fi or cell communication is in use, and the current battery level.

Other embodiments are envisioned. For example, in an embodiment a gateway adapts traffic from one tunnel type to another—perhaps because it may be desirable for a first terminal gateway to transport data to an existing network infrastructure without allowing any intermediate systems (e.g., remote gateway) to inspect traffic. This may be particularly important if the existing network infrastructure and client are owned by an enterprise, but the remote gateway is owned by a third party. One benefit of such adaptability is the ability to choose network tunneling protocols (e.g., SSL VPN, IPSEC tunnels), which may have one or more guarantees that are enforced via cryptography. Further benefits that may accrue from avoiding intermediate systems in this way include: integrity—the message is complete and unaltered; authentication—the message is from who it says to be from; confidentiality—unprivileged observers cannot view the contents of the message; and replay protection—the message cannot be sent again in the future.

Keying is typically part of providing cryptographic guarantees, specifically regarding: integrity, confidentiality, and replay protection. In an embodiment, a secret key may be pre-shared with a client and a VPN concentrator so that the above cryptographic guarantees may be met by holders of the secret key, but not by parties that do not hold the key. For example, a key exchange protocol, e.g., Diffie-Hellman, IKE, or IKEv2, may allow a client and a VPN concentrator to exchange cryptographic keys without requiring pre-shared keys. Ideally such a protocol is authenticated so that not merely anyone can exchange keys. In another example, asymmetric cryptography, particularly with a known public key (e.g., as part of an X509 certificate) may be used so that a one party can encrypt directly against the other's public key. Because of the performance issues with asymmetric cryptography, it is often used to exchange a symmetric key.

In an embodiment, authentication can be provided a number of ways, e.g.: using a pre-shared key; using a known public key or certificate containing a public key that may either be used directly or may be used as a part of a chain of certificate trust for one or both parties; using a username and password; and multi-factor authentication. And there are a number of example authentication protocols, including: 1) EAP http://en.wikipedia.org/wiki/Extensible_Authentication_Protocol; 2) PEAP http://en.wikipedia.org/wiki/Protected_Extensible_Authentication_Protocol; and MS-CHAP http://en.wikipedia.org/wiki/MSCHAP, among others (see http://en.wikipedia.org/wiki/Authentication_protocol).

Some embodiments may address issues that arise when information required to transform from one tunnel type to another requires knowledge of privileged information. In greater detail, the fields used to enforce cryptographic guarantees are often different between tunnel types. And the mechanism by which confidentiality, replay protection, and integrity are enforced differs between different types of tunnels. For example, OpenVPN utilizes HMAC over an IV (Initialization Vector) and ciphertext in a particular order to ensure integrity [http://openvpn.net/index.php/open-source/documentation/security-overview.html]. Similarly, in IPSEC ESP, the integrity check value is calculated over a different structure [http://tools.ietforg/html/rfc2406].

Embodiments address this by ensuring that the tunneling protocol that transforms from one tunnel type to another, e.g., between the first terminal gateway and the second gateway, is flexible enough to allow the second gateway to request that the first terminal gateway provide the material needed to transmit data to a second tunnel. In an embodiment, a first terminal gateway has one or more pre-configured sets of criteria it can send (e.g., IPSEC SHA-1 HMAC, OpenVPN SHA-1 HMAC, OpenVPN Ciphertext, and Raw Ciphertext) so that a second gateway has all of the appropriate parameters to conform to a second tunneling protocol (e.g., IPSEC ESP, OpenVPN, or another SSL VPN Protocol) without needing keying material for the connection. The second gateway requests that the first terminal gateway utilize one of the preconfigured sets of criteria. In another embodiment, a flexible definition format allows a second gateway to request a particular set of parameters. For example, the flexible format may specify functions and symbols that represent the data for each packet, such as: ENCRYPT( . . . data to encrypt . . . ); IP_PACKET_W_HEADERS; IP_PACKET_WO_HEADERS; SHA-1 HMAC( . . . data to HMAC with current HMAC key . . . ), 8_byte_sequence_number, 4_BYTE_SEQUENCE_NUMBER, 4_byte_IV, specific value (e.g., “\x1f\x23\x55\x52\x9f”). With such specified functions and symbols, the second gateway may request that first gateway provide data in the following manner, e.g.: ciphertext=ENCRYPT(4_byte_sequence_number+IP_PACKET_W_HEADERS); hmac_key=SHA-1 HMAC(4_byte_IV+ciphertext); or ciphertext=ENCRYPT(( . . . data to encrypt . . . ). And in an embodiment, a dynamic configuration is based on policy instead of an IP/MAC/host-based configuration, configuring services, users, and/or devices instead of ports.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

1. A method for managing a connection between a computing device and a destination computing device, the method comprising:
managing, by a first managing component, traffic between a first computing device and a destination computing device, including:
identifying, by the first managing component, at least one characteristic of the traffic;
accessing, by the first managing component, a database including at least one connection policy associated with the identified at least one characteristic;
determining, by the first managing component, an applicable connection policy based at least in part on the identified at least one characteristic;
retrieving, by the first managing component, the applicable connection policy; and
implementing, by the first managing component, the applicable connection policy in managing the traffic between the first computing device and the destination computing device and in managing a first connection between the first computing device and the destination computing device, the managing the first connection including:
providing, to a second computing device, a request for a first connection over a network, the second computing device:
configuring the first connection, and
establishing, after the first computing device is authenticated, the first connection.

2. The method of claim 1, the first managing component including a managing software component.

3. The method of claim 2, the managing software component embedded in a computer hardware component.

4. The method of claim 1, the first managing component including a gateway.

5. The method of claim 1, the identified at least one characteristic of the traffic including a user identity associated with the first computing device, or a data type associated with the traffic, or both.

6. The method of claim 1, the implementing of the applicable connection policy directing an aspect of the managing of the first connection.

7. The method of claim 1, the implementing of the applicable connection policy directing an aspect of analyzing the traffic.

8. The method of claim 1, the method further comprising:
managing, by the first managing component or a second managing component, a second connection between the first computing device and the destination computing device, including:
providing, to a third computing device, a second request for a second connection, the third computing device:
configuring the second connection at the third computing device, and establishing the second connection; and
managing, by the first managing component or a second managing component, traffic between the first computing device and the destination computing device.

9. The method of claim 1, the first managing component managing the traffic to conserve a resource of the first computing device.

10. The method of claim 1, the identified characteristic including a user identity, the applicable connection policy determined based on the user identity, the applicable connection policy modifiable by the user.

11. The method of claim 1, the identified at least one characteristic of the traffic associating the traffic with a first enterprise, the implementing the applicable connection policy directing an action taken regarding the traffic according to a first enterprise policy.

12. The method of claim 8, the first enterprise policy directing the scrubbing of vulnerabilities from traffic exiting the first enterprise.

13. The method of claim 1, the first managing component choosing a first gateway running a first managing software component, the second computing device including a second gateway and running a second managing software component.

14. The method of claim 13, instances of a managing software component running with each gateway of a plurality of gateways on a path between the first gateway and the destination computing device.

15. The method of claim 13, the first gateway an entrance to a tunnel between the first computing device and the destination computing device.

16. The method of claim 13, the first computing device including the first gateway.

17. The method of claim 13, the first gateway on a second computing device that is remote from the first computing device.

18. The method of claim 13, the destination computing device providing access to a private network.

19. The method of claim 13, the first gateway chosen by the first managing software component from among a plurality of gateways.

20. The method of claim 19, the plurality of gateways distributed on the network, the first gateway chosen from among the plurality by the first computing device based at least in part on latency.

21. The method of claim 13, each of a plurality of enterprises having access to a plurality of gateways, instances of the managing software component running with each gateway of the plurality of gateways, each of the instances of managing software having access to the database.

22. The method of claim 21, a first enterprise of the plurality of enterprises providing the plurality of gateways with the ability to tunnel to an infrastructure of the first enterprise.

23. The method of claim 21, the traffic being granted access to the plurality of gateways upon being granted access to the first gateway.

24. The method of claim 21, the instances of the managing software components provided with latency information for each of a subset of the plurality of gateways, at least one instance of managing software component routing the traffic to improve the latency at one of the subset of the plurality of gateways.

25. The method of claim 21, the database including at least one connection policy for each of the plurality of enterprises.

26. The method of claim 25, the at least one connection policy for at least one enterprise directing that the traffic be logged.

27. The method of claim 13, including an intermediate gateway between the first computing device and the destination computing device, the first gateway allowed access to a set of information regarding the traffic, the intermediate gateway denied access to a subset of the set of information.

28. The method of claim 27, the subset of information including the identity of a user of the first computing device.

29. The method of claim 13, the first computing device connecting to a virtual private network (VPN) to provide a tunnel between the first gateway and the second gateway.

30. The method of claim 13, the first connection including a tunnel between the first gateway and the second gateway, the first computing device connecting to a virtual private network (VPN) using the tunnel.

31. The method of claim 30, the VPN being established for a user and no other user, the first computing device accessing an enterprise service using a browser and the VPN, the enterprise service not otherwise accessible using the network.

32. The method of claim 31, the VPN established for the user remaining open when the user is not using it.

33. The method of claim 13, the first gateway located on the network, the first computing device accessing the first gateway using a first VPN, the traffic routed from the first gateway over the network to a terminal gateway on the network, the terminal gateway accessing the enterprise system using a second VPN.

34. The method of claim 33, the first and second VPNs being established dynamically when needed by the user for the user and no other user.

35. The method of claim 34, the first VPN established for the user remaining open when the user is not using it.

36. The method of claim 13, the first gateway located on the network, the traffic routed from the first gateway over the network to a terminal gateway on the network, the terminal gateway accessing the enterprise system using a first VPN, the first VPN available to any of a plurality of users for accessing the enterprise system.

37. A method for managing a path between a computing device and a destination computing device, the method comprising:
managing, by a first managing software component, traffic between a first computing device and a destination computing device, including:
identifying, by the first managing software component, at least one characteristic of the traffic;
accessing, by the first managing software component, a database including at least one connection policy associated with the identified at least one characteristic;
determining, by the first managing software component, an applicable connection policy based at least in part on the identified at least one characteristic;
retrieving, by the first managing software component, the applicable connection policy; and
implementing, by the first managing software component, the applicable connection policy in managing the traffic between the first computing device and the destination computing device and in managing a path between the first computing device and the destination computing device, the managing the path between a first computing device and a destination computing device, including:
choosing a first gateway located on the network, the first gateway including an entrance to a tunnel between the first computing device and the destination computing device.

38. The method of claim 37, the managing a path further comprising:
acquiring access to the first gateway using a first VPN; and
routing traffic from the first gateway over the network using the tunnel for at least part of the path to a terminal gateway on the network.

39. The method of claim 37, the managing a path further comprising:
accessing an enterprise system from the terminal gateway using a second VPN.

40. The method of claim 37, an instance of the managing software component on the terminal gateway, or any instance of the managing software component on the path, managing the path between the first computing device and the destination computing device, or managing traffic between the first computing device and the destination computing device.

41. A method for managing a plurality of gateways, the method comprising:
managing, by one or more instances of a managing software component, a path between a first computing device and a destination computing device, the path using a subset of the plurality of gateways;
managing, by one or more instances of a managing software component, the use of the plurality of gateways, including:
authenticating a user associated with traffic attempting to use the plurality of gateways;
accessing a database including at least one policy associated with the user;
retrieving the at least one associated policy; and
implementing the at least one associated policy in managing the use of the plurality of gateways.

42. The method of claim 41, the path including a tunnel.

43. The method of claim 41, the path including a VPN.

44. The method of claim 41, the at least one associated policy associated with the user based on the user being associated with an enterprise, the database including policies associated with a plurality of enterprises.
